(19) United States
(12) Patent Application Publication
(10) Pub. No.: US 2025/0018367 A1
(43) Pub. Date: Jan. 16, 2025

(54) Metal-Organic Frameworks for Removal of Liquid Phase Compounds and Methods for Using Same

(71) Applicant: Electric Power Research Institute, Inc., Palo Alto, CA (US)

(72) Inventors: Paul L. Frattini, St. Charles, MO (US); Daniel M. Wells, Charlotte, NC (US); Ashlee J. Howarth, Montreal (CA); Christopher James Copeman, Candiac (CA)

(21) Appl. No.: 18/767,842

(22) Filed: Jul. 9, 2024

Related U.S. Application Data
(60) Provisional application No. 63/526,023, filed on Jul. 11, 2023.

(51) Int. Cl. B01J 20/22; G21F 9/12

(52) U.S. Cl. CPC B01J 20/226; G21F 9/12

(57) ABSTRACT

In general, the present invention is directed to a metal-organic framework (MOF) for use in removing liquid phase compounds, in particular anionic and cationic species, as well as a combination of anionic and cationic species, from a liquid or liquid stream. In addition, the present invention is directed to various methods or processes for utilizing the MOF to remove such compounds from a liquid or liquid stream, such as an industrial process stream, and for using the MOF at elevated temperatures.

### BACKGROUND OF THE INVENTION

### Field of the Invention

The present invention and its embodiments relate to the removal of certain chemical species from a liquid. In particular, the present invention and its embodiments relate to the use of a metal-organic framework (MOF) having particular properties suitable for adsorption of certain anions and cations from a liquid or liquid stream, such as an industrial liquid stream, including, for example, liquid process streams associated with power generation processes, such as fossil and nuclear processes.

### Description of Related Art

Nuclear utilities are challenged with the removal of several impurities that significantly contribute to or drive dose, radioactive waste generation, environmental effluent waste concerns, and materials degradation issues. Analogously, fossil-based power generation facilities are challenged by the regulatory discharge requirements for wastewater from flue gas desulfurization and from scrubber, fireside washing, and boiler cleaning operations, as well as by the mandates for groundwater remediation due to coal pile run-off and ash pond leachates. Current technologies (e.g., ion exchange) lack the ability to remove these impurities from various process and wastewater streams to the extent needed due to factors associated with the mechanism of capture and competition with other impurities.

Removal of selenium from water streams is of particular interest. Selenium is a naturally occurring element that is essential, in low concentrations, for human health. Of all essential elements however, selenium has the most confining range between dietary deficiency (<40 μg/day) and toxicity (>400 μg/day). Selenium enters our waterways through a number of different sources such as agricultural runoff, mining, industrial production, and flue gas desulfurization processes. As a consequence of the narrow range between deficiency and toxicity, it is very important to monitor and control the amount of bioavailable selenium in our drinking water. Some regulatory proposals may reduce selenium discharge requirements to 14 ppb and then as low as 10 ppb, making the present operation of many flue gas desulfurization wastewater cleanup facilities incapable of achieving such purity without methods beyond typical ion exchange or adsorption engineering unit operations.

Selenium can occur in both organic and inorganic forms, but the high solubility and hence bioavailability of inorganic species such as selenite (SeO₃²⁻) and selenate (SeO₄²⁻) makes these anions the primary focus of remediation techniques. Many techniques have been explored for the removal of selenite and selenate from water including the use of vertical flow wetlands and bioreactors, but high start-up costs and size requirements have limited the application of these techniques. An alternative approach that has been investigated involves using an adsorbing media to soak up and remove unwanted inorganic selenium. Iron oxides (hematite, goethite, and ferrihydrite) have been studied extensively as potential adsorbents for selenite and selenate in aqueous solutions. These iron-based materials have very low surface areas, meaning that a lot of the material is wasted due to the lack of available adsorption sites. Iron oxides also tend to be effective for selenite removal due to the formation of inner-sphere complexes between the selenite anion and iron oxide surface while selenate removal is not as sufficient because only weak, outer-sphere interactions occur.

In nuclear power electricity generation plants, often the purity of the coolant waters also implicates their radioactive toxicity. One illustrative example is for antimony in primary reactor coolant of a light water reactor, such as a pressurized water reactor (PWR). Antimony is present in key subsystems of the PWR reactor coolant circuit, such as the secondary neutron source, responsible for neutronic start-up of the fissile core; seals for pumps and valves; control rod drive mechanisms; and fuel cladding alloy resulting in low levels of tin dissolved in the coolant water. As with most all metals, contacting them with water forces a temperature dependent, chemical equilibrium between the metal within the solid boundary and a small concentration of solubilized metal within the water. The soluble species are convected to the reactor core, where they are activated by neutron and photon irradiation; in the case of tin, activation produces a radioactive antimony isotope. Further, depending on the local electrochemical potential, much if not all of the activated species is oxidized, and the irradiated oxy-anion is then circulated within the coolant circuit where the primary reactor coolant clean-up loop must remove it. Otherwise, it will eventually deposit on the bounding surfaces of the coolant loop and there serve as a source of radioactive dose to personnel within the plant. However, oxy-anions that are geometrically large (like antimonates and antimonites) relative to polymeric ion exchange resin pores are difficult to remove to stable, low levels in the water flowing through the coolant clean-up loop. The reasons are that they experience mass transfer resistance to diffusion into the adsorbing pores of the resin and that they face larger charge separation (between the anion and the local cationic charge on the resin) due to the larger size involved than for most anions in solution.

An analogous situation occurs within the secondary coolant loop (the steam generating loop) in PWRs. Here, the relevant, large ion is lead, where oxides of lead for both [II] and [IV] oxidation-reduction states of the metal are formed wherever lead infiltrates the coolant. Lead is somewhat ubiquitous in a power plant in that it is part of weld rod, valve seatings, metals of construction in general even if only at very tiny concentrations, lubricants, and radiation field shielding. Lead oxides in part per billion (ppb) concentrations in the secondary water may concentrate within steaming, packed crevices between steam generator tubes and tube support plates, which pack with metal oxide impurity. Those packed crevices concentrate environmentally aggressive species like lead oxides within the crevices, causing advanced risk for stress corrosion cracking of the tube body. The same can be said for sulfate concentration in packed crevices bounded by some tubing alloys. For reference, the primary reactor coolant flows through the tube lumen, under sufficient pressure to remain liquid phase. The secondary coolant boils on the outer tube surface, creating the steam that ultimately turns the generators that produce electric power.

Even in advanced alloy steam generators, like those using Alloy 690 (a nickel/iron/chrome alloy), lead oxide may promote stress corrosion cracking. Hence, for tubing integrity concerns, it is imperative to be able to purify the coolant of such species; however, as with antimonates and antimonite noted above, the lead oxides are too large geometrically to be adequately removed by even nuclear grade, polymeric resin based, ion exchange resins. An analogous argument may be made for the reason lead oxides must be removed from the primary coolant circuit as well; they are the only species known to environmentally induce cracking on the primary coolant side of Alloy 690 tubes under alkaline operational conditions (a phenomena known as primary water stress corrosion cracking).

Radioisotopes of iodine, such as ¹²⁹I and ¹³¹I, are produced as fission products in the generation of nuclear power and can enter water-based coolant and ultimately the environment, for example, if nuclear fuel cladding is breached during fuel use in operating nuclear power plants or during storage of spent nuclear fuel. ¹²⁹I is a particular concern, because it is extremely long-lived with a half-life of 15.7 million years. Radioisotopes of iodine exist in aqueous environments as iodide, I⁻, and its oxyanion, iodate, IO₃⁻. Both species are readily soluble in water and can easily enter the human body through the ingestion of contaminated water or via the food chain for animals (including mammals and many fish) that harbor iodate naturally, as well as via inhalation. Exposure to radioisotopes of iodine can lead to thyroid pathologies, including issues with hormone production and cancer.

Many studies regarding the removal of iodine species from water are focused on removal of I⁻. Further, current materials for IO₃⁻ removal are often limited by slow kinetics or low uptake capacities, resulting in large amounts of sorbent being required for sufficient uptake. Further still, studies regarding the use of metal-organic frameworks (MOFs) as sorption platforms for iodine has been heavily focused on adsorption of gaseous I₂.

Even in the absence of competitive anion impurities in water streams, the ability of typical ion exchange resins to reduce effluent concentrations of iodate, for example, down to desired, ultra-low levels is thermodynamically limited by dynamic re-release of captured anionic species of iodine back into otherwise purified effluent water. Such phenomena are termed “equilibrium sloughage” (alternatively termed “equilibrium leakage”). Such sloughage makes use of typical resin-based, separations media essentially impossible for achieving, for example, iodate removal to levels below roughly 10 ppb within the aqueous effluent.

In addition, removal of certain liquid phase cations from certain industrial liquid streams can be advantageous. Certain cations found in industrial wastewater streams may be environmental pollutants or deleterious to the industrial process, necessitating their removal from the corresponding liquid stream. For example, certain cations in wastewater and other liquid process streams associated with power generation processes, such as fossil and nuclear process coolants and service cooling water, may need to be removed.

For example, lead is believed to be involved in intergranular attack and stress corrosion cracking of steam generator tubes in nuclear power plants. Lead, which is highly soluble, is ubiquitous in the nuclear plant environment, with sources from welding, soldering, lubrication, the extensive use of lead material for radiation shielding, leading to lead contamination in steam generator feedwater. Lead is known to accelerate stress corrosion cracking of several different alloys (e.g., Alloy 600, 800, and 690) used in steam generator tubes. Moreover, nuclear utilities are pursuing life extension up to 60 years or more, and new PWR advanced light water reactor designs under construction will use steam generators tubes with 690TT (thermally treated) and 800NG (nuclear grade). In caustic solution, lead causes 690TT and 800NG tubes to actually be more susceptible to stress corrosion cracking than 600MA (mill annealed) tubes, which suffered from severe stress corrosion cracking degradation. Given the significant costs to address these detrimental effects of lead, reducing the amount of lead that comes in contact with steam generator tubes could reduce the risk of lead stress corrosion cracking.

Ion exchange is one method used for removal of cations from liquid streams. For example, ion exchange is used for aqueous cleanup of cationic lead (Pb²⁺) from water streams typical of fossil and nuclear process coolants or service cooling water. However, it is difficult if not impossible to achieve removal that reduces the concentration of the cation in the liquid stream to ultra-low levels (e.g., part per billion or below). In some instances, removal using ion exchange medium is limited due to equilibrium leakage (i.e., the reverse of the uptake reaction). However, removal of cations to such ultra-low levels is necessary to meet technical specifications or discharge regulations. In addition, it should be appreciated that current US environmental protection regulations for lead limits in drinking water are extremely low for example, as low as 10 ppb.

However, achieving such removals of lead is difficult with typical adsorption medium. Even if ionic interactions predominate as with ion exchange, as the medium adsorbs analyte from the influent liquid stream, the analyte concentrates within the pores of the adsorption medium. As a result, the concentration gradient favorable to analyte transport reverses and begins driving the analyte back into the low concentration influent stream. This process is often termed “equilibrium leakage” from the uptake medium, and in the instance of ion exchange beds, it occurs near the outflow end of the bed. Accordingly, the lower the stream concentration desired, the more difficult achieving analyte uptake becomes; this phenomenon is especially relevant to attempts to remove large oxy-anions by typical anion exchange resin, as described above.

It should also be appreciated that removal of other chemical species from liquid streams is important. For example, release of mercury from coal piles, fly ash piles, and certain flue gas desulfurization processes can be an environmental concern. Therefore, mercury capture to minimize discharge can be important.

Additionally, circumstances exist wherein a given liquid or liquid stream contains ionic impurities of both anionic and cationic charges. For example, amphoteric compounds, those that can take on either a positive or a negative charge bias depending on the environment in which they are found, are often found in industrial processes and in environmental cleanup processes. In the nuclear industry, steam generator water is one such environment. Depending acutely on temperature and on local acidity, the elemental lead in steam generator waters can find itself in a cationic (+2) and an oxy-anionic charged speciation, wherein both species are solvated by water molecules.

Therefore, a novel technology is needed that effectively and efficiently removes specific impurities, such as certain anions, cations, or both from water and other liquid streams, such as industrial water-based streams. There is a need for such technology to remove these impurities in the presence of other competing species, or species that may compete for removal, thereby effectively reducing the removal efficiency of the species targeted for removal. There is also a need for such technology to remove these impurities in a manner that specifically targets capture of that impurity and minimizes any reversibility or release from capture, thereby holding it with a much higher binding energy. In particular, a different type of structural media is required to specifically address removal of low levels of particular species with high enough binding energy to maintain near irreversible uptake as analyte concentrations are lowered while competitor concentrations are simultaneously raised.

Accordingly, it would be advantageous to provide a chemical compound that effectively and efficiently removes specific impurities, including liquid phase anions, liquid phase cations, or both from water and other liquid streams, such as other industrial water-based streams. For example, it would be advantageous to provide a chemical compound to remove certain anionic species, such as oxy-anions, such as oxy-anions of selenium, including selenite (SeO₃²⁻) and selenate (SeO₄²⁻); oxy-anions of antimony, including oxy-anions in either the Sb[III] (antimonite) or the Sb[V] (antimonate) redox state; oxy-anions of lead, including oxy-anions in either the Pb[II] or the Pb[IV] redox state, such as Pb(OH)₆²⁻, Pb(OH)₆⁴⁻, PbO₃²⁻, and PbO₂²⁻; oxy-anion species of iodine, including radioisotopes of iodine such as ¹²⁹I and ¹³¹I, which may exist in the liquid or liquid stream as iodide, I⁻, or an oxy-anion of iodine, such as iodate, IO₃⁻; and an oxy-anion of sulfur (sulfate, SO₄²⁻). It would also be beneficial to provide a chemical compound to remove certain cationic species, such as divalent lead (Pb²⁺) or mercury (Hg²⁺). In nuclear power primary reactor coolant cleanup applications, cobalt (Co²⁺), which can be radioactive either as ⁵⁸Co²⁺ or more problematically as ⁶⁰Co²⁺. It should be appreciated that in nuclear plant coolants, the cationic form of lead is problematic since as soon as the electrochemical potential returns to an oxidative level (positive millivolts (mV) relative to a standard hydrogen electrode), the cation will form the noted oxy-anions. It would also be beneficial to provide a chemical compound for the removal of both anionic and cationic species simultaneously from one aqueous liquid or liquid stream, including those above.

More specifically, it would be beneficial to provide such a chemical compound that would reduce concentration of already low levels of a particular species with high enough binding energy to maintain near irreversible uptake and concurrently provide for removal of lead from the liquid stream to ultra-low levels with minimal or no equilibrium leakage. It would also be advantageous to provide such a chemical compound that would provide a high uptake capacity for certain liquid phase cations, thereby reducing the liquid phase concentration of those cations to an ultra-low level with minimal or no equilibrium leakage.

It would also be beneficial to provide a process that utilizes such a chemical compound to remove liquid phase anions, liquid phase cations, or both from water and other liquid streams, such as other industrial water-based streams. For example, it would be advantageous to provide a process for using such a chemical compound to remove certain anionic species, such as oxy-anions, such as oxy-anions of selenium, including selenite (SeO₃²⁻) and selenate (SeO₄²⁻); oxy-anions of antimony, including oxy-anions in either the Sb[III] (antimonite) or the Sb[V] (antimonate) redox state; oxy-anions of lead, including oxy-anions in either the Pb[II] or the Pb[IV] redox state, such as Pb(OH)₆²⁻, Pb(OH)₆⁴⁻, PbO₃²⁻, and PbO₂²⁻; and oxy-anion species of iodine, including radioisotopes of iodine such as ¹²⁹I and ¹³¹I, which may exist in the liquid or liquid stream as iodide, I⁻, or an oxy-anion of iodine, such as iodate, IO³⁻, and sulfate (an oxy-anion of sulfur). In nuclear fuel operations that can expose irradiated fissile fuel to liquid water, it would also be advantageous to provide a process and/or adsorptive media that could remove radioactive pertechnetate (⁹⁹TcO₄₋) from such water. In some light water reactors, it could be beneficial to be able to employ a process and/or an adsorptive media that could remove radioactive nitrogen (¹⁶N) from aqueous coolant (in the form of the oxy-anions nitrate and nitrite) at elevated temperature and pressure It would also be beneficial to provide a process for using such a chemical compound to remove certain cationic species, such as divalent lead (Pb²⁺) or mercury (Hg²⁺⁾ and similar cations in nuclear power primary reactor coolant cleanup applications, like cobalt (Co²⁺) which can be radioactive either as ⁵⁸Co²⁺ or more problematically as ⁶⁰Co²⁺. It would also be beneficial to provide a process for using such a chemical compound for the removal of both anionic and cationic species simultaneously from the same influent liquid or liquid stream, including those above.

It would also be beneficial to provide a process for removing any of the above species specifically from industrial process waters, such as certain liquid streams in fossil or nuclear power plants. For example, it would be beneficial to remove any of the above species from power plant coolant streams such as nuclear power plant coolant streams. In some cases, it would be beneficial to provide a process for removing any of the above species using such chemical compounds from industrial process waters having a certain heat content and minimizing the amount of cooling required. Specifically, it would be beneficial to provide a process and chemical compound for removing any of the above species from a nuclear reactor clean-up loop. It would also be beneficial to provide a process and chemical compound for removing any of the above species from a nuclear reactor clean-up loop at a temperature that is higher than currently used in such clean-up loops, such as used in corresponding demineralizers and ion exchange columns.

It would also be beneficial to provide a process for the generation of such a chemical compound and its preparation for use. For example, it would be beneficial to provide a process for the manufacture of such a chemical compound and its disposition on a substrate for use in removing certain species from a liquid or liquid process stream. It would also be beneficial to provide a process for the regeneration of the chemical compound to allow continued use.

It would further be beneficial to provide an adsorptive media capable of use at elevated temperatures and pressures, relative to the norm for typical polymeric ion exchange resins (which is usually subsaturated liquid water below 65° C.). Applications for such a media could come in the development of new designs for small modular reactors (SMRs) wherein raising the reactor coolant clean-up loop temperature could significantly improve the usual thermal efficiency of the primary plant. Equivalently, high temperature clean-up opportunities for water streams in existing water coolant nuclear power plants could improve present day operations and reduce overall plant operational costs if worker exposure to radioactive species in coolant could be diminished by a clean-up operation additions for liquids or aqueous liquid streams where none had been previously constructed

### BRIEF SUMMARY OF THE INVENTION

In general, the present invention is directed to a metal-organic framework (MOF) for use in removing liquid phase compounds, in particular anionic and cationic species, as well as a combination of anionic and cationic species, from a liquid or liquid stream. In addition, the present invention is directed to various methods or processes for utilizing the MOF to remove such compounds from a liquid or liquid stream, such as an industrial process stream, and for using the MOF at elevated temperatures. In some embodiments, the MOF is MOF 808.

Regarding the removal of anionic species, the MOF adsorbs or complexes with the anionic species in the liquid. Regarding the removal of cationic species, the MOF can be modified through the addition of a ligand that provides for the complexation of such cationic species. The general formula for the MOF and the ligand structure is R₁—SO₂—S—R₂—SH, where R₁ is the MOF, which can be a zirconium-based metal-organic framework, such as NU-1000 or MOF 808, having a pendant group, to which the ligand can be attached. In one embodiment, the ligand may be —SO₂—S—R₂—SH, and where R₂ is an alkyl group that is either ethyl or propyl.

The present invention also provides various processes for using the above MOF compounds to remove given anionic and cationic species from a liquid. Generally, such processes include contacting the MOF with a given liquid or liquid stream, such as industrial process streams, such as liquid process streams used in a nuclear power plant system, and adsorbing the various species, thereby removing the adsorbed species from the liquid or liquid stream.

It should be appreciated that the present invention provides numerous benefits. As noted above, the ability to select a given MOF based upon an intended use or need coupled with the ability to select or tailor the design of the substrate to which the MOF is attached, provides wide latitude in the overall design of the MOF-containing product. Further, the ability of remove various oxy-anions and cations, or both, from various industrial liquid process streams provides significant benefits with respect to process operation.

### BRIEF DESCRIPTION OF THE SEVERAL VIEWS OF THE DRAWINGS

FIG. 1 illustrates a metal organic framework (MOF) according to one embodiment of the present invention;

FIG. 2 illustrates a particular MOF, NU-1000;

FIG. 3 illustrates structural features of the MOF, NU-1000 of FIG. 2;

FIG. 4A illustrates a structure of NU-1000 highlighting the hexagonal pore size and the structure of the Zr₆ node;

FIG. 4B illustrates a structure of UiO-66 highlighting the octahedral pore size and the structure of the Zr₆ node;

FIG. 5 is a bar graph illustrating the number of selenate or selenite molecules adsorbed per node in a series of Zr-based MOFs;

FIG. 6 is a graph illustrating the kinetics of selenate and selenite uptake in NU-1000, UiO66-NH₂ and UiO66-(NH₂)₂;

FIG. 7 illustrates a flow chart outlining the screening process for selenate and selenite adsorption in Zr-based MOFs;

FIG. 8A illustrates diffuse reflectance infrared Fourier transform spectroscopy (DRIFTS) spectrum of as-synthesized NU-1000 (lower trace) and after adsorption of two molecules of selenite (middle trace) and selenate (upper trace);

FIG. 8B illustrates DRIFTS spectrum blown up from 4000-2000 cm-1;

FIG. 8C illustrates potential binding modes of selenate (or selenite) to the node of NU-1000;

FIG. 9A illustrates calculated differential pair distribution functions (PDFs) for selenite and selenate-loaded NU-1000;

FIG. 9B illustrates experimental differential PDFs for selenite and selenate-loaded NU-1000 only showing peaks at distances matching ∂₂μ₂ binding;

FIG. 10 illustrates selenate and selenite uptake vs. time in NU-1000 (2 mg) at low concentration and a starting concentration of 1000 ppb as Se;

FIG. 11 illustrates selenate and selenite uptake vs. time in NU-1000 (2 mg) at low concentration and 40° C. and a starting concentration of 1000 ppb as Se;

FIG. 12 illustrates the selenate and selenite uptake vs. time in NU-1000 (2 mg) at low concentration and pH 6 and a starting concentration of 1000 ppb as Se;

FIGS. 13A-E illustrate the amount adsorbed (q) vs. time at various concentrations of selenate and selenite per node of NU-1000, wherein the amount adsorbed is presented in weight of the full oxy-anion in milligrams normalized by the weight of the bare NU-1000 MOF in grams;

FIGS. 14A-C illustrate a Langmuir plot (linear, type I) for selenite and selenate adsorption on NU-1000, with adsorbed amount as the weight of the full oxy-anions;

FIG. 15A illustrates a powder X-ray diffraction pattern of as-synthesized NU-1000 compared to NU-1000 after adsorption of selenite or selenate;

FIG. 15B illustrates a nitrogen adsorption isotherm of as-synthesized NU-1000 compared to NU-1000 after adsorption of selenite or selenate;

FIGS. 16A-C illustrate selenate and selenite uptake as a function of time using 2 mg of NU-1000 and 10 mL of aqueous solution containing 100 ppb Se and (a) 100 ppb sulfur S and (b) 500 ppb S and (c) 1000 ppb S as sulfate;

FIGS. 17A-B illustrate the uptake of Sb(OH)₆⁻ over time in terms of uptake per node;

FIG. 18 illustrates a Langmuir fitting from the Sb[V] adsorption isotherms of FIG. 17;

FIG. 19 illustrates the powder x-ray diffraction pattern for NU-1000 and NU-1000 with Sb(OH)₆⁻;

FIG. 20 illustrates the nitrogen isotherm for NU-1000 and NU-1000 with Sb(OH)₆⁻;

FIGS. 21A-C illustrate a zirconium-based MOF, namely MOF-808 according to one embodiment of the present invention;

FIG. 22A illustrates powder X-ray diffraction patterns for the as-synthesized MOF-808 compared to a simulated pattern according to one embodiment of the present invention;

FIG. 22B illustrates ¹H NMR spectroscopy of MOF-808 showing the disappearance of the formate proton according to one embodiment of the present invention;

FIG. 22C illustrates the nitrogen adsorption-desorption isotherm for as-synthesized MOF-808 and pore size distribution according to one embodiment of the present invention;

FIG. 22D shows scanning electron microscopy (SEM) images of as-synthesized MOF-808 crystallites according to one embodiment of the present invention;

FIG. 23A illustrates the kinetics for iodate adsorption using MOF-808 according to one embodiment of the invention;

FIG. 23B illustrates a Langmuir plot of the adsorption of iodate in MOF-808 according to one embodiment of the present invention;

FIG. 24A illustrates a density functional theory (DFT) optimized model of the MOF-808 node with bridging iodate ions according to one embodiment of the invention;

FIG. 24B illustrates a simulated differential pair distribution function (dPDF) of the DFT model of FIG. 24A, experimental dPDF data of iodate-loaded MOF-808, and a simulated dPDF of unbound iodate according to one embodiment of the present invention;

FIG. 24C illustrates diffuse reflectance infrared Fourier transform spectroscopy data of bare and iodate-loaded MOF-808 according to one embodiment of the present invention;

FIG. 25A illustrates a DFT optimized model of the MOF-808 node with bridging iodate ions according to one embodiment of the invention;

FIG. 25B illustrates a simulated dPDF of the DFT model of FIG. 25A, experimental dPDF data of iodate-loaded MOF-808, and a simulated dPDF of unbound iodate according to one embodiment of the present invention;

FIG. 26A illustrates a DFT optimized model of the MOF-808 node with bridging iodate ions according to another embodiment of the invention;

FIG. 26B illustrates a simulated dPDF of the DFT model of FIG. 26A, experimental dPDF data of iodate-loaded MOF-808, and a simulated dPDF of unbound iodate according to another embodiment of the present invention;

FIG. 27A illustrates a DFT optimized model of the MOF-808 node with bridging iodate ions according to another embodiment of the invention;

FIG. 27B illustrates a simulated dPDF of the DFT model of FIG. 27A, experimental dPDF data of iodate-loaded MOF-808, and a simulated dPDF of unbound iodate according to another embodiment of the present invention;

FIG. 28A illustrates a DFT optimized model of the MOF-808 node with bridging iodate ions according to another embodiment of the invention;

FIG. 28B illustrates a simulated dPDF of the DFT model of FIG. 28A, experimental dPDF data of iodate-loaded MOF-808, and a simulated dPDF of unbound iodate according to another embodiment of the present invention;

FIG. 29A illustrates powder X-ray diffraction patterns for MOF-808 according to one embodiment of the present invention;

FIG. 29B illustrates nitrogen gas adsorption/desorption isotherms for various forms of MOF-808 according to one embodiment of the present invention;

FIGS. 30A-D show SEM images for iodine, zirconium, and MOF-808 crystallite and an SEM energy dispersive x-ray spectroscopy (SEM-EDS) line scan analysis according to one embodiment of the present invention;

FIGS. 31A-D illustrate adsorption and desorption cycles for iodate in MOF-808 according to one embodiment of the present invention.

FIG. 32 illustrates a generic chemical compound for use in removing a cation from a liquid according to one embodiment of the invention;

FIG. 33 illustrates one chemical compound for use in removing a cation from a liquid according to one embodiment of the invention;

FIG. 34 illustrates another chemical compound for use in removing a cation from a liquid according to another embodiment of the invention;

FIG. 35 illustrates the chemical compound of FIG. 33 interacting with cationic lead cation according to one embodiment of the invention;

FIG. 36 illustrates the chemical compound of FIG. 34 interacting with cationic lead cation according to one embodiment of the invention;

FIG. 37 illustrates the results of the adsorption of sulfate in MOF-808 according to one embodiment of the invention;

FIG. 38 illustrates the results of the adsorption of sulfate in MOF-808 according to another embodiment of the invention;

FIG. 39 illustrates a Langmuir plot for the MOF-808 adsorption of FIG. 38;

FIGS. 40A and 40B illustrate the results of kinetic studies of the adsorption of sulfate in MOF-808;

FIG. 41 illustrates DRIFTS as performed on MOF-808 to confirm the nodal adsorption mechanism by the sulfate oxyanion according to one embodiment of the invention;

FIG. 42 DRIFTS as performed on MOF-808 to confirm the nodal adsorption mechanism by the sulfate oxyanion according to another embodiment of the invention;

FIGS. 43A-B illustrate DFT optimized MOF-808 node with bridging sulfate comparison to experimental pair distribution function of sulfate loaded MOF-808;

FIG. 44 illustrates sulfate uptake by MOF 808 after 3 hours at 20° C., 80° C., and 120° C. according to one embodiment of the invention;

FIG. 45 illustrates sulfate uptake by MOF 808 after 24 hours at 20° C., 80° C., and 120° C. according to one embodiment of the invention;

FIG. 46 illustrates powder X-Ray diffractograms of as-synthesized MOF-808 and MOF-808 after 3-hour sulfate adsorption experiments at 20° C., 80° C., and 120° C.;

FIGS. 47-51 illustrates Langmuir plots for sulfate adsorption in MOF-808 at various temperatures;

FIG. 52 illustrates pseudo second order kinetics fits for MOF-808 sulfate adsorption at 1.5/n exposures up to 3 hours at 20° C., 40° C., 60° C., and 80° C.;

FIG. 53 illustrates powder X-ray diffractograms of as-synthesized MOF-808 and MOF-808 after 72-hour sulfate adsorption experiments at 20° C., 80° C., and 120° C. and after 3-hour adsorption experiments at 150° C. and 200° C.; and

FIG. 54 illustrates nitrogen adsorption-desorption isotherms for as-synthesized MOF-808 and MOF-808 after 72-hour sulfate adsorption experiments at 20° C. and 120° C. and 3-hour adsorption experiments at 150° C. and 200° C.

### DETAILED DESCRIPTION OF THE INVENTION

The present invention is more fully described below with reference to the accompanying drawings. While the present invention will be described in conjunction with various embodiments, such should be viewed as examples and should not be viewed as limiting or as setting forth the only embodiments of the invention. Rather, the present invention includes various embodiments or forms, various related aspects or features, and various uses, as well as alternatives, modifications, and equivalents to the foregoing, all of which are included within the spirit and scope of the invention and the claims, whether or not expressly described herein. Further, the use of the terms “invention,” “present invention,” “embodiment,” and similar terms throughout this description are used broadly and are not intended to mean that the invention requires, or is limited to, any particular embodiment or aspect being described or that such description is the only manner in which the invention may be made or used.

In general, the present invention is directed to a metal-organic framework (MOF) for use in removing liquid phase compounds, in particular anionic and cationic species, as well as a combination of anionic and cationic species, from a liquid or liquid stream. In addition, the present invention is directed to various methods or processes for utilizing the MOF to remove such compounds from a liquid or liquid stream, such as an industrial process stream, and for using the MOF at elevated temperatures. At temperatures exceeding saturation for atmospheric pressure, the liquid or liquid stream is presumed to be kept at elevated pressure, as well, in order to suppress volatilization/boiling so as to maintain these solutions in the liquid state. While historically MOFs have been applied to gas states alone, the present invention contemplates application to liquid state alone. Application to a mixture of vapor and liquid, such as seen in “wet” steam, is also a potential utilization of MOFs from this invention as the liquid portion of the two-phase stream could still be purified via MOF use as described by the present invention. The present invention also provides various methods for attaching the MOF to a substrate for use and for regenerating the MOF.

Metal-organic frameworks (MOFs) are coordination polymers consisting of metal centers connected to one another by molecular organic ligands to form networks that often form via self-assembly into crystalline and highly porous materials. The metal nodes can be single metal ions, chains, or clusters, while the organic ligands, or linkers, can be di-, tri, or tetratopic. Due to the vast array of metal and organic linker combinations, and a multitude of accessible topologies, MOFs can be designed to have large surface area, permanent porosity, and high thermal and chemical stability. In particular, zirconium-based MOFs, constructed using a Zr₆ octahedron cluster as the metal node, take advantage of the strong Zr(IV)—O bond between the metal center and multitopic carboxylate linkers, resulting in robust materials that are stable in aqueous conditions. Additionally, they can possess accessible metal sites, capped by labile —OH and —OH₂ ligands, that allow for the adsorption of a variety of guest molecules. In one embodiment, the zirconium-based MOF is NU-1000, and in another embodiment, the zirconium-based MOF is MOF-808 (also known in the literature as Zr-MOF-808).

In some embodiments, the MOF is a Zr-based MOF, such as NU-1000 or MOF 808, having the ability to complex or adsorb certain anionic species and optionally having an attached ligand for complexation with certain cationic species. The anionic species that may be removed include, for example, oxy-anions, such as oxy-anions of selenium, including selenite (SeO₃²⁻) and selenate (SeO₄²⁻); oxy-anions of antimony, including oxy-anions in either the Sb[III] (antimonite) or the Sb[V] (antimonate) redox state; oxy-anions of lead, including oxy-anions in either the Pb[II] or the Pb[IV] redox state, such as Pb(OH)₆²⁻, Pb(OH)₆⁴⁻, PbO₃²⁻, and PbO₂²⁻; oxy-anion species of iodine, including radioisotopes of iodine such as ¹²⁹I and ¹³¹I, which may exist in the liquid or liquid stream as iodide, I⁻, or an oxy-anion of iodine, such as iodate, IO³⁻; and an oxy-anion of sulfur (sulfate). The cationic species that may be removed include, for example, divalent lead (Pb²⁺) or mercury (Hg²⁺) and similar cations in nuclear power primary reactor coolant cleanup applications, such as cobalt (Co²⁺), which can be radioactive either as ⁵⁸Co²⁺ or more problematically as ⁶⁰Co²⁺. Accordingly, the MOF of the present invention provides for the capture or removal of specific anionic species, specific cationic species, or both from a given liquid or liquid stream.

In one embodiment, the MOF has a molecular formula of Zr₆(μ₃O)₄(μ₃OH)₄(OH)₄(H₂O)₄(TBAPy)₂, wherein TBAPy is 1,3,6,8-tetrakis (p-benzoic-acid)pyrene (known as NU-1000). Without being limited by theory, the preferred mechanism for complexation of the oxy-anion by the MOF is adsorption. In one embodiment, the adsorption of the oxy-anion by the MOF is through nodal uptake via the zirconium oxide/hydroxide nodal features of the MOF. In another embodiment, the MOF may be MOF 808, which is a Zr₆-cluster-based MOF with 6-connected nodes bridged by the commercially available, tritopic, 1,3,5-benzenetricarboxylate linker. MOF 808 has a molecular formula of Zr₆O₄(OH)₄(BTC)₂(HCOO)₆, where BTC is 1,3,5-benzenetricarboxylate, before activation, and a molecular formula of Zr₆(μ₃—O)₄(μ₃—OH)₄(BTC)₂(OH)₆(H₂O)₆, where BTC=1,3,5-benzenetricarboxylate, after acid washing and activation. Activation usually involves heating and vacuum drying in order to remove solvents employed during synthesis from the resultant MOF surface structures.

Specifically regarding the removal of cationic species, the MOF can be modified through the addition of a ligand that provides for the complexation of such cationic species. The general formula for the MOF and the ligand structure is R₁—SO₂—S—R₂—SH, where R₁ is the MOF, which can be a zirconium-based metal-organic framework, such as NU-1000 or MOF 808, having a pendant group, to which the ligand can be attached.

In one embodiment, the ligand may be —SO₂—S—R₂—SH, and where R₂ is an alkyl group that is either ethyl or propyl. The ligand for complexation with cationic species attached to the MOF is a thiosulfonyl-thiol (—SO₂—S—R₂—SH, where R₂ is an alkyl group) ligand, also known as a thio-alkyl-sulfonyl-mercaptan ligand. This ligand may be attached to the MOF by any means known in the art provided that such does not significantly interfere with the MOF's ability to adsorb a particular anion. In some embodiments, this ligand may be attached to the MOF through a pendant group attached to the MOF. In some embodiments, the pendant group is attached to a linker of the MOF. It should be appreciated that multiple pendant groups, each attached to separate linkers of the MOF, can be used. It should be also appreciated that the sulfonyl group attached to the MOF is such that the thioalkyl group can be attached to the sulfonyl group on the MOF through nucleophilic attack. Therefore, any pendant group to which the sulfonyl group can be attached, and that itself can be attacked nucleophilically, can be used to attach the ligand of the present invention to the MOF. In some embodiments the pendant group is a pendant benzyl group attached to the MOF to which the sulfonyl (i.e., —SO₂₋) functionality attaches.

In another embodiment, the ligand may be a ligand for sequestration of other cations, such as cobalt, iron, nickel, and zinc. In one embodiment, this ligand may be tetraehtylenepentamine (TEPA), which is H₂N[CH₂CH₂NH]₄H. This ligand is described in more detail in U.S. Pat. Nos. 8,975,340; 9,214,248; and 9,589,690, each of which is hereby incorporated by reference in its entirety. This ligand may be attached to the MOF by any means known in the art provided that such does not significantly interfere with the MOF's ability to adsorb a particular anion. For example, this ligand may be attached to the MOF through a benzyl-to-amino linkage, using the available MOF organic linker aromatic functionality as a substrate for placing the TEPA ligand within the MOF cavity. Known MOF chemistry synthetic methods (SALE, solvent assisted linker exchange, and SALI, solvent assisted ligand incorporation) may be employed to accomplish this chemical transition of the original MOF to a TEPA cavity-substituted MOF. In some embodiments, this ligand may be attached to the MOF through a pendant group attached to the MOF. In some embodiments, the pendant group is attached to a linker of the MOF. It should be appreciated that multiple pendant groups, each attached to separate linkers of the MOF, can be used. Similarly, any pendant group to which the linker organic features of the MOF can be reacted, and that itself can be attacked nucleophilically, can be used to attach the ligand of the present invention to the MOF. In some embodiments the pendant group is a pendant benzyl group attached to the MOF to which the amino functionality attaches. In addition, the above patents describe methods for attaching this ligand to a resin, which may alternatively be used to attach this ligand to a MOF of the subject invention.

It should be appreciated that appropriate pendant groups can be attached to the linker portions of the MOF using SALE or SALI (see for example, P. Deria, W. Bury, J. T. Hupp and O. K. Farha, “Versatile Functionalization of the NU-1000 Platform by Solvent-Assisted Ligand Incorporation,” Chem. Commun. 2014, 50, 1965-1068; and, P. Deria, J. E. Mondloch, O. Karagiardi, W. Bury, J. T. Hupp and O. K. Farha, “Beyond Post-Synthesis Modification: Evolution of Metal-Organic Frameworks via Building Block Replacement,” Chem. Soc. Rev., 2014, 43, 5896-5912). Accordingly, SALE or SALI can be used to attach pendant benzyl groups to various positions on the MOF, including the organic linker portions. In one embodiment, pendant benzyl groups can be created by attaching a phenyl group to the linker portion of the MOF via a styrene bond (e.g., [MOF]—HC═C—CH-phenyl). In some embodiments, SALE may be used to place the pendant benzyl group within or inside of the MOF structure, such as in the middle or approximately in the middle, of the MOF, as opposed to, in some embodiments, using SALI to place the pendant benzyl group near the aperture of the MOF structure.

With respect to the complexation of the cationic species with the ligand —SO₂—S—R₂—SH attached to the MOF for complexation with cationic species, it should be appreciated that an important aspect of the ligand is the synthesis of the —SO₂—S— bond, i.e., the S—S bonding between the thio-alkyl and the sulfonyl moieties. This provides a ligand having a mercapto-sulfur of the thio-sulfonyl moiety and a terminal mercaptan moiety (—SH). As described below, a cation such as lead is complexed through a bis-sulfur interaction with the ligand in which the lead cation (Pb²⁺) complexes with the mercapto-sulfur of the thio-sulfonyl moiety and to the terminal mercaptan moiety (—SH), which essentially “backbites” the lead cation (Pb²⁺) thereby forming five or six member open rings or ring-like geometries, depending upon whether the R₂ alkyl group is ethyl or propyl, respectively. The complexation of the cation with the ligand may also be referred to as an ionic interaction or chemisorption, which occurs through the positive charge on the cation and the electronegativity of the mercapto-sulfur of the thio-sulfonyl moiety and a terminal mercaptan moiety. Accordingly, it should be appreciated that cations other than lead may be complexed using the ligand of the present invention. For example, cations that are similar to lead (Pb²⁺), such as cationic mercury, may be complexed in a similar fashion. Similarly, with respect to the complexation of the cationic species with the ligand H₂N[CH₂CH₂NH]₄H attached to the MOF for complexation with cationic species, the lone electron pairs on multiple nitrogen atoms in the amine may be used to coordinate the cation, such as Co²⁺. Indeed, if this ligand is available to the incoming cobalt cation within the MOF cavity, complexation with the ligand would retard the cobalt cation significantly from exiting the MOF cavity, using the MOF as a combination covalently binding and geometrically excluding media for removing the cationic impurity from the inlet, flowing solution.

Accordingly, it should be appreciated that such a MOF with a ligand can also be used to concurrently complex with a given anionic compounds or species, such as those described above. In one embodiment, the present invention provides a method for reducing the concentration of both oxy-anions and cations from a liquid stream, comprising contacting a liquid stream comprising an oxy-anion and a cation with a chemical compound having the formula R₁—SO₂—S—R₂—SH, wherein R₁ comprises a zirconium-based metal-organic framework having a pendant group attached to an organic linker and R₂ comprises an alkyl; complexing the oxy-anion with the zirconium-based metal-organic framework, thereby reducing the concentration of the oxy-anion in the liquid stream; and complexing the cation with the chemical compound, thereby reducing the concentration of the cation in the liquid stream. In another embodiment, the pendant group is a pendant benzyl group and wherein the oxy-anion complexes with a node of the zirconium-based metal-organic framework and wherein the cation complexes with a mercapto-sulfur of a thio-sulfonyl moiety of the chemical compound and a terminal mercaptan of the chemical compound to form a ring-like geometry. Similarly, a MOF having the ligand H₂N[CH₂CH₂NH]₄H attached may similarly remove both anions and cations.

It should also be appreciated that MOF with the ligand for complexation with cationic species can be used to remove amphoteric compounds, or those that can take on either a positive or a negative charge bias depending on the environment in which they are found. For example, a lead oxy-anion and a lead cation may be adsorbed by a MOF suitably functionalized by the ligand. As described below, the NU-1000 zirconium MOF can be used to adsorb lead oxy-anions in solution via a nodal uptake mechanism. Simultaneously, if the lead cationic uptake ligand were available on the internal surface of the MOF cavity, then cationic lead could be removed within the MOF cavity while the anionic oxy-anion form could be removed on the zirconium nodal structures.

It should be appreciated that in some embodiments demanding both anion and cation adsorption from one influent liquid or liquid stream a mixture of Zr-MOFs may be applied to removing these species simultaneously. For example, one MOF would be directed to the removal of anions, like oxy-anion adsorption to Zr-based nodes and/or adsorption of other anions to SALE- and/or SALI-inserted ligands, and a second MOF would be directed to removal of cations by SALE- or SALI-inserted ligands, such as for the bivalent cations of zinc, cobalt, nickel, lead, mercury, or ferrous iron.

It should be appreciated that tailoring the cavity and aperture dimensions of certain Zr-MOFs via synthetic control of porosity may allow other MOF constituents of a possible mixture of MOFs for clean-up of aqueous ions for which ligand or nodal electronic interactions are unavailable. For example, geometric capture of large cations like cesium and like silver could be accomplished by hold-up of these large analytes within the MOF cavity, much like they might be held-up in present-day zeolites. ¹³⁷Cs⁺ and ^{110m}Ag⁺, cesium and silver cations, respectively, that are found in nuclear power reactor primary coolant and radiological wastewaters are examples of large-sized, singly charged cations that are difficult to remove from aqueous solutions down to low concentrations by ion exchange resins alone.

The present invention also provides various processes for using the above MOF compounds to remove given anionic and cationic species from a liquid. Generally, such processes include contacting the MOF with a given liquid or liquid stream and adsorbing the various species, thereby removing the adsorbed species from the liquid or liquid stream.

Generally, the present invention provides methods for using the MOFs described above to remove the various species described above from a given liquid, including liquid streams, such as industrial process streams. Specifically, the MOFs of the present invention can be used to remove various anionic species, including, for example, oxy-anions, such as oxy-anions of selenium, including selenite (SeO₃²⁻) and selenate (SeO₄²⁻); oxy-anions of antimony, including oxy-anions in either the Sb[III] (antimonite) or the Sb[V] (antimonate) redox state; oxy-anions of lead, including oxy-anions in either the Pb[II] or the Pb[IV] redox state, such as Pb(OH)₆²⁻, Pb(OH)₆⁴⁻, PbO₃²⁻, and PbO₂²⁻; oxy-anion species of iodine, including radioisotopes of iodine such as ¹²⁹I and ¹³¹I, which may exist in the liquid or liquid stream as iodide, I⁻, or an oxy-anion of iodine, such as iodate, IO³⁻; and an oxy-anion of sulfur (sulfate). Additionally, the MOFs of the present invention having an attached ligand for complexation with cationic species can be used to remove not only the various anionic species but also certain cationic species, such as, for example, divalent lead (Pb²⁺) or mercury (Hg²⁺) and similar cations in nuclear power primary reactor coolant cleanup applications, such as cobalt (Co²⁺), which can be radioactive either as ⁵⁸Co²⁺ or more problematically as ⁶⁰Co²⁺, from a liquid stream, such as an industrial process liquid stream, including, for example, a power plant process stream or a wastewater stream. It should be appreciated that the ability of the MOF, such as NU-1000 or MOF 808, to reduce the concentration of the oxy-anion in water provides for a more environmentally acceptable water stream. In addition, without being limited by theory, it is believed that the complexation of the cationic species, by the ligand attached to the MOF through the mercapto-sulfur of the thio-sulfonyl moiety and the backbiting terminal mercaptan moiety or through the use of the TEPA ligand, provides the ability to remove significant amounts of the cation from a given liquid, resulting in the ability to achieve extremely low concentrations of the given cation within the liquid or liquid stream.

Generally, the liquid or liquid stream is brought into contract with the MOF for complexation with the desired anionic or cationic species, resulting in the adsorption of that species by the MOF and, accordingly, their removal from the liquid or liquid stream. For example, the MOFs of the present invention may be brought into contact with a given liquid or liquid stream using known methods for contacting a liquid and an adsorbent to provide contact between the liquid containing one or more liquid species to be removed from the liquid with the MOF. Upon contact, the liquid species to be removed would attach to the MOF and, therefore, be removed from the liquid.

For example, the MOFs of the present invention may be attached to any structure that is used to facilitate contact between the liquid stream having the particular species to be removed and the MOF. For example, the MOF can be attached to pre-coatable filter/demineralizers or independent packed columns, including such devices already in use at a given facility or plant (e.g., existing vessels used for ion exchange). Thereafter, the structure can be appropriately mounted to allow contact between the liquid stream and the MOF on the structure. Once in contact with the liquid stream, the particular species to be removed is adsorbed onto the MOF, thereby reducing the concentration of that species in the liquid stream. As described above, the MOFs of the present invention may be used to remove certain anionic compounds, cationic compounds, or both from a given liquid or liquid stream.

It should be appreciated that the liquid or liquid stream may be any liquid or liquid stream containing anionic or cationic species, or both, that can be removed by the MOFs of the present invention. In some embodiments, the liquid stream may be an industrial process stream or wastewater stream. The liquid stream may be an industrial process stream such as a power plant coolant stream, such as nuclear power plant reactor coolant stream or clean-up stream.

It should be appreciated that in some embodiments, the liquid stream, such as the industrial process stream, such as a nuclear power plant reactor coolant stream or clean-up stream, may be at a temperature where it may be desirable to maintain the heat content of that stream or minimize the heat loss, such as reducing the amount of cooling required for removing a given species from that liquid stream. Accordingly, the present invention provides the ability to utilize the MOFs described above at higher temperatures to minimize the amount of cooling and thereby improve overall thermal efficiency of the process and nuclear reactor operation. The MOFs of the present invention provide the ability to remove the various species described above at higher than normal temperatures to provide thermal efficiency for liquid streams that would otherwise require cooling prior to treatment.

For example, in present day LWRs, including GEN III and GEN III+ reactors, the primary coolant average temperature can be around 310° C., but the coolant clean-up stream must be brought down to below roughly 45° C. in order that the polymeric resins used for ion exchange do not thermally degrade. Certainly, at temperatures above roughly 60° C. to 65° C., even typical nuclear grade polymeric resins that are presently used for coolant clean-up will chemically degrade, thereby throwing tramp organo-sulfonates and aminates forward into the effluent of the liquid or liquid stream that they supposedly are ridding of these types of species (Organic portions of these tramp materials will rapidly degrade within a nuclear power reactor or steam generator, leaving the inorganic ions to contaminate those coolants.) That stream requiring clean-up then must be re-heated to at least T_{cold} (the cold leg of the reactor coolant, at roughly 285° C.) in order to be recombined with the bulk reactor coolant flow. In GEN IV reactors (so called advanced reactors, several using aqueous coolants that are of small modular reactor design) the average coolant temperature can likely exceed 325° C. Hence, cooling to 45° C. would entail an even greater thermal efficiency cost. Therefore, the idea of only having to cool to MOF stability temperatures would provide an energy efficiency improvement.

Further, the use of ion-exchange columns for cleaning nuclear power plant reactor coolant streams or clean-up streams requires that these streams be cooled to obtain the desired removal of a given species. Such results in heat loss. The MOFs of the present invention would allow the clean-up loop temperature to remain well above the roughly 45° C. to 65° C. approximate thermal limit for nuclear grade ion exchange resins, such as up to approximately 150° C., for purpose of improving energy efficiency of the loop and not having to cool the kidney flow nor reheat it as much.

As described above, it should also be appreciated that while the various methods or processes of the present invention are described in the context of using one particular MOF, that in some embodiments demanding both anion and cation adsorption from one influent liquid or liquid stream, a mixture of Zr-MOFs may be applied to removing these species simultaneously. For example, one MOF would be directed to the removal of anions, like oxy-anion adsorption to Zr-based nodes and/or adsorption of other anions to SALE- and/or SALI-inserted ligands, and a second MOF would be directed to removal of cations by SALE- or SALI-inserted ligands, such as for the bivalent cations of zinc, cobalt, nickel, lead, mercury, or ferrous iron.

The present invention also describes methods for attaching certain MOFs to a substrate to form a MOF-containing product that can be used in numerous ways depending upon the specific MOF attached to the substrate. Accordingly, it should be appreciated that a particular MOF having a particular property, such as an affinity for a particular species to be removed from a given fluid, may be selected for attachment to the substrate. The substrate may be any substrate to which a given MOF may be attached, and the form and shape of the substrate may be selected based upon its ultimate use. For example, the configuration or shape of the substrate may be selected to allow use of the selected MOF in a given environment, such as a given industrial process or a given piece of equipment and provide the proper exposure of the MOF in that environment, such as exposure of the MOF to a given fluid in a given process or piece of equipment.

It should be appreciated that the MOF to be attached for a substrate may be any one of the MOFs described herein. For example, in one embodiment, the MOF may be a MOF capable of removing certain chemical species from a given fluid. For example, the MOF may be a MOF capable or configured to remove certain liquid phase species from a given liquid or liquid stream. In some embodiments, the MOF is a Zr-based MOF, such as NU-1000 or MOF 808, for removal of certain anions, such as oxy-anions, from a liquid or liquid stream. In other embodiments, the MOF is a Zr-based MOF, such as NU-1000 or MOF 808, configured for removal of certain cations from a liquid or liquid stream as described herein. In some embodiments, the MOF is a Zr-based MOF, such as NU-1000 or MOF 808, configured for removal of both certain anions, such as certain oxy-anions, and certain cations from a liquid or liquid stream as described herein. In other embodiments, the MOF is a Zr-based MOF, such as NU-1000 or MOF 808, having the ability to complex or adsorb certain anionic species and having an attached ligand for complexation with certain cationic species as described herein.

In one embodiment, the substrate may be any inert substrate to which the MOF may be attached. For example, the substrate may be inert polypropylene polymer resin beads, a macroscopic fabric such as a mesh material or mesh filter, a molecular fabric, or any other three-dimensional shaped substrate.

In one embodiment the MOF, including any of the MOFs described herein, such as a Zr-based MOF such as NU-1000 or MOF 808 with or without the ligand for complexation with certain cationic species as described herein, may be attached to an inert substrate such as polypropylene polymer resin beads, a macroscopic fabric such as a mesh material or mesh filter, or a molecular fabric. In one embodiment for attaching the MOF, the substrate is initially subjected to atomic layer deposition of a metal oxide, such as aluminum oxide, titanium oxide, or zinc oxide, to the surface of the substrate. Separately, the MOF may be attached to cetyl-trimtheylammonium bromide (CTAB) in a solution that is then combined with the substrate with the metal oxide. This results in attachment of the MOF to the substrate and the production of a commercial product consisting of a substrate having an attached MOF. In another embodiment for attaching the MOF to the substrate, the MOF may be attached to beta-cyclodextrin (beta-CD) in a solution that is then combined with the substrate. This results in attachment of the MOF to the substrate via the beta-CD and the production of a commercial product consisting of a substrate having an attached MOF.

It should be appreciated the MOF-containing substrate, which may be a commercial product, may be used in numerous ways, depending upon the MOF selected for attachment to a given substrate. As noted above, in some embodiments, the MOF may be a MOF capable of removing certain chemical species from a given fluid. For example, the MOF may be a Zr-based MOF, such as NU-1000 or MOF 808, configured for removal of certain anions, such as certain oxy-anions, and certain cations from a liquid or liquid stream. Specifically, the MOF may be used on a substrate to remove oxy-anions of selenium, including selenite (SeO₃²⁻) and selenate (SeO₄²⁻); oxy-anions of antimony, including oxy-anions in either the Sb[III] (antimonite) or the Sb[V] (antimonate) redox state; and oxy-anions of lead, including oxy-anions in either the Pb[II] or the Pb[IV] redox state, such as Pb(OH)₆²⁻, Pb(OH)₆⁴⁻, PbO₃²⁻, and PbO₂²⁻; oxy-anion species of iodine, including radioisotopes of iodine such as ¹²⁹I and ¹³¹I, which may exist in the liquid or liquid stream as iodide, I⁻, or an oxy-anion of iodine, such as iodate, IO³⁻; and an oxy-anion of sulfur (sulfate). Further, the addition of certain ligands to these MOFs provides for the removal of certain cation species, such as divalent lead (Pb²⁺) or mercury (Hg²⁺) and similar cations in nuclear power primary reactor coolant cleanup applications, such as cobalt (Co²⁺), which can be radioactive either as ⁵⁸Co²⁺ or more problematically as ⁶⁰Co²⁺. Accordingly, such MOFs with the attached ligand may provide the ability to concurrently remove both cationic and anionic species from a given liquid or liquid stream, such as power plant coolant or waste streams, including nuclear power plant liquid streams. In other embodiments, the MOF may be a Zr-based MOF used to remove certain chemical species, such as water, from a gas stream or air, including ambient air. Such MOFs may include MOF-801, 801-P, 802, 805, 806, 812, and 841. In other embodiments, the MOF-containing substrate, which may be a commercial product, may be a Zr-based MOF, such as NU-1000 or MOF 808, having the ability to complex or adsorb certain anionic species and having an attached ligand for complexation with certain cationic species as described herein.

It should be appreciated that the present invention provides numerous benefits. As noted above, the ability to select a given MOF based upon an intended use or need coupled with the ability to select or tailor the design of the substrate to which the MOF is attached, provides wide latitude in the overall design of the MOF-containing product. In addition, the placement of a MOF on inert substrates, such as a plurality of chemically inert polypropylene beads, a macroscopic fabric, or a molecular fabric, provides a platform or mechanism for exposing a MOF to a given fluid of interest and removing targeted species from that fluid. Given the capacity of a MOF to sorb a given quantity of a particular species or plurality of species from a fluid, placing the MOF on a given substrate, whose configuration or shape can be controlled to provide the proper exposure of the MOF to the fluid in a given environment, a lower quantity of MOF can be used, thereby significantly reducing the cost of the MOF used in any given process. Basically, porting expensive MOF particles onto inexpensive structures allows for the use of the MOFs in existing industrial structures without the need to produce enough MOF particles to fill the entire structure. For example, in some embodiments, the configuration of the substrate can be used to provide the necessary amount of surface exposure of the MOF to accomplish the desired results of using that MOF without the need to use a relatively large amount of pure MOF. Indeed, coating structures, such as polypropylene beads, a macroscopic fabric such as a mesh filter, or a molecular fabric, with a thin layer of MOF particles may result in a cost significantly below that of using MOF particles without any structural support. Such cost savings would enable bulk use of MOF particles in many industrial processes, including processes in both fossil fuel and nuclear power plants.

For example, placing MOFs on a support structure provides the ability to efficiently bring a given liquid being treated into contact with the MOF to allow for the uptake of the chemical species to be removed by the MOF. Coating of inert beads, such as polypropylene beads, with MOF enables a high degree of surface area contact between the MOFs and any liquid stream in which the beads are deployed. Accordingly, placement of the MOF on the surface of polypropylene beads provides the ability of MOF particles to bind chemical compounds in a liquid stream as the liquid stream is filtered through the MOF structure. Further, the use of MOF-coated inert structures, such as polypropylene beads, enables liquid contact between the MOFs and a flowing liquid stream without convection away from other MOF particles.

It should also be appreciated that the methods of the present invention for attaching the MOFs to a particular substrate and producing a commercial product similarly provides numerous benefits. As noted above, the ability to select a given MOF based upon an intended use or need coupled with the ability to select or tailor the design of the substrate to which the MOF is attached, provides wide latitude in the overall design of the MOF-containing product. In addition, the placement of a MOF on inert substrates, such as a plurality of chemically inert polypropylene beads, a macroscopic fabric, or a molecular fabric, provides a platform or mechanism for exposing a MOF to a given fluid of interest and removing targeted species from that fluid. Given the capacity of a MOF to sorb a given quantity of a particular species or plurality of species from a fluid, placing the MOF on a given substrate, whose configuration or shape can be controlled to provide the proper exposure of the MOF to the fluid in a given environment, a lower quantity of MOF can be used, thereby significantly reducing the cost of the MOF used in any given process. Basically, porting expensive MOF particles onto inexpensive structures allows for the use of the MOFs in existing industrial structures without the need to produce enough MOF particles to fill the entire structure. For example, in some embodiments, the configuration of the substrate can be used to provide the necessary amount of surface exposure of the MOF to accomplish the desired results of using that MOF without the need to use a relatively large amount of pure MOF. Indeed, coating structures, such as polypropylene beads, a macroscopic fabric such as a mesh filter, or a molecular fabric, with a thin layer of MOF particles may result in a cost significantly below that of using MOF particles without any structural support. Such cost savings would enable bulk use of MOF particles in many industrial processes, including processes in both fossil fuel and nuclear power plants.

For example, placing MOFs on a support structure provides the ability to efficiently bring a given liquid being treated into contact with the MOF to allow for the uptake of the chemical species to be removed by the MOF. Coating of inert beads, such as polypropylene beads, with MOF enables a high degree of surface area contact between the MOFs and any liquid stream in which the beads are deployed. Accordingly, placement of the MOF on the surface of polypropylene beads provides the ability of MOF particles to bind chemical compounds in a liquid stream as the liquid stream is filtered through the MOF structure. Further, the use of MOF-coated inert structures, such as polypropylene beads, enables liquid contact between the MOFs and a flowing liquid stream without convection away from other MOF particles.

The present invention is also directed to methods for regenerating the adsorbent, such as the MOF, including a zirconium-based MOF such as MOF-808. In some embodiments, the regeneration of the MOF includes using an acid wash to remove the adsorbed species. In some embodiments, the acid wash may be an aqueous solution of hydrochloric acid, including solutions having up to approximately 10% hydrochloric acid. In some embodiments, up to three washes may be used, resulting in a regenerated MOF having little to no effect on subsequent adsorption performance.

Following, various specific aspects of the invention are described, including the structure of MOFs for use in the present invention, including their synthesis and adsorptive capacity. In addition, methods for using the MOFs of the present invention to remove various species are described, followed by a description of methods for regenerating the MOFs of the present invention. Further, other variations of these embodiments are also described.

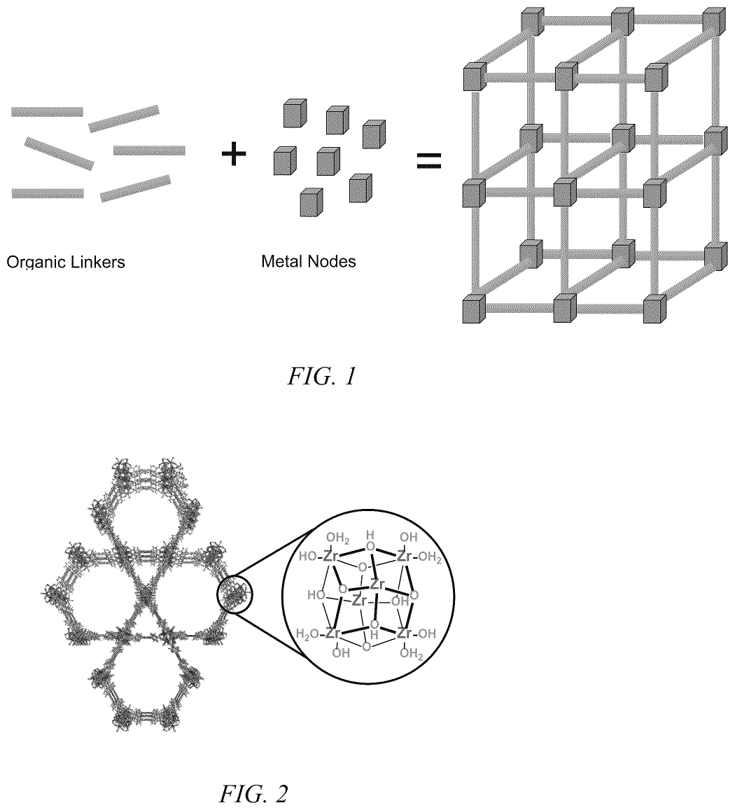

FIG. 1 illustrates a MOF according to one embodiment of the present invention. MOFs are structurally diverse, porous materials that are constructed from metal nodes bridged by organic linkers. MOFs are composed of multi-functional organic linkers and metal-based nodes that are interconnected by coordination bonds of moderate strength. In terms of adsorption or complexation of analyte molecules from aqueous solutions, MOFs containing zirconium metal nodes are of interest due to their inherent stability over a wide pH range in water. This stability arises from the strong Zr(IV)—O bonds, which also makes these frameworks mechanically and thermally robust to temperatures >350° C. MOFs in aqueous solution are appropriate candidate materials in either pre-coatable filter/demineralizer applications or independent packed column separation applications, which may also be consistent with use in vessels already in existence with a given plant, such as a nuclear power plant (e.g., vessels already in use for ion exchange) or a fossil fueled electricity generation plant's flue gas desulfurization wastewater treatment facility.

While the MOF may be usable in such liquid flow applications in its native structure, it is possible that the amount of pressure required to permeate packed beds of such small particles (typical size ranging from 75 to 1200 nanometers with 5 micron crystallites forming from the MOF particles) may exceed available fluid driving equipment, meaning that the MOF particles may need to be ported upon some other larger particle carrier (more of the order of a resin particle, typically 50 to 850 microns diameter in powder or bead form) such that fluid may permeate conglomerates of carrier particles more easily. One of ordinary skill in the art ought to be able to construct multiple methodologies for contacting the MOF particles onto some suitable carrier particle such that the hydraulic permeability of a conglomerate of such carrier particles, either in a columnar flow through a bed of such carrier particles or a flow through a filter providing a porous surface onto which such carrier particles are coated, is sufficiently high to afford the required fluid volumetric throughput. As such, the adsorptive properties of the MOF will still manifest since the MOF itself will be exposed to the analyte in the water stream as it flows about the carrier particles onto which the MOF media are attached.

FIG. 2 illustrates a particular MOF, NU-1000. NU-1000 is a Zr-based MOF and has the molecular formula of Zr₆(μ₃—O)₄(μ₃OH)₄(OH)₄(H₂O)₄(TBAPy)₂, wherein TBAPy is 1,3,6,8-tetrakis (p-benzoic-acid)pyrene that can be used as the MOF in the present invention. The parent-framework node of this MOF consists of an octahedral Zr₆ cluster capped by four μ₃—OH and four μ₃—O ligands. Eight of the twelve octahedral edges are connected to TBAPy units, while the remaining Zr coordination sites (after activation) are occupied by four terminal —OH and four terminal —OH₂ ligands. The 3D structure can be described as 2D Kagome sheets linked by TBAPy ligands. Two of the four terminal —OH groups point into the mesoporous channels, while the remaining terminal hydroxyls lie in smaller apertures between the Kagome sheets.

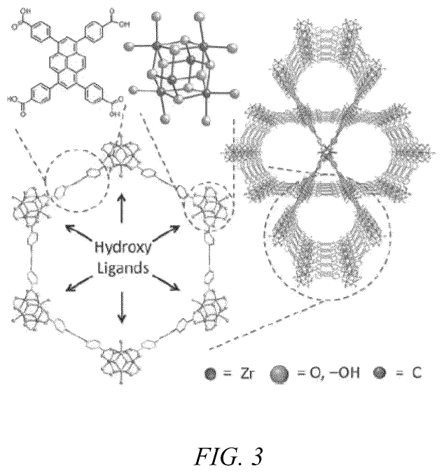

FIG. 3 illustrates structural features of the MOF, NU-1000 of FIG. 2. Further features of this MOF and its synthesis technique are described in Mondloch, JE, W Bury, D Fairen-Jimenez, S Kwon, EJ DeMarco, MH Weston, AA Sarjeant, ST Nguyen, PC Stair, RQ Smurr, OK Farha and JT Hupp, “Vapor-Phase Metalation by Atomic Layer Deposition in a Metal-Organic Framework”, J. Am. Chem. Soc. (2013) 135, 10294-10297, which is incorporated herein by reference in its entirety. For example, synthesis of the organic linker of NU-1000 involves two steps: a Suzuki coupling between 1,3,6,8-tetrabromopyrene and 4-(ethoxycarbonyl)phenylboronic acid followed by hydrolysis of the resulting tetraester compound to give the tetracarboxylic acid linker, 1,3,6,8-tetrakis(p-benzoic acid)-pyrene. To synthesize NU-1000, the Zr₆-cluster nodes are first formed by reacting zirconyl chloride octahydrate with excess benzoic acid modulator for 1 hour at 80° C. in N,N-dimethylformamide. After cooling the reaction mixture to room temperature, 0.2 equivalents of the 1,3,6,8-tetrakis(p-benzoic acid)-pyrene linker are added and the mixture is heated at 100° C. for 24 hours to give benzoic acid capped NU-1000. To remove the benzoic acid ligands and reveal the terminal —OH and —OH2 on the nodes, the MOF is activated with 8M HCl for 24 hours. It should also be appreciated that less pure starting materials of ZrOCl₂·8H₂O and HfOCl₂·xH₂O to reduce the costs of manufacture of the NU-1000. For example, 99.99% pure ZrOCl₂·8H₂O and HfOCl₂·xH₂O cost approximately 400% more than the 98% pure precursors.] Also, structural features of this MOF are described in Planas, N.; Mondloch, J. E.; Tussupbayev, S.; Borycz, J.; Gagliardi, L.; Hupp, J. T.; Farha, O. K.; Cramer, C. J. Defining the Proton Topology of the Zr₆-Based Metal-Organic Framework NU-1000. J Phys. Chem. Lett. 2014, 5, 3716-3723, which is incorporated herein by reference in its entirety.

Bare NU-1000 has surprisingly been found to complex with oxy-anions of selenium, including selenite (SeO₃²⁻) and selenate (SeO₄²⁻), in aqueous solutions. Results to date indicate that oxy-anions of selenium bond with significant strength so as to remove those anions down to 20 ppb levels in simple continuous stirred tank environments within reasonably and relatively fast times and to even lower concentrations, such as 10 ppb and lower, 6 ppb and lower, and 2 ppb and lower in other embodiments. The bonding for selenate and selenite are shown to be to the zirconium nodes of the MOF directly, without worry for the ligand interactions with the MOF cavity. It should be appreciated that the ability of NU-1000 to complex with selenite and selenate has been accomplished without the need for modifying the structure of NU-1000, for example, by functionalizing NU-1000 through metalation using atomic layer deposition (ALD), through solvent-assisted linker exchange (SALE), nor through solvent-assisted ligand incorporation (SALI).

Specifically, a series of zirconium-based MOFs were tested for their ability to adsorb and remove selenate and selenite anions from aqueous solutions. MOFs were tested for adsorption capacity and uptake time at different concentrations. (FIG. 7 is a flow chart outlining the screening process for selenate and selenite adsorption in Zr-based MOFs.) NU-1000 was shown to have the highest adsorption capacity, and fastest uptake rates for both selenate and selenite, of all zirconium-based MOFs in this testing.

Different ratios of adsorbent:adsorbate were tested to understand how the ratio affects uptake. Samples of 2, 4, 6, and 8 mg of NU-1000 were exposed to 10 mL solutions containing 1000 ppb Se as either SeO₄²⁻ or SeO₃²⁻. At all the adsorbent:adsorbate ratios tested, 98.3% or more of the SeO₃²⁻ in solution is adsorbed leaving an average of 10-17 ppb in solution. Similarly, at all adsorbent:adsorbate ratios tested, 97.7% or more of the SeO₄²⁻ in solution is adsorbed leaving an average of 20-23 ppb in solution. In general, these experiments show that changing the adsorbent:adsorbate ratio by 4×, at these concentration levels, does not have a significant impact on the total Se adsorbed from solution. It should be noted that throughout testing NU-1000 for Se uptake, for example studies performed at pH 6 and analogous batch studies performed using 100 ppb Se starting concentrations instead of 1000 ppb, remnant Se concentrations less than 10 ppb (down to 6 ppb and 2 ppb) have been observed when exposing 2 mg of NU-1000 to 1000 ppb and 100 ppb Se respectively. In such embodiments, the present invention may be used to reduce the total selenium concentration (i.e., the total of all selenium species) to less than 10 ppb or the amount set for suitable drinking water standards. Accordingly, the present invention may reduce the total Se concentration in a given liquid or liquid stream by more than 90%, by more than 94%, and by more than 98% in some embodiments.

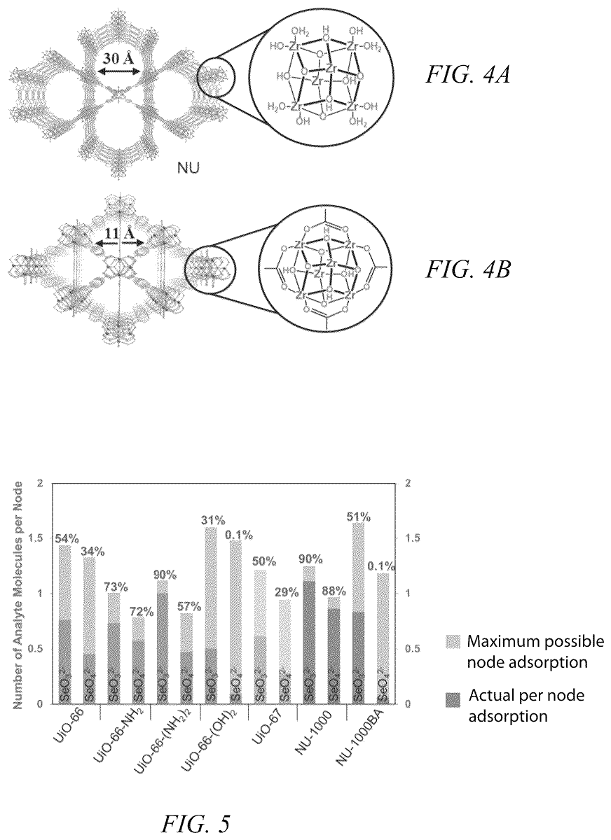

FIG. 4A illustrates a structure of NU-1000 highlighting the hexagonal pore size and the structure of the Zr₆ node. FIG. 4B illustrates a structure of UiO-66 highlighting the octahedral pore size and the structure of the Zr₆ node. Metal-organic frameworks from the NU-1000 (FIG. 4A), UiO-66 (FIG. 4B), and UiO-67 families were screened for their selenate and selenite uptake ability. For initial screening, two samples of each MOF were exposed separately to aqueous solutions of either selenate (100 ppm Se) or selenite (100 ppm Se). After 72 hours of exposure, UiO-66 adsorbed 54% and 34% of the selenite and selenate present in the respective solutions, suggesting that anion exchange is occurring both on, and within, the MOF. This demonstrates that Zr-bound hydroxides in a MOF are useful for adsorption of selenium oxy-anions, despite the strongly bridging nature of the OH group in the nodes of UiO-66. Furthermore, anion exchange appears to be enhanced by the presence of Lewis/Bronsted basic amine groups on the terephthalic acid linker with UiO-66-(NH₂)₂ and UiO-66-NH₂ showing some of the highest selenate and selenite adsorption per Zr₆-node among the MOFs studied (FIG. 5). Without being bound by theory, this is likely a consequence of hydrogen bonding interactions between the amine groups and selenate and selenite anions, similar to hydrogen bonding motifs in amine-containing macrocyclic frameworks which have high affinities for sulfate and selenate anions.

FIG. 5 is a bar graph illustrating the number of selenate or selenite molecules adsorbed per node in a series of Zr-based MOFs. FIG. 5 shows that of the seven MOFs examined, NU-1000 achieves the highest degree of uptake of selenate as well as selenite, both gravimetrically and on a per-node basis. It also accomplishes the most complete removal of these ions from a 100 ppm Se test solution, i.e. 88% (SeO₄²⁻) and 90% (SeO₃²⁻). These results underscore the value and importance of MOFs with non-structural-ligand lability in accomplishing anion uptake.

Again, without being bound by theory, an alternative mode of uptake could conceivably be adsorption of the selenate/selenite sodium salt through, for example, oxy-selenium-anion/node-aqua(hydroxy) hydrogen bonding. ICP-OES (inductively coupled plasma-optical emission spectroscopy) measurements reveal no sodium adsorption in the MOF, indicating that the adsorbates cannot be salts and implying that each adsorbed oxy-selenium di-anion must be charge-balanced by loss of two anionic ligands (presumably hydroxides) from the MOF. ICP-OES measurements additionally established that no zirconium is lost to solution.

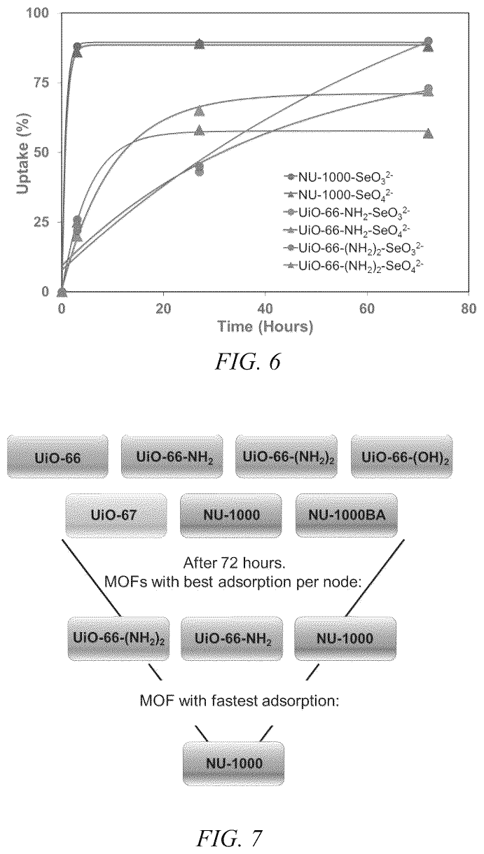

FIG. 6 is a graph illustrating the kinetics of selenate and selenite uptake in NU-1000, UiO66-NH₂ and UiO66-(NH₂)₂. Given the high capacities of UiO-66-NH₂, UiO-66-(NH₂)₂, and NU-1000 for selenate and selenite, the kinetics of SeOₓ²⁻ uptake were also evaluated. As shown in FIG. 6, limiting high-capacity uptake from 100 ppm solutions required ca. 70 hours or more with UiO-66-(NH₂)₂, about 27 hours with UiO-66-NH₂, and less than 3 hours with NU-1000. The faster uptake by NU-1000 compared with UiO-66 and its derivatives is likely related to aperture and pore size. NU-1000 has triangular and hexagonal pores, which are 12 Å and 30 Å in diameter, respectively, with apertures of the same size (FIG. 4A), while UiO-66 comprises tetrahedral and octahedral pores that are 8 Å and 11 Å in diameter, respectively, with an aperture of 7 Å. (FIG. 4B shows the octahedral pore.) The apertures of UiO-66-NH₂ and UiO-66-(NH₂)₂ are anticipated to be even smaller. Selenate and selenite anions have radii of 2.4 Å and 2.6 Å, respectively. Therefore, based on pore size vs. analyte size alone, one would expect diffusion of selenate and selenite through the pores of NU-1000 to be faster than diffusion within UiO-66 derivatives.

Notable features for both NU-1000 and UiO-66-NH₂ are their ability to take up selenate and selenite with essentially equal efficacy—both kinetically and in terms of uptake capacity. The ability to adsorb both forms of inorganic selenium is an important feature for selenium remediation. The high adsorption capacity combined with fast uptake time using NU-1000 suggests that both aperture size and the presence of substitutable ligands (aqua and hydroxy groups) on the Zr₆ node may be important for attaining high uptake capacity and fast uptake kinetics.

Examination of the periodic table of elements would suggest that oxy-anions of the following elements might also be expected to be taken up by such MOFs like NU-1000 in a manner analogous to selenium, namely, oxy-anions of aluminum (that is, water soluble aluminum oxides/hydroxides), silicon (that is, silicates and hydrosilicates), phosphorus (such as phosphates and hydrophosphates), sulfur (that is, sulfates), chlorine (such as chlorates and perchlorates), geranium (that is, water soluble oxides/hydroxides of geranium), arsenic (such as, arsenates), tin (that is, stannates), antimony (such as antimonates and antimonites), iodine (such as iodates, per-iodates and iodites), lead (that is, water soluble oxides/hydroxides of lead), and nitrogen (as nitrates (NO₃⁻) and nitrites (NO₂⁻)).

To gain insight into the mechanism(s) of selenate and selenite adsorption on NU-1000, maximum adsorption capacities per Zr₆ node were determined. When exposed to aqueous solutions containing various concentrations of selenate and selenite anions ranging from 2-7 per node, the maximum adsorption capacity of NU-1000 was found to be two anions per node (Table 1). In addition, the affinities of NU-1000 for selenate and selenite are similar under these conditions, suggesting perhaps that the two analytes are bound in a similar fashion. At initial concentrations corresponding to more than six per node (>90 ppm Se for the solution volume and the amount of sorbent examined), NU-1000 is shown to take up more than two anions per node with concomitant adsorption of sodium cations. This adsorption of sodium shows that NU-1000 can no longer inherently charge balance when adsorption beyond two anions per node occurs. In the absence of Na⁺ co-incorporation, for each doubly-charged selenate or selenite anion adsorbed, two negative charges must be given up by the MOF to maintain charge balance. One way for NU-1000 to accommodate two selenate or selenite anions per node (−4 charge) would be to substitute all four terminal hydroxyl groups (OH⁻) from the Zr₆ node; as detailed below there is likely a substitution of water molecules as well (FIG. 4A).

TABLE 1
Selenite and selenate adsorption per node in NU-
1000 when exposed to various concentrations of
aqueous sodium selenate and sodium selenite.

| | Exposure-Per Node | Uptake-Per Node |
|---|---|---|
| NU-1000- SeO₃²⁻ | 2 | 1.5 |
| NU-1000- SeO₄²⁻ | | 1.3 |
| NU-1000- SeO₃²⁻ | 3 | 1.8 |
| NU-1000- SeO₄²⁻ | | 1.8 |
| NU-1000- SeO₃²⁻ | 4 | 1.7 |
| NU-1000- SeO₄²⁻ | | 2.4* |
| NU-1000- SeO₃²⁻ | 5 | 1.8 |
| NU-1000- SeO₄²⁻ | | 2.0 |
| NU-1000- SeO₃²⁻ | 6 | 2.2 |
| NU-1000- SeO₄²⁻ | | 1.7 |
| NU-1000- SeO₃²⁻ | 7 | 4.3* |
| NU-1000- SeO₄²⁻ | | 3.4* |

*Na⁺ was also adsorbed.

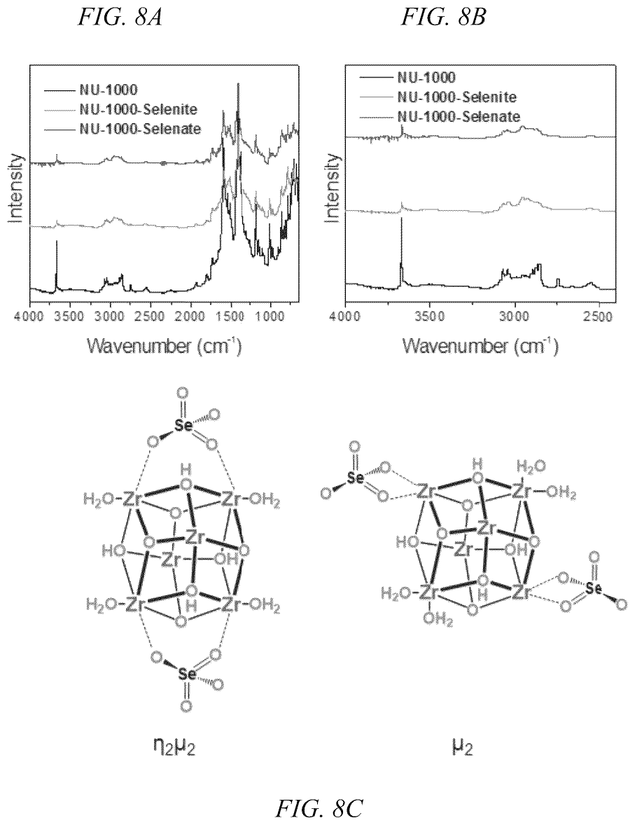

Diffuse reflectance infrared Fourier transform spectroscopy (DRIFTS) was used to gain insight into the location of the two analyte molecules per node of NU-1000. FIG. 8A illustrates DRIFTS spectrum of as-synthesized NU-1000 (lower trace) and after adsorption of two molecules of selenite (middle trace) and selenate (upper trace). FIG. 8B illustrates DRIFTS spectrum blown up from 4000-2000 cm⁻¹. FIG. 8C illustrates potential binding modes of selenate (or selenite) to the node of NU-1000. Prior to analyte adsorption, the IR spectrum of NU-1000 contains a sharp peak at 3670 cm⁻¹ (FIG. 8A/B, lowest trace) corresponding to stretching of the nodes' terminal —OH groups (FIG. 4a). The spectrum also contains a small peak at 2745 cm⁻¹ (FIG. 8A/B lower trace) corresponding to O—H stretches from hydrogen-bonding between the aqua and hydroxyl ligands in the Zr₆-node (FIG. 4A). After adsorption of ca. two molecules of selenate or selenite per node, the O—H stretch at 3670 cm⁻¹ is greatly diminished and the hydrogen-bonding based O—H stretch at 2745 cm⁻¹ disappears completely (FIG. 8A/B, middle and upper traces, respectively). Based on this information, it is reasonable to suggest that each SeO₄²⁻ or SeO₃²⁻ anion replaces two terminal hydroxyl groups on the Zr₆-node. Therefore, when two analyte molecules are bound per node, all four terminal hydroxyl groups are replaced and analyte binding can occur in a η₂μ₂ or μ₂ fashion (FIG. 8C).

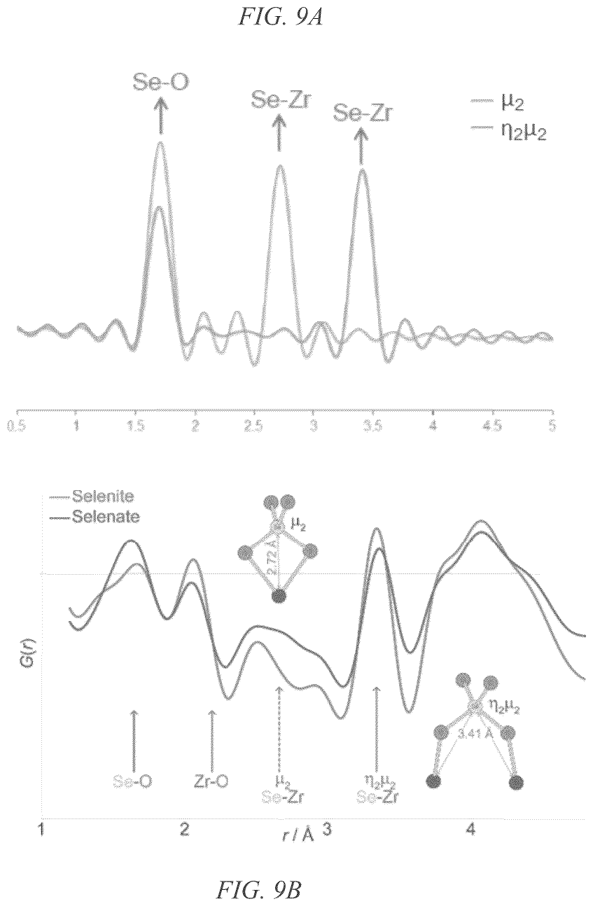

Pair distribution function (PDF) analyses of X-ray total scattering data were used to evaluate the structural changes accompanying binding of selenate and selenite anions. FIG. 9A illustrates calculated differential pair distribution functions (PDFs) for selenite and selenate-loaded NU-1000. FIG. 9B illustrates experimental differential PDFs for selenite and selenate-loaded NU-1000 only showing peaks at distances matching η₂μ2 binding. Simulated PDFs indicate Se—Zr distances of 3.41 Å and 2.72 Å, respectively, for η2μ2 and μ2 binding (FIG. 9A). The experimental PDF results, evaluated from difference data so as to isolate atom-atom distances unique to the adsorbent/adsorbate combination, showed a feature at ˜3.4 Å (3.36 Å for selenite, 3.37 Å for selenate), but not at 2.7 Å, clearly indicating that these anions exclusively bind in an η2μ2 mode (FIG. 9B, wherein the curve for selenite begins higher on the left side). Both differential PDFs show peaks at ˜1.7 Å assignable to the Se—O distance within the anion, and features at 2.0-2.3 Å consistent with a slight contraction of the average Zr—O distance.

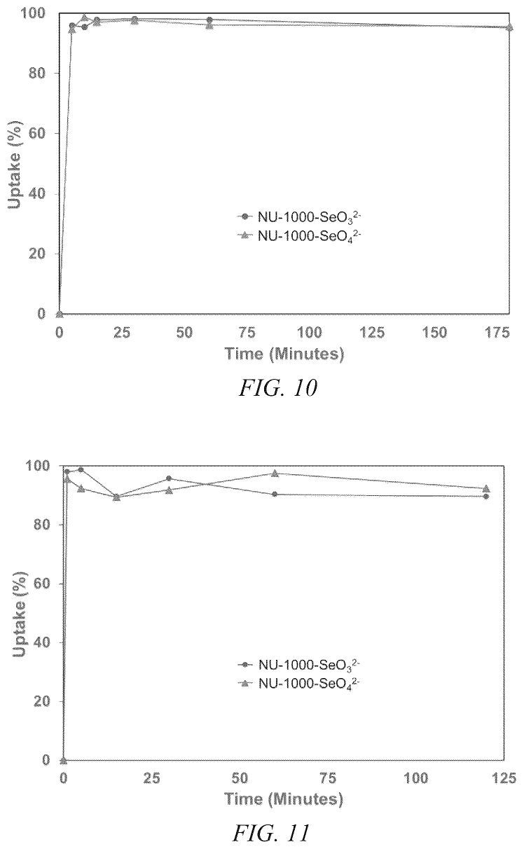

FIG. 10 illustrates selenate and selenite uptake vs. time in NU-1000 (2 mg) at low concentration and a starting concentration of 1000 ppb as Se. To test if current EPA standards for selenium in water can be satisfied by using NU-1000 as a sorbent, uptake of selenate and selenite at low concentrations was also studied. When exposed to 5 mL of an aqueous solution of selenium as sodium selenite or sodium selenate at 1000 ppb, 2 mg of NU-1000 adsorbed 98% of the selenite or selenate in solution in less than 5 minutes. After 3 hours, the amount adsorbed remained constant, meaning that the anions adsorbed after 5 minutes did not subsequently leach from the sorbent. With a remnant solution concentration of only ˜20 ppb selenium, test samples treated with NU-1000 meet the EPA standards for drinking water of <50 ppb selenium. It would be expected that those of skill in the art of engineering fluid cleanup equipment and the like would be able to optimize these results so as to contact the NU-1000 MOF with a continuous flow stream of aqueous solutions of selenate and selenite and to produce after suitable contact time an effluent water stream with concentration of these ions on the order of ten part per billion as selenium.

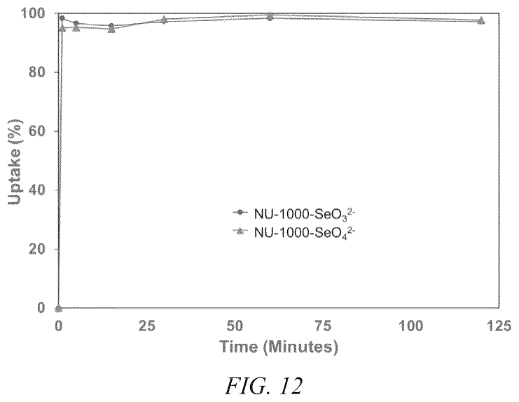

Adsorption of selenate and selenite by NU-1000 at low concentrations was also tested at 40° C. (FIG. 11) and pH 6 (FIG. 12) to simulate the conditions of recirculating cooling water from the flue gas desulfurization process in power plants where selenate and selenite remediation is a concern. FIG. 11 illustrates selenate and selenite uptake vs. time in NU-1000 (2 mg) at low concentration and 40° C. and a starting concentration of 1000 ppb as Se. FIG. 12 illustrates the selenate and selenite uptake vs. time in NU-1000 (2 mg) at low concentration and pH 6 and a starting concentration of 1000 ppb as Se. The successful tests showed that NU-1000 is a promising candidate for removal of selenite or selenate under power plant operating conditions.

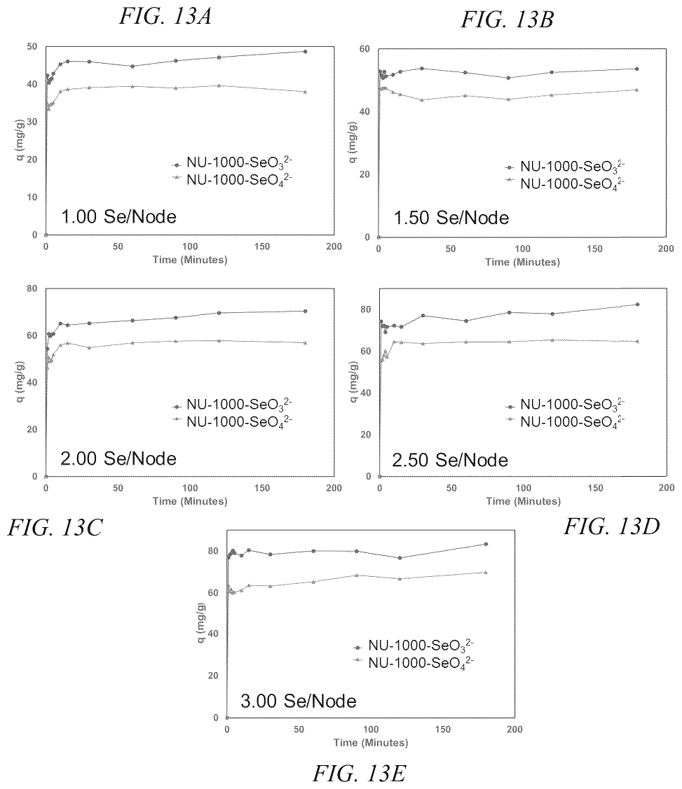

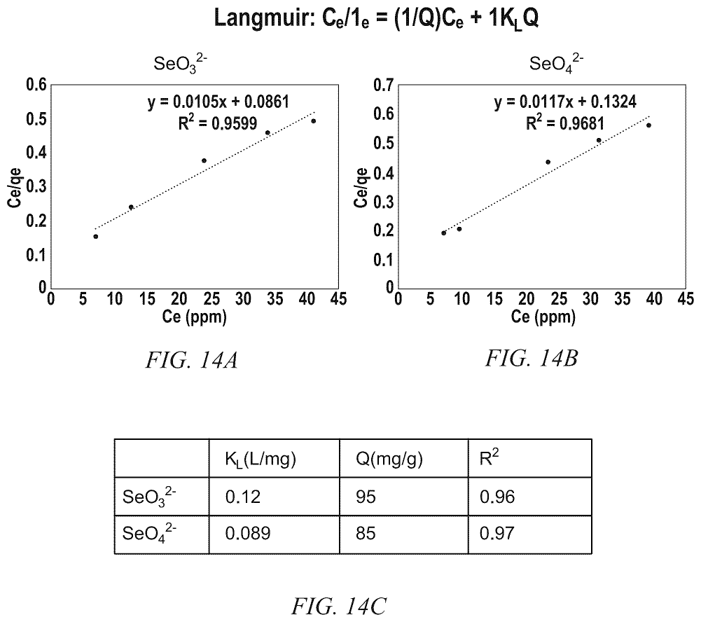

FIGS. 13A-E illustrate the amount adsorbed (q) vs. time at various concentrations of selenate and selenite per node of NU-1000, wherein the amount adsorbed is presented in weight of the full oxy-anion in milligrams normalized by the weight of the bare NU-1000 MOF in grams. FIGS. 14A-C illustrate a Langmuir plot (linear, type I) for selenite and selenate adsorption on NU-1000, with adsorbed amount as the weight of the full oxy-anions. The amount of selenite and selenate adsorbed per gram of NU-1000 was probed by exposing the MOF to various concentrations of selenite or selenate and monitoring the amount adsorbed (q) in mg of analyte/g of adsorbent over time (FIGS. 13A-E). Adsorption isotherm data was fit using the Langmuir model and high correlation coefficients were obtained (FIGS. 14A-C). Using the Langmuir equation, the maximum adsorption capacity (Q) of NU-1000 for selenite is 95 mg/g and for selenate is 85 mg/g. These data are roughly comparable to a millimole level of analyte per gram of uptake media. At amounts (i.e., concentrations and volumes) corresponding to 1.00 to 3.00 selenite or selenate anions per node, NU-1000 was found to reach its maximum adsorption within 1 minute of exposure (FIG. 13). The adsorption capacity of NU-1000 places it among the highest-capacity selenate and selenite adsorbing materials described to date; these analyte oxy-anions are much larger in size than the typical sulfate or chloride anion and are harder to achieve overall uptake capacity in many typical adsorption or ion exchange media available commercially. The uptake time of <1 minute in particular sets NU-1000 apart from other materials such as aluminum oxide and iron oxide derivatives as well as ion exchange and polymer resins, each of which require 30 or more minutes to reach maximum adsorption capacity under equivalent conditions. This feature, along with the low equilibrium final Se concentrations seen for NU-1000, is likely a manifestation of the significantly improved binding capability of the MOF for the larger oxy-anions when compared to other available adsorption media.

Adsorption capacity as a function of time at different concentrations (q) is given in FIG. 14 where q=(Cᵢ−C_{f})×V/m and Cᵢ=initial concentration of selenate or selenite, C_{f}=final concentration at a given time, V=volume of selenate or selenite solution used and m=mass of NU-1000. For the Langmuir plots shown, the type I linear equation (FIG. 14) was used where Cₑ=equilibrium concentration of selenate or selenite in solution, qₑ=equilibrium adsorption capacity, Q=maximum adsorption capacity of NU-1000 and K_{L}=Langmuir adsorption constant. qₑ and Cₑ are taken as the average values of q and C_{f}, respectively, from the analysis performed in FIG. 13 and described above.

TABLE 2
Values of Cₑ and qₑ used in FIG. 14 for selenate
and selenite adsorption on NU-1000.

| Selenite on NU-1000 | | | Selenate on NU-1000 | | |
|---|---|---|---|---|---|
| Ca. Per Node | Cₑ | qₑ | Ca. Per Node | Cₑ | qₑ |
| Exposure | (ppm) | (mg/g) | Exposure | (ppm) | (mg/g) |
| 1.00 | 7.0 | 45.9 | 1.00 | 7.0 | 37.1 |
| 1.50 | 12.5 | 52.3 | 1.50 | 9.4 | 46.2 |
| 2.00 | 23.9 | 63.8 | 2.00 | 23.3 | 53.8 |
| 2.50 | 33.9 | 73.9 | 2.50 | 31.3 | 61.6 |
| 3.00 | 41.0 | 83.4 | 3.00 | 39.1 | 69.9 |

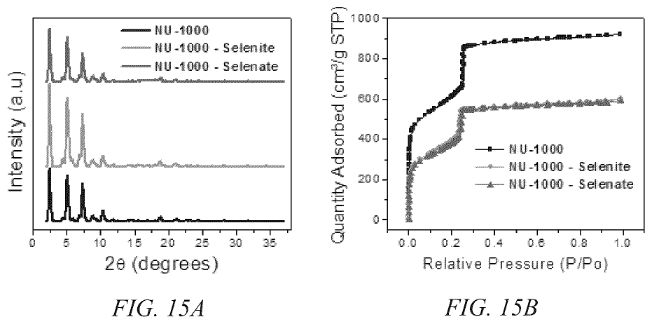

FIG. 15A illustrates a powder X-ray diffraction pattern of as-synthesized NU-1000 compared to NU-1000 after adsorption of selenite or selenate. FIG. 15B illustrates a nitrogen adsorption isotherm of as-synthesized NU-1000 compared to NU-1000 after adsorption of selenite or selenate. Characterization of NU-1000 before and after adsorption of selenate and selenite suggests that the framework remains intact. Powder X-ray diffraction (PXRD) patterns are unchanged before and after adsorption. The Brunauer-Emmett-Teller (BET) volumetric surface area of NU-1000 before adsorption is 1035±5 m²/cm³ (gravimetric surface area: 2130±5 m²/g) whereas after adsorption of selenate and selenite the volumetric surface area drops slightly to 682±10 m²/cm³ and 705±10 m²/cm³ respectively (gravimetric surface area: 1240±10 and 1300±10 m²/g) (FIG. 15B). Similarly modest decreases have been reported following Al^{III} installation on NU-1000's nodes via atomic layer deposition.

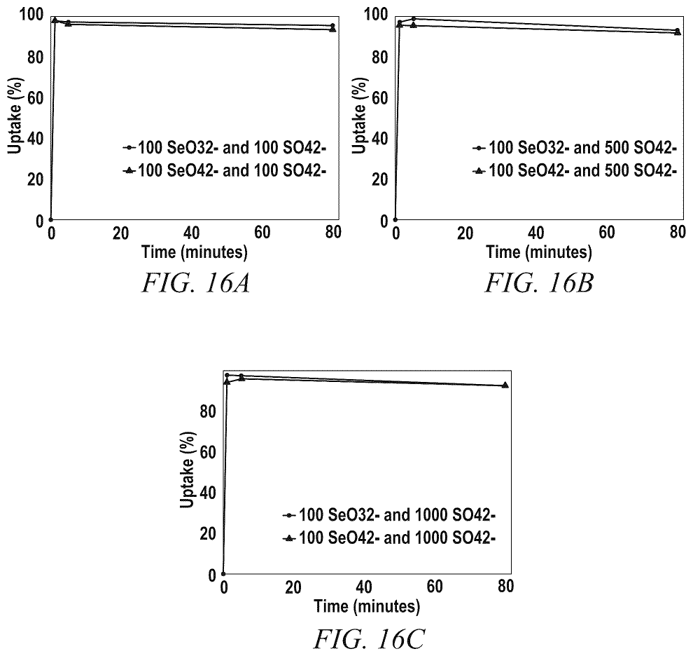

FIGS. 16A-C illustrate selenate and selenite uptake as a function of time using 2 mg of NU-1000 and 10 mL of aqueous solution containing 100 ppb Se and (a) 100 ppb sulfur S and (b) 500 ppb S and (c) 1000 ppb S as sulfate. Specifically, FIGS. 16A-C illustrate the performance of the NU-1000 MOF using nodal uptake of selenate and selenite in the presence of competing sulfate anions.

Batch adsorption studies were performed for selenate and selenite uptake both in the presence of sulfate originally upon exposure to the bare MOF and as a “knock-off study” wherein sulfate was exposed to the MOF already having adsorbed the selenium oxy-anions. The competitive adsorption case was studied by exposing 2 mg of NU-1000 to 10 mL aqueous solutions containing 100 ppb Se as either SeO₄²⁻ or SeO₃²⁻ as well as 100, 500, or 1000 ppb S as SO₄²⁻. In all cases, >95% of the Se in solution is adsorbed (FIGS. 16A-C) and the presence of SO₄²⁻ (up to ten time higher concentration in ppb) has no effect on the SeO₄²⁻ or SeO₃²⁻ uptake at these concentrations. (Of course, this result does not mean sulfate does not adsorb. Rather, the competition between selenium oxy-anions and the sulfur oxy-anions favors the former, and any adsorption sites remaining (many) for bridging binding opportunity within the nodal structure after majority of selenium oxy-anions are removed from the liquid phase can then accommodate the less competitive sulfate.) In addition, the remnant Se concentrations as SeO₃²⁻ or SeO₄²⁻ were found to be between 2-7 and 4-9 ppb Se, respectively.

The “knock-off” studies were performed by first exposing 2 mg of NU-1000 to 10 mL aqueous solutions containing 24 ppm Se as SeO₄²⁻ and SeO₃²⁻. This is equivalent to an exposure level of 3.3 Se/node, which was used to insure that NU-1000 was saturated with SeO₄²⁻ and SeO₃²⁻. NU-1000-2SeO₄²⁻ and NU-1000-2SeO₃²⁻ was then exposed to an aqueous solution containing 25 ppm SO₄²⁻ (equivalent to 3 S/node) and the leaching of SeO₄²⁻ and SeO₃²⁻ was probed as a function of time. There was minimal leaching (3%) of SeO₃²⁻ from NU-1000-2SeO₃²⁻ in the presence of SO₄²⁻ whereas leaching of SeO₄²⁻ from NU-1000-2SeO₄²⁻ was more significant (20%) in the presence of SO₄²⁻, but still low compared to many other types of adsorption media for which it is difficult even to obtain adsorption of both speciation of selenium oxy-anion without sulfate much less with a knock-off challenge.

The following describes the general methods used for the above analysis. UiO-66, UiO-66-NH₂, UiO-66-(NH₂)₂, UiO-66-(OH)₂ and UiO-67 were made according to procedures described in Katz, M. J.; Brown, Z. J.; Colón, Y. J.; Siu, P. W.; Scheidt, K. A.; Snurr, R. Q.; Hupp, J. T.; Farha, O. K. A facile synthesis of UiO-66, UiO-67 and their derivatives. Chem. Commun. 2013, 49, 9449-9451, which is incorporated herein by reference in its entirety. NU-1000 was made according to a procedure described in Planas, N.; Mondloch, J. E.; Tussupbayev, S.; Borycz, J.; Gagliardi, L.; Hupp, J. T.; Farha, O. K.; Cramer, C. J. Defining the Proton Topology of the Zr₆-Based Metal-Organic Framework NU-1000. J. Phys. Chem. Lett. 2014, 5, 3716-3723, which is incorporated herein by reference in its entirety). Powder X-ray diffraction measurements were obtained using a Bruker MX IμS microsource with Cu-Ku radiation and an Apex II CCD detector. Measurements were made over a range of 2°<2θ<37°. N₂ adsorption and desorption isotherm measurements were performed on a Micromeritics Tristar II at 77K. Samples were activated by heating at 120° C. for 12 hours under high vacuum on a Micromeritics Smart VacPrep. All gases used were Ultra High Purity Grade 5 as obtained from Airgas Specialty Gases. DRIFTS were recorded on a Nicolet 6700 FTIR spectrometer equipped with an MCT detector that was cooled to 77 K. The spectra were collected in a KBr mixture under Argon purge (samples prepared in air). Pure KBr was measured as the background and subtracted from sample spectra. ICP-OES data were collected on a Varian Vista MPX ICP Spectrometer. ICP-MS data were collected on a ThermoFisher X Series II instrument equipped with Collision Cell Technology (CCT) to reduce interferences from doublets for accurate detection of Se. ICP standards were purchased from Fluka Analytical. The as-purchased Na and Se ICP standards were 1000 mg/L in 2% nitric acid, TRACECERT and the Zr standard was 10 000 μg/mL in 4 wt % HCl. Standards for ICP-OES measurements (0.25-10 ppm) were prepared via serial dilution in 3% H₂SO₄ and standards for ICP-MS measurements (4-1000 ppb) were prepared via serial dilution in 3% HNO₃. Scattering data for PDF analysis were collected at beamline 11-ID-B at the Advanced Photon Source (APS) at Argonne National Laboratory (ANL). High energy X-rays (58.66 keV, λ=0.2114 Å) were used in combination with a Perkin Elmer amorphous silicon-based area detector. The samples were loaded into Kapton capillaries for PDF measurements under ambient conditions. PDF measurements were collected on NU-1000 samples containing selenate or selenite by taking 60 frames of 2 seconds exposure each. The 2-D scattering images were integrated to obtain 1-D scattering intensity data using software Fit2D. The structure function S(Q) was obtained within software PDFgetX3. Direct Fourier transform of the reduced structure function F(Q)=Q[S(Q)−1] led to the reduced pair distribution function, G(r), with Qₘₐₓ=23 Å⁻¹. Contributions from the pristine MOF were measured under exactly same conditions and subtracted to yield differential PDF (dPDF). The dPDF data show the new contributions coming from Se-atom correlations. Models for Se coordination modes (η₂μ₂ or μ₂) to the MOF Zr-cluster were constructed within CrystalMaker. PDFs for both models were simulated using PDFGui³² and compared with the experimental ones.

Initial selenite/selenate uptake studies were performed by exposing 10 mg of MOF to 5 mL of an aqueous, 100 ppm solution of selenium as sodium selenite or sodium selenate in a 15 mL polypropylene centrifuge tube. 100 ppm control solutions of sodium selenite and sodium selenate were also prepared. The solutions were centrifuged for 1 minute to allow the MOF to settle to the bottom of the tube. After 72 hours, 0.5 mL of the supernatant was removed and diluted to 10 mL in 3% H₂SO₄ for ICP-OES measurements. ICP-OES was used to determine the concentration of Se, Zr, and Na in each solution. Comparison of control solutions to those containing MOF was used to determine the amount of selenate or selenite adsorbed by the MOF.

Kinetic studies were performed by exposing 10 mg of UiO-66-(NH₂)₂, UiO-66-NH₂ and NU-1000 to 5 mL of an aqueous, 100 ppm solution of selenium as sodium selenite or sodium selenate in a 15 mL polypropylene centrifuge tube. The solutions were centrifuged for 1 minute to allow the MOF to settle to the bottom of the tube. 0.5 mL aliquots of the supernatant were removed at 3, 27, and 72 hours and diluted to 10 mL in 3% H₂SO₄ for analysis by ICP-OES. ICP-OES was used to determine the concentration of Se, Zr, and Na in each solution. Comparison of control solutions to those containing MOF was used to determine the amount of selenate or selenite adsorbed by the MOF at each time.

The maximum uptake per node of NU-1000 was determined by exposing 2 mg of NU-1000 to 5 ml of an aqueous solution of sodium selenite or sodium selenate in a 15 ml polypropylene centrifuge tube with selenium concentrations of 30, 45, 60, 75, 90, and 105 ppm. These concentrations correspond to an exposure level of 2-7 analyte molecules per MOF node (i.e., Zr₆ cluster). The solutions were centrifuged for 1 minute to allow the MOF to settle to the bottom of the tube. Aliquots of the supernatant were removed and diluted to 10 mL in 3% H₂SO₄ for analysis by ICP-OES. ICP-OES was used to determine the concentration of Se, Zr, and Na in each solution. Comparison of control solutions to those containing MOF was used to determine the number of selenate or selenite anions adsorbed per node of NU-1000.

Low concentration kinetic studies were performed by exposing six 2 mg samples of NU-1000 to 5 mL of an aqueous, 1 ppm solution of selenium as sodium selenite or sodium selenate in a 15 mL polypropylene centrifuge tube. The solutions were centrifuged for 1 minute to allow the MOF to settle to the bottom of the tube. 2895 μL aliquots of the supernatant were removed from each solution at different times (5, 10, 15, 30, 60, and 180 minutes) and diluted to 3 mL in 3% HNO₃ for analysis by ICP-MS. ICP-MS was used to determine the concentration of Se, Zr, and Na in each solution. Comparison of control solutions to those containing MOF was used to determine the amount of selenate or selenite adsorbed by the MOF at each time. Studies at 40° C. and pH 6 were performed in the same fashion. To perform tests at 40° C., the selenate and selenite solutions were heated in a beaker full of Lab ARMOR BEADS and to perform tests at pH 6 the selenate and selenite solutions were made in pH 6 HCl.

The amount of selenate or selenite adsorbed per gram of NU-1000 was determined by exposing 5 mg of NU-1000 to 10 mL of an aqueous solution of selenium as sodium selenite or sodium selenate in a 15 mL polypropylene centrifuge tube with concentrations of ca. 18, 27, 36, 45, and 55 ppm. These concentrations correspond to an exposure level of 1.00, 1.50, 2.00, 2.50 and 3.00 analyte molecules per Zr₆-node of NU-1000. The solutions were centrifuged for 30 seconds to allow the MOF to settle to the bottom of the tube. Aliquots of the supernatant were removed and diluted to 10 mL in 3% H₂SO₄ at 1, 2, 3, 4, 5, 10, 15, 30, 60, 90, 120, and 180 minutes for analysis by ICP-OES. ICP-OES was used to determine the concentration of Se, Zr, and Na in each solution. Comparison of control solutions to those containing MOF was used to determine the amount of selenate or selenite adsorbed (q) in mg/g of NU-1000 where q=(Ci−Cf)×V/m, Ci=initial concentration, Cf=final concentration, V=volume of solution exposed to NU-1000 and m=mass of NU-1000 in g.

As noted above, Zr-based MOFs, including, for example, NU-1000, may remove other oxy-anions, such as oxy-anions of aluminum (that is, water soluble aluminum oxides/hydroxides), silicon (that is, silicates and hydrosilicates), phosphorus (such as phosphates and hydrophosphates), sulfur (that is, sulfates), chlorine (such as chlorates and perchlorates), geranium (that is, water soluble oxides/hydroxides of geranium), arsenic (such as, arsenates), tin (that is, stannates), antimony (such as antimonates and antimonites), iodine (such as iodates, per-iodates and iodites), lead (that is, water soluble oxides/hydroxides of lead) and nitrogen (as nitrates (NO₃⁻) and nitrites (NO₂⁻)).

In some embodiments, the Zr-based MOF, including NU-1000, is used to adsorb oxy-anions of antimony, including oxy-anions in either the Sb[III] (antimonite) or the Sb[V] (antimonate) redox state. Antimony is used in pressurized water reactors as a neutron source (paired with beryllium), and thus, antimony is a constituent in the wastewater generated from nuclear power plants. Antimony is also released from the fuel oxide layer into primary coolant water during the shutdown of nuclear power plants resulting in major radiation doses to personnel and the surrounding environment. Common forms of antimony that are present in aqueous solutions under oxidizing conditions include Sb(OH)₆⁻, HSbO₂, Sb(OH)₃, and Sb(OH)⁴⁺. Therefore, the Zr-based MOF, including NU-1000, can be used to remove oxy-anions of antimony, including those listed above, from these sources.

NU-1000 was exposed to concentrations of Sb(OH)₆⁻ corresponding to 2-7 Sb/node. Aliquots were taken from the supernatant at 24 hours and 48 hours. Table 3 shows the amount of Sb(OH)₆⁻ adsorbed by NU-1000 per node. Antimony adsorption in NU-1000 per node after 24 hours and 48 hours using Sb(OH)₆⁻ as an antimony source.

TABLE 3
Antimony adsorption in NU-1000 per node after 24 hours
and 48 hours using Sb(OH)₆⁻ as an antimony source.

| Per node | Per node uptake | Per node uptake |
|---|---|---|
| Sb Exposure | 24 hours | 48 hours |
| 2 | 1.36 | 1.45 |
| 3 | 1.76 | 1.99 |
| 4 | 1.88 | 2.06 |
| 5 | 1.87 | 2.07 |
| 6 | 2.21 | 2.33 |
| 7 | 1.94 | 2.00 |

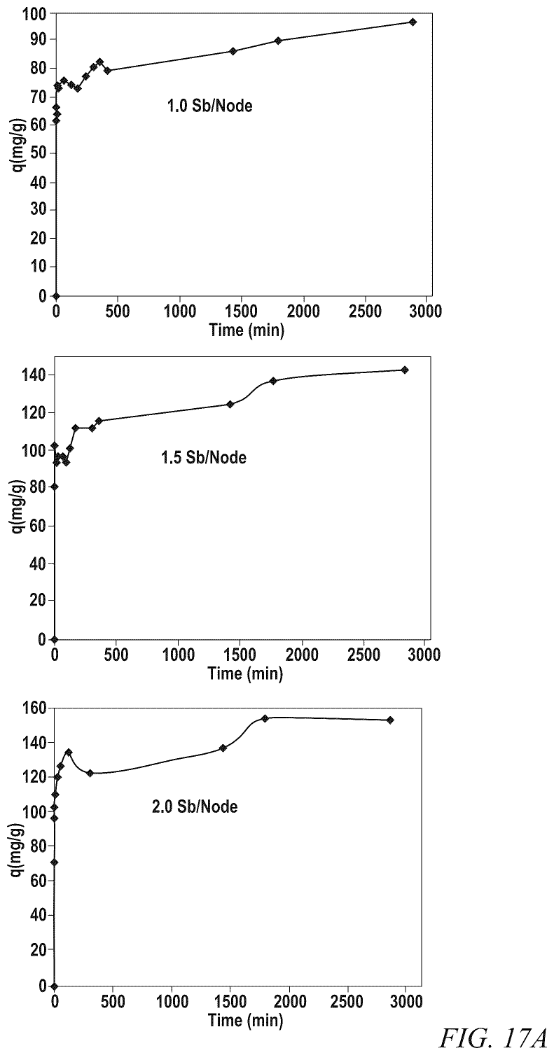

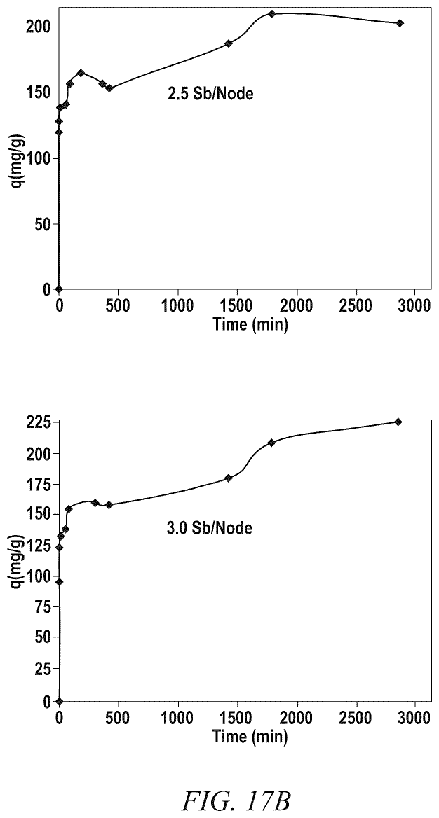

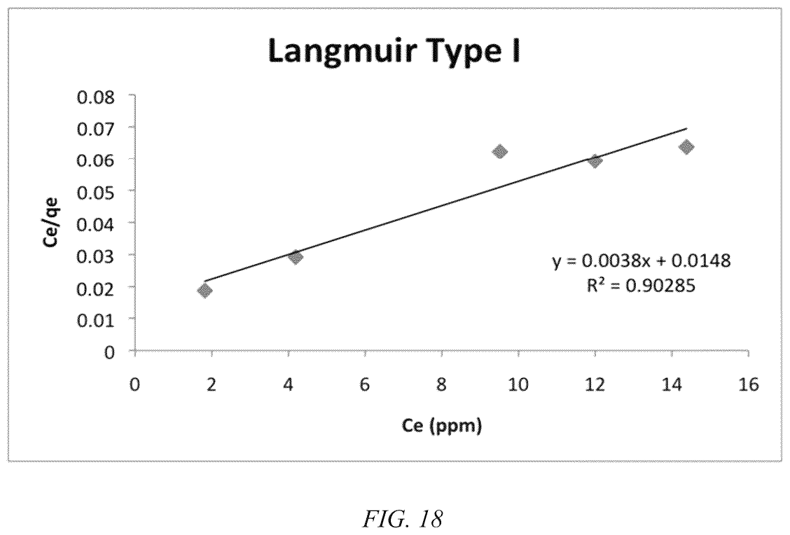

FIGS. 17A-B illustrate the uptake of Sb(OH)₆⁻ over time in terms of uptake per node. Tests were performed to determine Sb(OH)₆⁻ uptake over time at Sb(OH)₆⁻ concentrations corresponding to 1.00, 1.50, 2.00, 2.50 and 3.00 Sb/Zr₆ node. Aliquots from each solution were taken at 1, 5, 10, 15, 30, 60, 90, 120, 180, 240, 300, 360, 420, 1440, 1800, and 2880 minutes. These show that the adsorption kinetics for Sb(OH)₆⁻ in NU-1000 are fast with more than 60% of the total capacity reached in less than 1 minute. FIG. 18 illustrates a Langmuir fitting from the Sb adsorption isotherms of FIGS. 17A-B. FIG. 18 illustrates a maximum adsorption capacity for Sb(OH)₆⁻ in NU-1000 of 260 mg/g (or 142 mg/g Sb only).

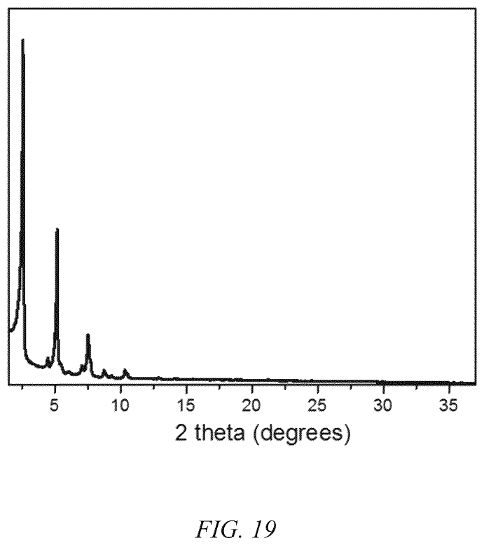

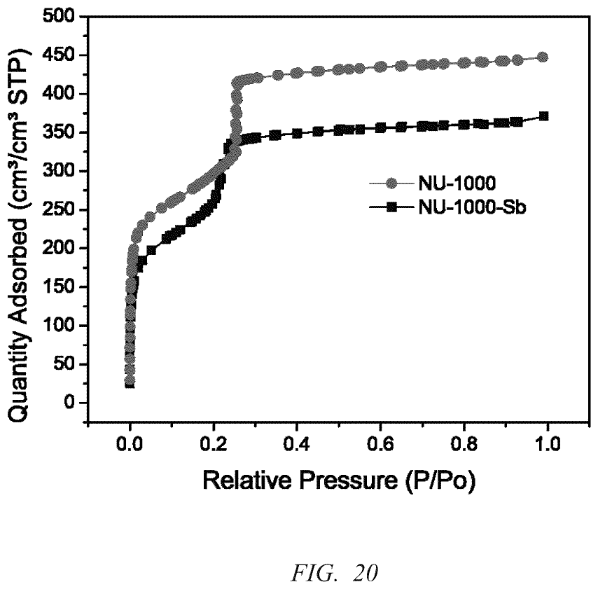

FIG. 19 illustrates the powder x-ray diffraction pattern for NU-1000 and NU-1000 with Sb(OH)₆⁻. This shows the stability of NU-1000 after adsorption of Sb(OH)₆⁻. PXRD, nitrogen adsorption-desorption isotherms, and ICP-OES measurements were taken to determine bulk crystallinity, porosity, and Zr leaching, respectively. The PXRD patterns show that the bulk crystallinity of NU-1000 remains intact after adsorption. FIG. 20 illustrates the nitrogen isotherm for NU-1000 and NU-1000 with Sb(OH)₆⁻. This shows that the surface area of the material decreases to approximately what would be expected given that mass is being added to the framework. Lastly, no Zr leaching from the framework is observed by ICP-OES.

Similar to the adsorption of oxy-anions of selenium, adsorption of oxy-anions of lead would be expected using a Zr-based MOF, including NU-1000. Lead in caustic solution in which its oxy-anion forms as previously identified above is believed to be involved in intergranular attack/stress corrosion cracking of steam generator tubes in nuclear power plants. Therefore, removal of these oxy-anions, including oxy-anions in either the Pb[II] or the Pb[IV] redox state, such as Pb(OH)₆²⁻, Pb(OH)₆⁴⁻, PbO₃²⁻, and PbO₂²⁻, from the related liquid streams would be beneficial.

It should be appreciated that in some embodiments, the MOFs of the present invention provide for the adsorption of the oxy-anions even in the present of other species that may compete for adsorption sites on the MOF. In particular, in some liquid streams, such as those in flue gas desulfurization systems, oxy-anions of boron and sulfur in the liquid phase may compete for adsorption sites on the MOF. However, even in the presence of these species, it has been found that the MOFs of the present invention still provided for the adsorption of oxy-anions. One of skill in the art will appreciate that the concentration of the various species, including the oxy-anion to be adsorbed and any competing species, should be taken into account in determining the concentration of the MOF to be used in the liquid stream of interest.

Tables 4, 5, and 6 show test results for the use of NU-1000 in a flue gas desulfurization liquid stream sample, both before and after the addition of the NU-1000. (With respect to Table 4, it should be recognized that Stage 1 flue gas desulfurization (FGD) wastewater can contain many more particulate form selenates/selenites than soluble oxy-anions, which may account for the relatively small adsorption amounts after exposure to the MOF.)

TABLE 4
FGD wastewater (10 mL) before and after
treatment with NU-1000 (10 mg).

| | Boron | Selenium | Sulfur |
|---|---|---|---|
| Sample Name | (ppm) | (ppm) | (ppm) |
| Stage 1-FGD (before) | 75.2 | 0.252 | 386.8 |
| With NU-1000 (after) | 75.1 | 0.209 | 386.6 |

TABLE 5
FGD wastewater (10 mL) before and after
treatment with NU-1000 (10 mg).

| Sample name | Selenium | Sulfur | Boron | Sodium |
|---|---|---|---|---|
| Stage 3-FGD (before) | 19.6 ppb | 865.3 ppm | 19.5 ppm | 147.0 ppm |
| With NU-1000 (after) | 2.3 ppb | 788.0 ppm | 18.4 ppm | 146.8 ppm |

TABLE 6
Uptake of Se from FGD wastewater
with various amounts of NU-1000.

| Sample Name | 2 min | | 10 min | | 20 min | | 1 hr | |
|---|---|---|---|---|---|---|---|---|
| Stage 3-FGD | 21.78 | ppb | 21.78 | ppb | 21.78 | ppb | 21.78 | ppb |
| (before) | | | | | | | | |
| After 10 mg | 14.68 | ppb | 10.52 | ppb | 10.33 | ppb | 10.20 | ppb |
| NU-1000 | | | | | | | | |
| After 25 mg | 10.35 | ppb | 6.33 | ppb | 6.25 | ppb | 6.10 | ppb |
| NU-1000 | | | | | | | | |
| After 50 mg | 5.59 | ppb | 4.51 | ppb | 4.29 | ppb | 3.97 | ppb |
| NU-1000 | | | | | | | | |

With respect to Tables 4 and 5, 10 mg of NU-1000 was added to 10 mL of wastewater, which is equivalent to exposure levels of 15B/Zr₆ node, 26S/Zr₆ node and only 0.007Se/Zr₆ node, which are very challenging competitive conditions. Table 4 shows the levels of B, Se and S in the wastewater after treatment with NU-1000, and only 100 ppb B, 43 ppb Se, and 160 ppb of S were taken up by the MOF. Given that exposure levels of B and S are 2100× and 3700× that of Se, the NU-1000 is still able to adsorb Se. Accordingly, in some embodiments, adsorption of selenium oxy-anions still occurs in the presence of ions present at a range of 100-10,000× the selenium oxy-anion concentration.

With respect to Table 6, different amounts of NU-1000 (50 mg, 25 mg, 10 mg, 5 mg) were tested for the removal of SeOₓ²⁻ from stage 3 FGD water and data points were taken at shorter times (5 min, 10 min, 30 min). This shows the minimum amount of MOF and the shortest time possible to obtain the desired results. As apparent from Table 6, as the amount of MOF increases and the time of exposure increases, the effluent concentration of the oxyanion remaining in the plant water sample decreases. MOF exposure time and MOF loading improvements appear to be equivalent in their ability to improve oxyanion uptake.

The Zr-based MOFs of the present invention may range in crystalline size and still provide for the adsorption of the oxy-anions noted above. In some embodiments, the crystalline size of NU-1000 may range from approximately 75-5000 nm. In some embodiments, the crystalline size of NU-1000 may range from approximately 75-1200 nm or from approximately 300-5000 nm. In some embodiments, the NU-1000 may range from 75-1200 nm. In some embodiments, the MOFs of the present invention may have relatively large apertures, for example, up to approximately 30 Å or larger, which promotes diffusion of the analytes and improves the uptake kinetics. It should be appreciated that a larger aperture MOF will allow diffusive access of the oxy-anion to the available nodes for uptake more readily than smaller geometries.

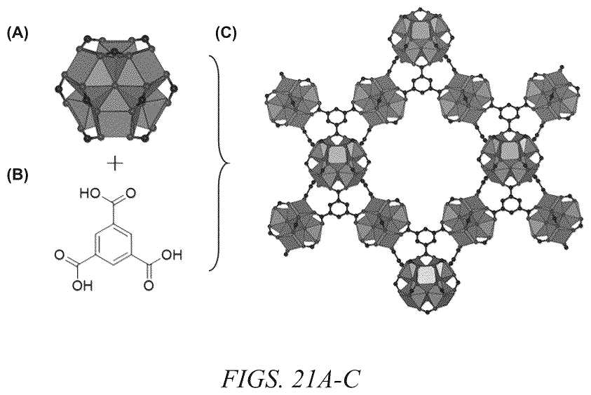

FIGS. 21A-C illustrate a zirconium-based MOF, namely MOF-808, according to one embodiment of the present invention. FIG. 21A illustrates the Zr₆-clusters; FIG. 21B illustrates 1,3,5-benzenetricarboxylate linker; FIG. 21C illustrates the 6-connected MOF-808. MOF-808 is well suited towards wastewater remediation due to its high thermal and chemical stability (stable in solutions with pH ranging from 1-10). Of the possible 12 metal node binding sites, only 6 are occupied by structural organic linkers in the spn topology of MOF-808, leaving 6 available to interact with adsorbate molecules, leading to the potential for high uptake capacity of guest molecules.

MOF-808, which may be used in the present invention, has a molecular formula of Zr₆O₄(OH)₄(BTC)₂(HCOO)₆, where BTC is 1,3,5-benzenetricarboxylate, before activation, and a molecular formula of Zr₆(μ₃—O)₄(μ₃—OH)₄(BTC)₂(OH)₆(H₂O)₆, where BTC=1,3,5-benzenetricarboxylate, after acid washing and activation. Activation usually involves heating and vacuum drying in order to remove solvents employed during synthesis from the resultant MOF surface structures.

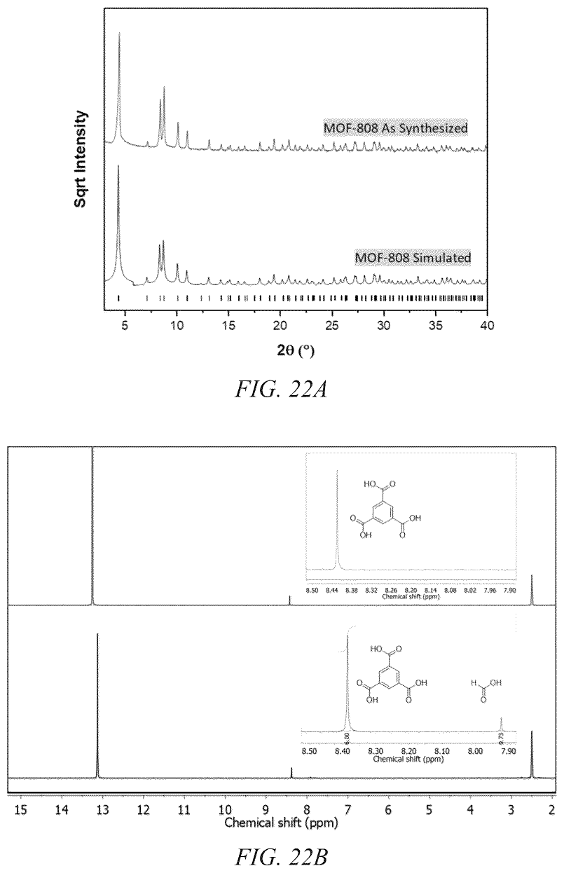

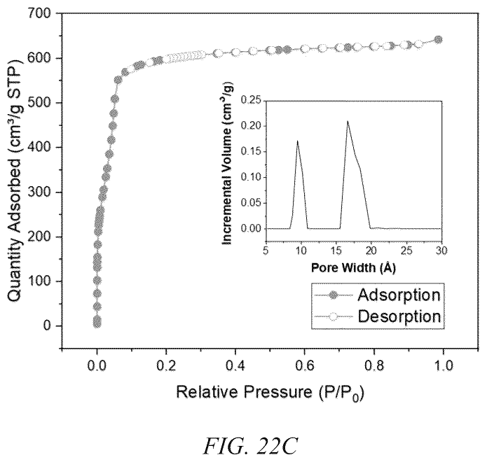

FIGS. 22A-D illustrates analytical results regarding the synthesis of MOF-808 accordingly to one embodiment of the invention. MOF-808 can be synthesized and activated as follows: MOF-808 can be synthesized under solvothermal conditions using ZrOCl₂·8H₂O and 1,3,5-benzenetricarboxylic acid in dimethylformamide (DMF) with formic acid modulator at 120° C. In one embodiment, MOF-808 was synthesized using a by combining 97 mg of ZrOCl₂·8H₂O with 63 mg of H₃BTC in 7.5 mL each of DMF and formic acid. The resulting mixture was sonicated until the components were dissolved and placed in an oven at 120° C. to react for 72 hours. The MOF was washed three times with fresh DMF (3×10 mL) and soaked in fresh DMF (10 mL) overnight, followed by three acetone washes (3×10 mL) and an overnight acetone (10 mL) soak. The powder was subsequently dried in a vacuum oven at 80° C. before soaking in 10 mL of 0.1 M HCl overnight to remove the formate capping ligands from the MOF nodes. The MOF was centrifuged and the HCl solution was removed followed by three water washes (3×10 mL), and three acetone washes (3×10 mL). (The acetone washes were performed to avoid framework stability issues related to capillary forces exerted by repeated adsorption and desorption tests.) The MOF was soaked in acetone (10 mL) overnight before drying in a vacuum oven at 80° C. for one hour, and then activated on a Micromeritics SmartVacPrep at 120° C. for 20 hours. 45.4 mg of sample was activated and used to collect the isotherm appearing in FIG. 2C.

To ensure that the 6 nodal sites are accessible for oxyanion adsorption, the as-synthesized MOF is soaked in 0.1 M HCl to remove the formate capping ligands leftover from synthesis. Powder X-ray diffraction (PXRD) confirms that the MOF is phase pure and crystalline after the removal of formate capping ligands (FIG. 22A showing powder X-ray diffraction patterns for the as-synthesized MOF-808 compared to a simulated pattern), and ¹H NMR spectroscopy shows the disappearance of the formate proton at 7.92 ppm (FIG. 22B). N₂ gas adsorption analysis performed on MOF-808 shows the expected Type 1b isotherm, with a Brunauer-Emmett-Teller (BET) area of 2020 m²/g and pore diameters of 10 and 18 Å (FIG. 22C showing the nitrogen adsorption-desorption isotherm for as-synthesized MOF-808 at 77 K with the MOF-808 pore size distribution (inset)), consistent with previous reports. Scanning electron microscopy images show the expected morphology, with crystallite sizes of approximately 5 μm (FIG. 22D showing SEM images of as-synthesized MOF-808 crystallites).

In one embodiment iodate was adsorbed using MOF-808. 2.5 mg of MOF-808 was exposed to solutions of potassium iodate with concentrations equivalent to exposures of 2-7 iodate anions per metal node of MOF (41-287 ppm). The MOF was submerged in the solution for 72 hours, resulting in iodate uptake between 0.95 per node and 1.93 per node for exposures of 2 and 7 iodate equivalents, respectively, as shown in Table 7 below. This translates to between 134 and 286 mg of iodate per gram of MOF-808, indicating that the MOF has a high gravimetric capacity for iodate adsorption.

TABLE 7
Iodate Uptake by MOF-808

| Exposure per node | 72 h Uptake (mg/g) | Uptake per node |
|---|---|---|
| 2 | 134 | 0.95 |
| 3 | 178 | 1.27 |
| 4 | 187 | 1.32 |
| 5 | 225 | 1.56 |
| 6 | 234 | 1.63 |
| 7 | 286 | 1.93 |

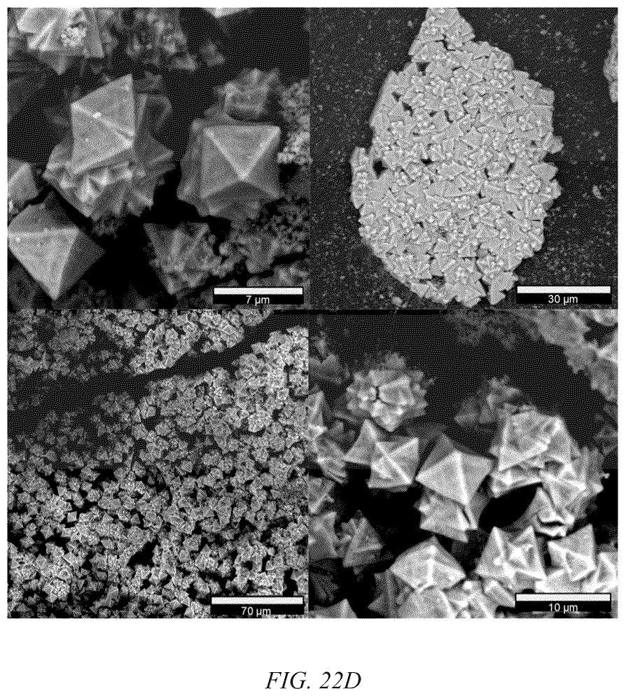

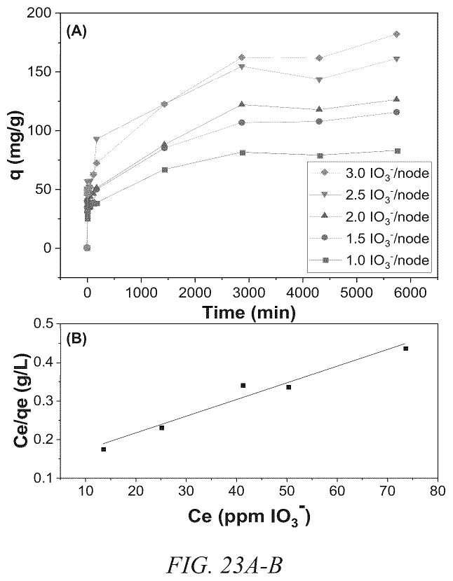

FIG. 23A illustrates the kinetics for iodate adsorption using MOF-808 according to one embodiment of the invention. The kinetics of the adsorption process were determined by exposing 2.5 mg of MOF-808 to 10 mL solutions of 1, 1.5, 2, 2.5, and 3 iodate anions per node (41, 61.5, 82, 102.5, and 123 ppm, respectively). The amount (q) of iodate adsorbed in mg/g of MOF was determined using Equation 1:

$$q = ( {C}_{i} - {C}_{f} ) \times V / m \qquad Eq . 1$$

where Cᵢ is the initial concentration (ppm), C_{f} is the final concentration (ppm), V is the volume of the iodate solution (L), and m is the mass of MOF-808 (g). In all cases, steep uptake is observed within the first few minutes of exposure of MOF-808 to the iodate solution, with uptake continuing to increase until reaching a plateau between 48-72 hours.

FIG. 23B illustrates a Langmuir plot of the adsorption of iodate in MOF-808 according to one embodiment of the present invention. The maximum adsorption capacity, Q, was calculated by fitting the data to the Langmuir adsorption model using Equation 2:

$${C}_{e} / {q}_{e} = ( 1 / Q ) {C}_{e} + 1 / {K}_{L} Q \qquad Eq . 2$$

where Q is the equilibrium adsorption capacity (mg/g), Cₑ is the equilibrium concentration (ppm), qₑ is the equilibrium uptake (mg/g), and K_{L} is the Langmuir adsorption constant. Q was determined to be 233 mg/g. This is the highest reported gravimetric iodate uptake to date (for example, for either MOFs or ion exchange polymeric resins), with other materials showing maximum adsorption capacities ranging from 0.01-170 mg/g as shown in Table 8:

TABLE 8
Various Maximum Adsorption Capacities Compared to MOF-808

| Material | Uptake (mg/g) | Time | | Concentration | |
|---|---|---|---|---|---|
| Pomelo Peels | 6.91 | 5 | days | 100 | ppm |
| δ-Bi₂O₃@PES | 170.6 | 5 | hours | 10-500 | ppm |
| Hydrothermal | 16.87 | 5 | days | 5-90 | ppm |
| Biochar | | | | | |
| Diatomite/ | 370 mL/g | | | | |
| nanotitanium | (Freundlich model) | | | | |
| dioxide | | | | | |
| Tubular Hallyosite | 3.4 | 36 | hours | 17.5 | ppm |
| Organoclays | 21.1-27.5 | 6 | days | 8.75-875 | ppm |
| Activated Carbon | 40.25 | 24 | hours | 17.5-175 | ppm |
| F400 | | | | | |
| Chinese Soils | 0.01-0.03 | 40 | hours | 1.3-11 | ppm |

Based on the foregoing, MOF-808 adsorbs iodate, which is an oxy-anion of iodine that is a particularly difficult to adsorb on typical anion exchange polymeric resins. Accordingly, MOF-808 may also adsorb other anionic forms (e.g., I⁻) by modifying the MOF nodal or linker chemistries to incorporate typical anion exchange ligands (e.g., pendant ammonium cation molecules, which could serve an anion exchange function in aqueous solution. Hence, the MOF Zr-nodal clusters can physi-sorb iodate oxy-anion while the cavity inner surface of the very same MOF, for example, incorporating ammonium chemistry features could hold-up anionic iodide electrochemically.

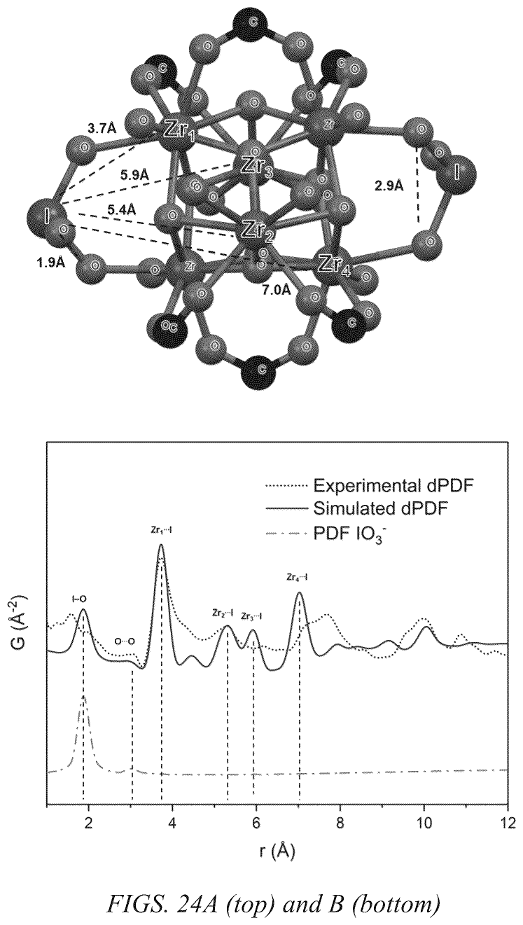

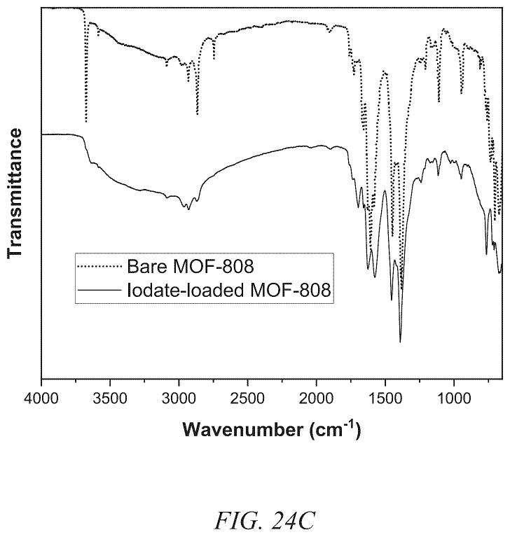

FIG. 24A illustrates a density functional theory (DFT) optimized model of the MOF-808 node with bridging iodate ions according to one embodiment of the invention. FIG. 24B illustrates a simulated differential pair distribution function (dPDF) of the DFT model of FIG. 24A, experimental dPDF data of iodate-loaded MOF-808, and a simulated dPDF of unbound iodate according to one embodiment of the invention. FIG. 24C illustrates diffuse reflectance infrared Fourier transform spectroscopy data of bare and iodate-loaded MOF-808. Specifically, FIG. 24A shows a DFT optimized model of the MOF-808 node with bridging iodate ions, with hydrogen atoms omitted for clarity. FIG. 24B shows the model-simulated dPDF of the DFT model of FIG. 24A (as shown in the upper distinct line trace), which is for two iodate anions with 1212 binding. FIG. 24B also shows the dPDF for iodate-loaded MOF-808 (from synchrotron X-ray total scattering measurements) (varying width trace shown under the upper distinct line trace for the DFT model) and the dPDF for bare iodate (lower distinct line trace).

As shown, a substantial decrease in the O—H stretch at 3674 cm¹ after iodate loading confirms that —OH ligands are replaced by iodate (FIG. 4C). Distances obtained via dPDF analysis are consistent with those determined by density functional theory (DFT) calculations for the optimized geometry of the Zr₆ cluster of MOF-808 with a bridging iodate. Atom-pair distances of 1.9 and 3.7 Å are observed after loading with iodate, corresponding to I—O and Zr—I, respectively. The signal is consistent with a binding mode where the iodate bridges two adjacent zirconium metal centers in the cluster or a 1212 binding mode. Peaks at larger distances are consistent with distances expected between iodine and successively further zirconium metal centers within the cluster. The DFT calculations suggest that hydrogen bonding with bound water has a directive effect on the iodate orientation—thus parts of the dPDF not clearly indexed by the model may plausibly occur due to distributed orientations, e.g. by interaction with further water layers.

FIG. 25A illustrates a DFT optimized model of the MOF-808 node with bridging iodate ions according to another embodiment of the invention. FIG. 25B illustrates a dPDF of the DFT model of FIG. 25A, experimental dPDF data of iodate-loaded MOF-808, and a simulated dPDF of unbound iodate according to one embodiment of the present invention. Specifically, FIG. 25A shows an optimized structural model of two bridging iodate anion binding to opposite sides of a MOF-808 Zr₆ node. FIG. 25B shows the model-simulated dPDF of the DFT model of FIG. 5A (as shown in the upper distinct line trace). FIG. 25B also shows the dPDF for iodate-loaded MOF-808 (varying width trace shown under the upper distinct line trace for the DFT model) and the dPDF for bare iodate (lower distinct line trace).

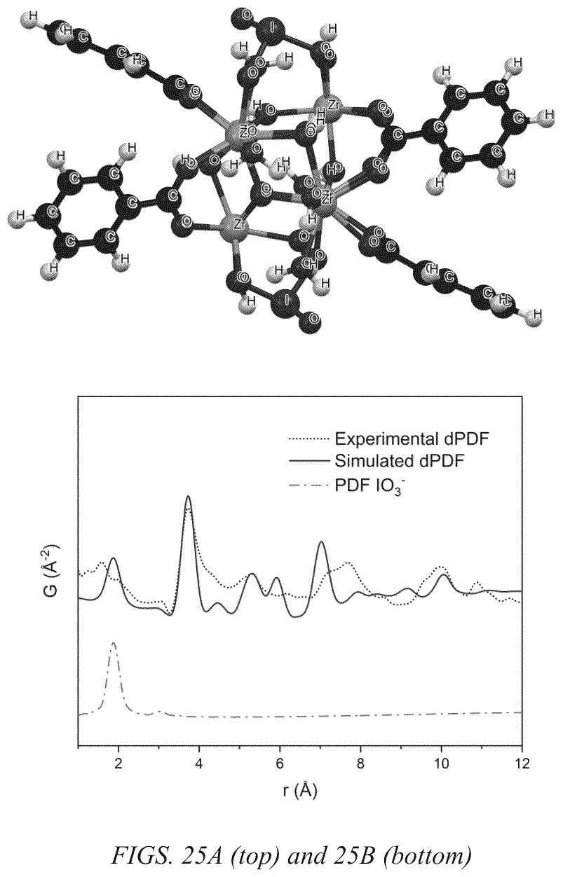

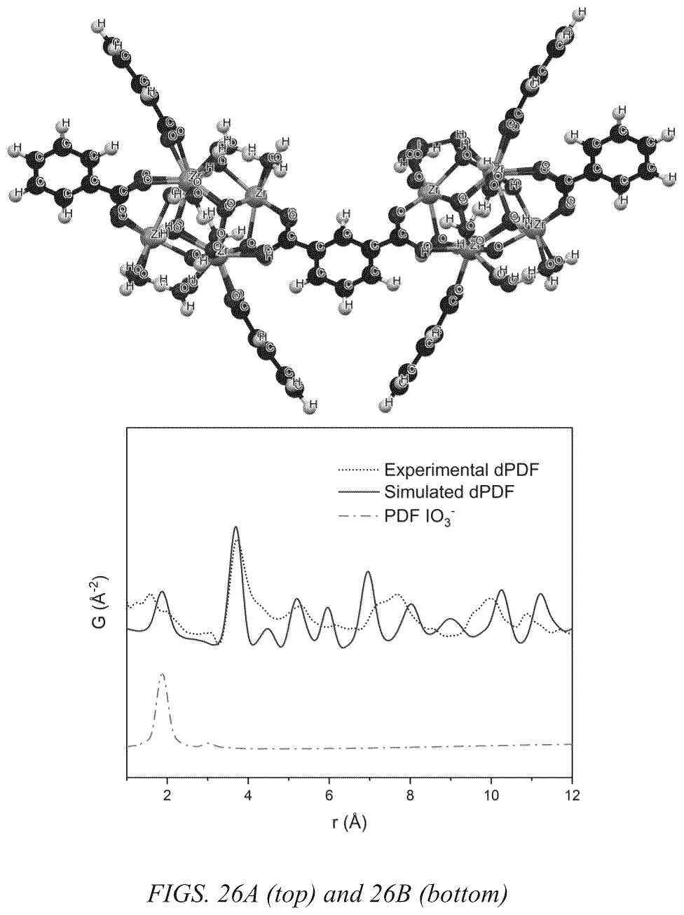

FIG. 26A illustrates a DFT optimized model of the MOF-808 node with bridging iodate ions according to another embodiment of the invention. FIG. 26B illustrates a simulated dPDF of the DFT model of FIG. 26A, experimental dPDF data of iodate-loaded MOF-808, and a simulated dPDF of unbound iodate according to one embodiment of the present invention. Specifically, FIG. 26A shows an optimized structural model of a bridging iodate anion binding to one Zr₆ node of a 2-node MOF-808 system. FIG. 26B shows the model-simulated dPDF of the DFT model of FIG. 26A (as shown in the upper distinct line trace). FIG. 26B also shows the dPDF for iodate-loaded MOF-808 (varying width trace shown under the upper distinct line trace for the DFT model) and the dPDF for bare iodate (lower distinct line trace).

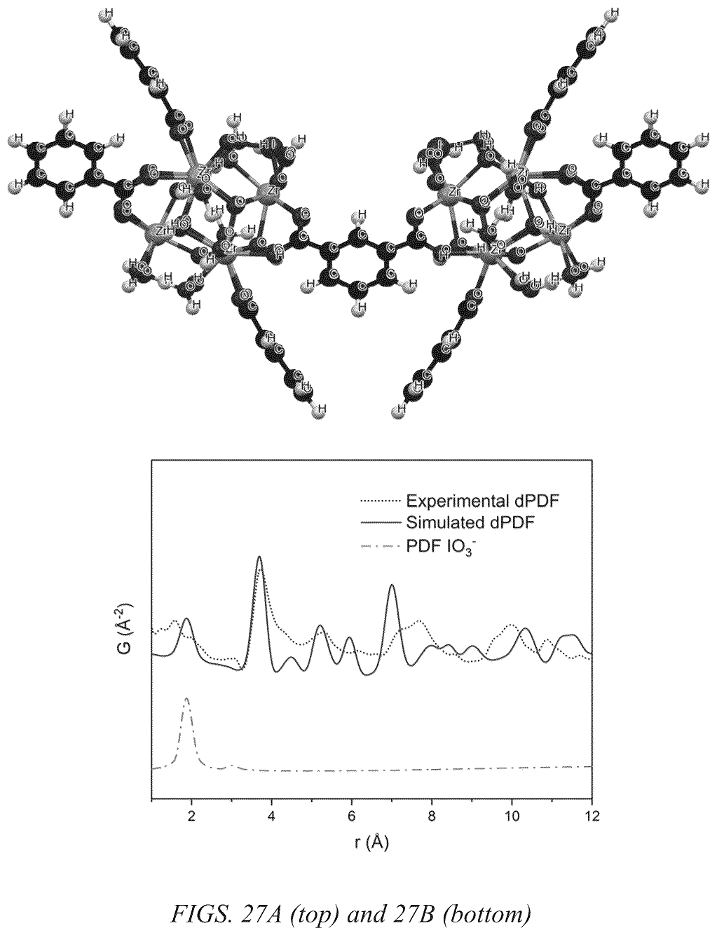

FIG. 27A illustrates a DFT optimized model of the MOF-808 node with bridging iodate ions according to another embodiment of the invention. FIG. 27B illustrates a simulated dPDF of the DFT model of FIG. 27A, experimental dPDF data of iodate-loaded MOF-808, and a simulated dPDF of unbound iodate according to one embodiment of the present invention. Specifically, FIG. 27A shows an optimized structural model of two bridging iodate anion binding to nearest adjacent sites on opposite Zr₆ nodes of a 2-node MOF-808 system. FIG. 27B shows the model-simulated dPDF of the DFT model of FIG. 27A (as shown in the upper distinct line trace). FIG. 27B also shows the dPDF for iodate-loaded MOF-808 (varying width trace shown under the upper distinct line trace for the DFT model) and the dPDF for bare iodate (lower distinct line trace).

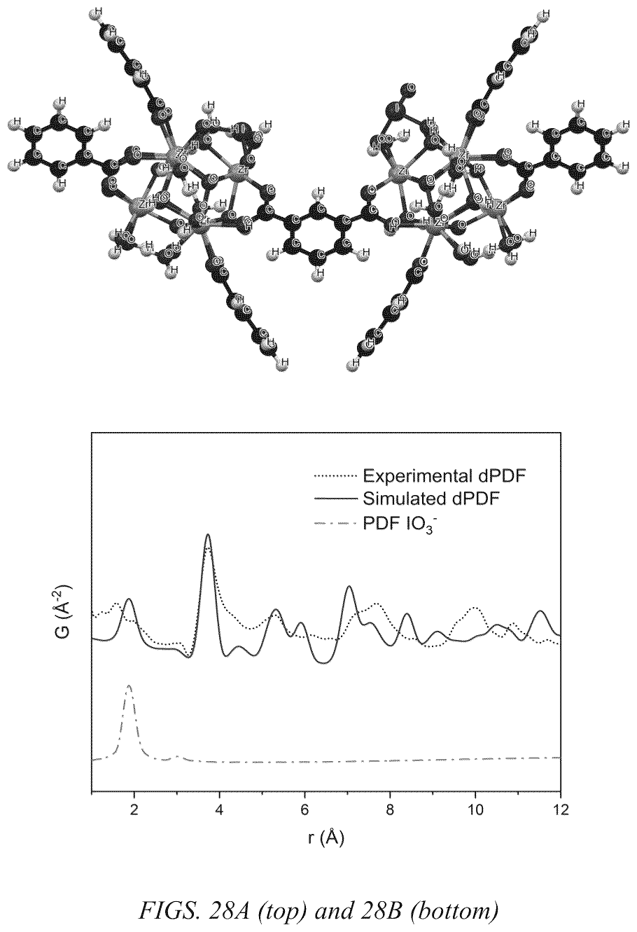

FIG. 28A illustrates a DFT optimized model of the MOF-808 node with bridging iodate ions according to another embodiment of the invention. FIG. 28B illustrates a simulated dPDF of the DFT model of FIG. 28A, experimental dPDF data of iodate-loaded MOF-808, and a simulated dPDF of unbound iodate according to one embodiment of the present invention. Specifically, FIG. 28A shows an optimized structural model of two bridging iodate anion binding to the second nearest adjacent sites on opposite Zr₆ nodes of a 2-node MOF-808 system. FIG. 28B shows the model-simulated dPDF of the DFT model of FIG. 8A (as shown in the upper distinct line trace). FIG. 28B also shows the dPDF for iodate-loaded MOF-808 (varying width trace shown under the upper distinct line trace for the DFT model) and the dPDF for bare iodate (lower distinct line trace).

It should be appreciated that “η₂” refers to the fact that two adjacent oxygen atoms in the iodate are the adsorbing atoms and that “μ₂” refers to those sites comprising the adsorption sites on the MOF surface that are two adjacent Zr metal atoms. In the oxygen cases, “adjacent” refers to one oxygen on each side of the included iodine atom, and in the Zr cases, “adjacent” refers to two Zr atoms separated by sufficient space to bind those two adjacent oxygens. It should be appreciated that the space can be comprised of the organic constituents of the MOF nodal features, with those Zr atoms being held either within the same nodal structure or in two neighboring nodal structures at equilibrium within the range of distance needed to bond the iodate oxygens. In both options the un-excluded space allows for an unencumbered approach from the liquid water solution toward the adsorption site or the two Zr atoms on one node or the two Zr atoms positioned properly for picking up the iodate using two nodes (one Zr atom from each node). It should also be appreciated that the hexagonal symmetry of the macrocrystal affords six full nodal structures pendant to the unit cell that are available to adsorb the iodate (and other oxy-anions analogously) unencumbered by linker excluded volume.

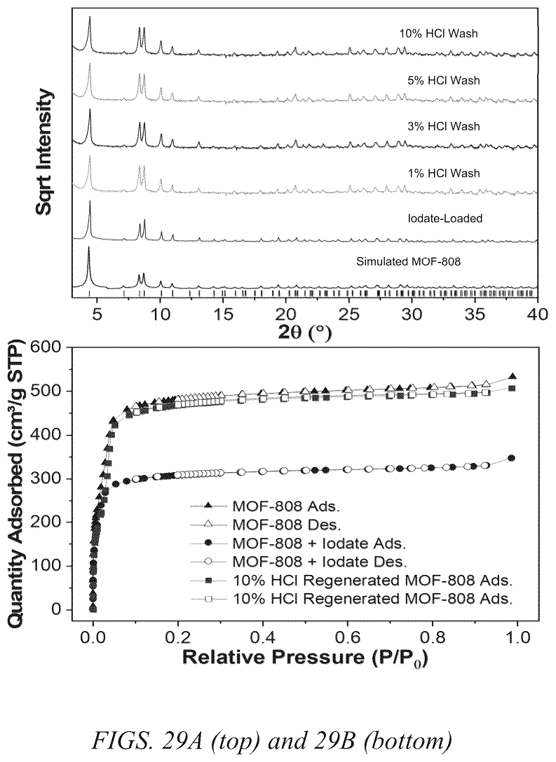

FIG. 29A illustrates powder X-ray diffraction patterns for various forms of MOF-808 according to one embodiment of the present invention. Specifically, the X-ray for the bottom pattern is for a simulated MOF-808, and the pattern immediately above that is for an iodate-loaded MOF-808 (CuK_{α}, λ=1.54178 Å). These data confirm that crystallinity of the MOF is maintained after iodate adsorption. It should also be appreciated that the X-ray patterns shown for various concentrations of HCl, illustrate that the crystallinity of the MOF is maintained even after three regenerative washing steps with 1, 3, 5, or 10% HCl. (Regeneration is discussed further below.)

FIG. 29B illustrates nitrogen gas adsorption/desorption isotherms for various forms of MOF-808 according to one embodiment of the present invention. Specifically, the top two isotherms, which essentially trace on top of each other, are adsorption/desorption isotherms for bare MOF-808, whereas the bottom two lower isotherms, which similarly trace on top of each other, are adsorption/desorption isotherms for MOF-808 having adsorbed iodate or after loading with iodate. It should be appreciated that the isotherms are Type 1b isotherms, with a reduction in BET area from 1860 m2/g to 1270 m2/g and a reduction in pore volume from 0.75 cm³/g to 0.51 cm³/g. These data confirm that the porosity of the MOF is retained after iodate adsorption. It should also be appreciated that the porosity of the MOF is retained even after regeneration as shown by the two middle isotherms. After regeneration the surface area returned to 1850 m2/g, and the pore volume to 0.75 cm3/g. (Regeneration is discussed further below.)

FIGS. 30A-D show SEM images for iodine, zirconium, and MOF-808 crystallite and an SEM-EDS line scan analysis according to one embodiment of the present invention. Larger crystallites of MOF-808 were grown for easier visualization by electron microscopy. SEM images show that the MOF-808 expected morphology is maintained after loading with iodate. Furthermore, EDS elemental mapping and line scan analysis of iodate loaded MOF-808 crystallites show iodine distributed evenly throughout the MOF crystallite.

Depending on the application envisioned, the ability to reuse and recycle an adsorbent material may be an important factor, reducing the cost and amount of material required to remediate contaminated water. To assess the reusability of MOF-808, 10 mg of MOF-808 was loaded with iodate by exposing the MOF to a 1148 ppm solution of potassium iodate overnight resulting in uptake of 1.36-1.61 iodate/node. The following day, the iodate-loaded MOF-808 in the iodate solution was placed on a membrane filter in a glass microfiltration apparatus and the solution was passed through the filter by applying vacuum to the flask. The MOF-808 powder was then washed three times with 10 mL of water. 10 mL of either 1%, 3%, 5%, or 10% HCl was then passed through the MOF by controlled vacuum filtration over the course of 5 minutes. The MOF was then washed with water three times and placed in 10 mL of fresh 1148 ppm iodate solution overnight. When using the 1% HCl solution for regeneration of MOF-808, a maximum of 0.40 iodate/node was removed from the MOF. The performance increased, however, with increasing acid strength.

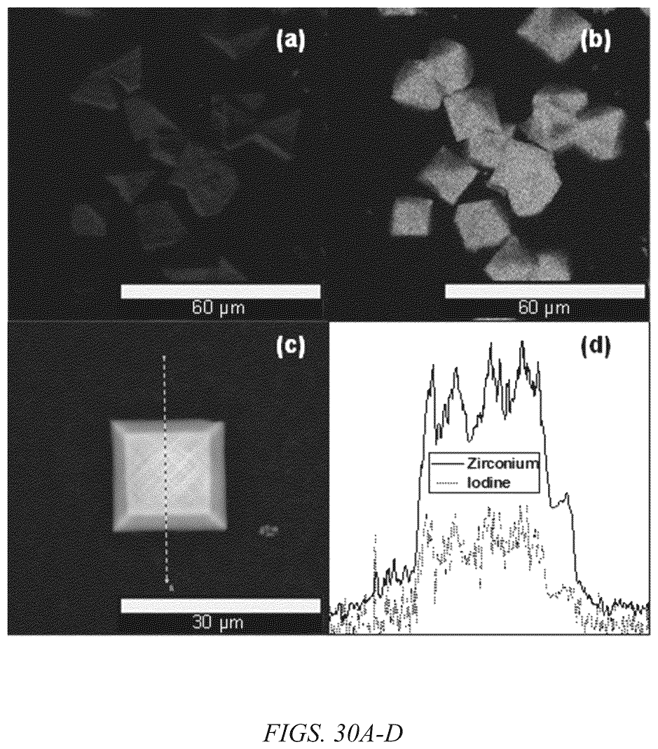

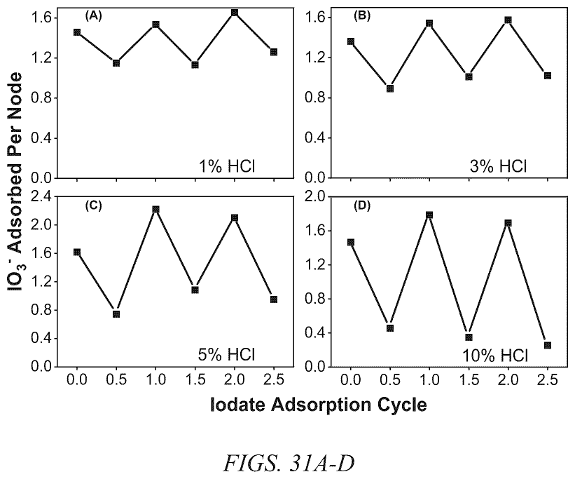

FIGS. 31A-D illustrate adsorption and desorption cycles for iodate in MOF-808 according to one embodiment of the present invention. Washing the MOF with 3% HCl (FIG. 21B) was found to remove a maximum of 0.55 iodate/node with a further increase when using 5% HCl (FIG. 11C) to 1.15 iodate/node. Using 10% HCl (FIG. 11D), the highest removal was obtained, with a maximum of 1.43 node equivalents removed, representing up to 85% removal of adsorbed iodate from the MOF. In between each acid wash, MOF-808 was exposed to an 1148 ppm solution of potassium iodate, and in each case, the maximum iodate uptake was preserved over 2 subsequent adsorption-desorption cycles.

It should also be appreciated that modifications to the MOF, such as MOF-808, can be made. Because there exists in the literature established chemistries for modifying the linker portion of a MOF, such as SALE (solvent assisted linker exchange) and SALI (solvent assisted ligand incorporation (see e.g., P. Deria, W. Bury, J. T. Hupp and O. K. Farha, “Versatile Functionalization of the NU-1000 Platform by Solvent-Assisted Ligand Incorporation,” Chem. Commun. 2014, 50, 1965-1068; and, P. Deria, J. E. Mondloch, O. Karagiardi, W. Bury, J. T. Hupp and O. K. Farha, “Beyond Post-Synthesis Modification: Evolution of Metal-Organic Frameworks via Building Block Replacement,” Chem. Soc. Rev., 2014, 43, 5896-5912), one of expertise in the art should be able to envision suitable algorithms for applying such chemistries to introduce into the MOF-808 cavity appropriate ligand functionalities that further attract anions such as chloride (Cl⁻), iodide (I⁻), and oxy-anions such as selenate (SeO₃²⁻), selenite (SeO₃²⁻), antimonate (SbO₃⁻), antimonite (SbO₂⁻), lead oxides (including Pb(OH)₆²⁻, Pb(OH)₆⁴⁻, PbO₃²⁻, and PbO₂²⁻), and sulfate (SO₄²⁻) so as to enhance the overall binding capacity of the material for these analyte species and hence to improve engineering operations employing these media for water treatment functions. In the specific case of selenate or selenite, one linker chemistry expected by those expert in the art of theoretical bonding calculation is a functionalized urea chemistry, like a pyridyl-urea held pendant on a carbon or ether oxygen linear chain of sufficient length (for example, six to twelve elemental carbon or oxygen atoms long) to allow the urea derived ligand to contact the selenium oxy-anions that permeate the MOF cavity, with an appropriate terminal group to attach said ligand onto the MOF cavity and aperture forming components.

Based on the foregoing, the present invention provides for attaching a ligand to the above MOFs to also complex certain cationic species in addition to removing anionic species. Following is a description of the ligands to be attached to the MOF for purposes of complexing a given cation species, followed by a description of its synthesis to a pendant group, such as a pendant benzyl group. Following this is a further description of its synthesis and attachment to a pendant group, such as a pendant benzyl group, on a MOF of the present invention, for example, via the linker portion of the MOF, to provide a ligated MOF according to the present invention for removal of both anionic and cationic species from a liquid or liquid stream.

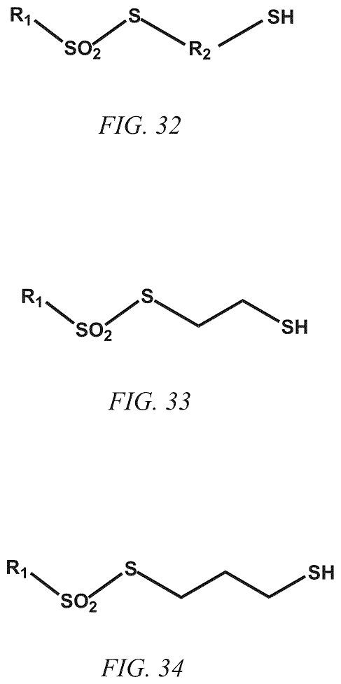

FIG. 32 illustrates a generic chemical compound for use in removing a cation from a liquid according to one embodiment of the invention. As shown, the chemical compound has the formula of R₁—SO₂—S—R₂—SH, where R₁ is generally a support molecule having an appropriate pendant group to which the ligand (—SO₂—S—R₂—SH, where R₂ is an alkyl group) can be attached. The ligand is a thiosulfonyl-thiol (—SO₂—S—R₂—SH) ligand, also known as a thio-alkyl-sulfonyl-mercaptan ligand, where R₂ is an alkyl group, which in some embodiments is either propyl or ethyl. In one embodiment, the support molecule R₁ may be a MOF of the present invention having an appropriate pendant group to which the ligand can be attached. In some embodiments, a benzyl group can be used as the point at which the sulfonyl group of the ligand is attached. In other words, the MOF may have available pendant benzyl groups to which the ligand is attached through the sulfonyl (i.e., —SO₂—) functionality of the ligand. It should be appreciated that the support molecule, such as the MOF, should be able to withstand the conditions used for synthesizing/attaching the ligand of the present invention to the available pendant groups.

It should be appreciated that in some embodiments the sulfonyl group attached to the MOF is such that the thioalkyl group may be attached to the sulfonyl group on the MOF through nucleophilic attack. Therefore, a support molecule, such as a MOF of the present invention, with any pendant group to which the sulfonyl group is attached, and that itself can be attacked nucleophilically, may be used to support the ligand of the present invention. In addition, the resulting structure of the support molecule, such as a MOF of the present invention, with the attached ligand should be stable enough to maintain the capability of backbiting geometry for complexing large divalent cations such as lead (Pb²⁺).

FIG. 33 illustrates one chemical compound for use in removing a cation from a liquid according to one embodiment of the invention. As shown, in this embodiment, the compound has the structure of the compound of FIG. 32, wherein the alkyl group (R₂) is ethyl.

FIG. 34 illustrates another chemical compound for use in removing a cation from a liquid according to another embodiment of the invention. As shown, in this embodiment, the compound has the structure of the compound of FIG. 32, wherein the alkyl group (R₂) is propyl.

The cation is complexed through a bis-sulfur interaction with the ligand in which the cation complexes or ionically interacts with the thio sulfonyl moiety, specifically the mercapto-sulfur of the thio-sulfonyl moiety, and the terminal mercaptan moiety (—SH), which essentially backbites the cation to form five or six member open rings or ring-like geometries, depending upon whether the R₂ alkyl group is ethyl or propyl, that essentially incorporate the cation as part of the open ring. In this manner the cation is actually complexed from two points on a single ligand by using the two sulfurs that each contribute electronegativity to the positively charged cation. This ionic interaction provides a more stable complex and reduces the ability of the complexed cation to be released back into solution based upon equilibrium leakage.

Specifically with respect to the complexation of cations, in one embodiment, the cation that is complexed is lead (Pb²⁺). Accordingly, the ligands of the present invention can be used to complex to cationic lead (Pb²⁺⁾ in the liquid phase to remove the cationic lead from the liquid. The sulfhydril attractor is used as the portion of the ligand which takes up lead cations (otherwise known as a terminal mercaptan of the chemical form —SH). The highest binding energy and fastest uptake kinetics have been observed for lead cations when two reduced sulfur moieties are bound to the same lead cation. Moreover, the use of two mercaptans reduces or minimizes the release of bound lead back into solution thereby limiting the effluent removal fraction for a given liquid stream substantially. Accordingly, rather than using two independent mercapto-terminated ligand features to bind to a lead cation, a type of bis-sulfhydril bonding is used, wherein a geometric backbiting, resulting in a five member open ring or ring-like geometry when the ligand has an ethyl alkyl group (R₂) or a six member open ring or ring-like geometry when the ligand has a propyl alkyl group (R₂). This allows the same ligand to provide both sulfur atoms from which electronegativity is donated to the cationic lead. In some embodiments, the removal of cationic lead exceeds the removal that would otherwise be achieved with ion exchange. It should be appreciated that this same type of bis-sulfhydril bonding can be used to complex mercury cations (Hg²⁺). Accordingly, it should be appreciated that other similar cations may be similarly complexed and removed from a given liquid or liquid stream in conjunction with the removal of oxy-anions using analogously designed, backbiting ligands that can sequester the aqueous cation of interest.

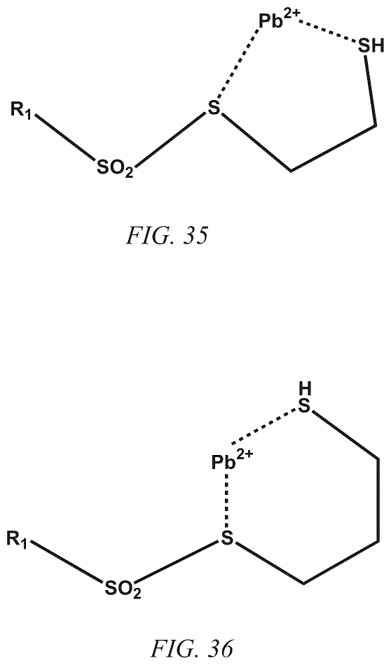

FIG. 35 illustrates the chemical compound of FIG. 33 interacting with cationic lead cation according to one embodiment of the invention. In this embodiment, the chemical compound of FIG. 33 is shown, which is R₁—SO₂—S—R₂—SH, where R₁ is a MOF of the present invention containing appropriate pendant groups, such as a pendant benzyl groups, to which the ligand (—SO₂—S—R₂—SH) is attached, where R₂ is ethyl, and where the dashed lines represent the ionic interactions with the lead. (It should be appreciated that FIG. 35 is not intended to illustrate any steric or otherwise proportional/three dimensional aspects of the chemical compound and the binding of the lead.)

As shown, lead is electronegatively complexed to the ligand through two linkages, one with the mercapto-sulfur of the thio-sulfonyl moiety (or the sulfhydril moiety adjacent to the sulfonyl (also termed a thio-sulfonyl bond) that is attached to the polymer) and the terminal mercapto group at the terminal end of the ligand. In other words, the alkyl, in this case the ethyl alkyl, separates the two points to which the lead is complexed along the ligand. Accordingly, the lead once associated with the ligand in this manner, basically forms a geometry like that of a five member open ring consisting of the ligand backbiting onto the cation. Such adsorptive interactions secure the lead cation to the ligand attached to the MOF and thereby removes the lead cation from the liquid phase or liquid stream.

FIG. 36 illustrates the chemical compound of FIG. 34 interacting with cationic lead according to one embodiment of the invention. The chemical compound of FIG. 34 is shown, which is R₁—SO₂—S—R₂—SH, where R₁ is MOF of the present invention containing appropriate pendant groups, such as a pendant benzyl groups, to which the ligand (—SO₂—S—R₂—SH) is attached to the pendant benzyl group, where R₂ is propyl, and where the dashed lines represent the ionic interactions with the lead. (It should be appreciated that FIG. 36 is not intended to illustrate any steric or otherwise proportional/three dimensional aspects of the chemical compound and the binding of the lead.)

As shown, lead is complexed by the ligand through two linkages, one with the mercapto-sulfur of the thio-sulfonyl moiety (or the sulfhydril moiety adjacent to the sulfonyl (also termed a thio-sulfonyl bond) that is attached to the polymer) and the terminal mercapto group at the terminal end of the ligand. In other words, the alkyl, in this case the propyl alkyl, separates the two points to which the lead is electronegatively complexed along the ligand. Accordingly, once complexed to the ligand in this manner, the lead is basically captured in a geometric six-member open ring consisting of the ligand backbiting onto the cation. Such binding secures the lead to the ligand attached to the MOF and thereby removes the lead from the liquid or liquid stream.

In some embodiments, lead can be captured up to 200 mg/gm capacity for the thio propyl sulfonyl mercaptan ligand (i.e., the ligand of FIG. 34). Testing has shown that lead concentrations as high as 50 ppb in water (as lead nitrate) could be reduced to below 0.5 ppb within a matter of minutes exposure time. Therefore, in some embodiments, the concentration of lead in the effluent liquid stream may be below 1 ppb or at an ultra-low level. Further, the pH of the effluent liquid approached that of concentrated nitric acid when the test analyte was lead in nitrate form, which illustrates that the bis-sulfhydril complex or the interaction of the lead to the sulfur adjacent to the sulfonyl (i.e., the mercapto-sulfur of the thio-sulfonyl moiety) is highly stable, as the corresponding low pH of the effluent did not exhibit any deleterious effect on lead removal. Therefore, this reduces or eliminates the possibility of any desorption of the lead from the ligand back into the liquid or liquid stream.

It should be appreciated that the adsorption of an anion by a MOF of the present invention as described above and the complexation of a cation by the ligand attached to the MOF as described above can occur within the same MOF compound. It should be appreciated that the adsorption of an anion and the complexation of a cation can occur simultaneously or in sequence with either the anion or the cation being the first species to interact with the MOF. During contact between the MOFs of the present invention having the ligand attached to the MOF for complexing cations and the liquid containing one or more oxy-anions and cations to be removed, the oxy-anion is complexed or adsorbed by the MOF structure itself via nodal uptake, and the cation upon entering the cavity of the MOF would complexed or ionically interact with the ligand attached to the MOF. Further, cation and anion uptake capability can be obtained by using a mixture of MOFs, each component of which is functionalized appropriately for adsorption of the particular ion for which it is designed. In addition, as described above, oxy-anions can be adsorbed by attachment to the zirconium node of the MOF.

The chemical compounds of the present invention for use in complexing with both an anionic species and a cationic species may be synthesized by starting with a support molecule, such as a MOF of the present invention. In order to attach the thiosulfonyl-thiol (—SO₂—S—R₂—SH) ligand, also known as a thio-alkyl-sulfonyl-mercaptan ligand, onto the inner surface or aperture of the NU-1000 MOF cavity, an appropriate pendant group, such as a pendant benzyl group, to which the ligand can be attached must be added to the structure of the MOF. Such ligand exchanges or insertions are already known to occur via MOF chemistries known as SALE or SALI. Once the pendant group, such as a pendant benzyl group, is attached, it will be essentially dangling from the MOF surface structure, for example, within the MOF cavity from the inner MOF surface structures or near or at the aperture of the MOF cavity or, in some cases dangling from a portion of the MOF metal-containing nodal structure itself.

The sulfonic acid moiety can then be synthesized onto the MOF via this pendant group. As noted, in one embodiment, this pendant group may be a pendant benzyl group. Accordingly, the following synthesis will be described using a pendant benzyl group as the pendant group. The sulfonic acid moiety can then be synthesized onto the MOF via this pendant benzyl group by reacting with thionyl chloride to form a sulfonyl chloride or by reacting with excess chlorosulfonic acid. It should be appreciated that in some cases, using both thionyl chloride and chlorosulfonic acid during addition of the sulfonic acid moiety may result in the addition of inorganic chloride to the aromatic benzene ring. In some embodiments, thionyl chloride can be used in a post-synthesis or subsequent cold wash. It should also be appreciated that storage of the chlorosulfonated MOF, such as in the form of beads, may result in hydrolysis of the sulfonyl chloride groups to sulfonic acid groups. However, subsequent treatment with thionyl chloride can convert sulfonic acid to sulfonyl chloride to provide full chlorosulfonation of each pendant benzyl ring.

Once the sulfonyl chloride has been generated, a ligand precursor terminated on both ends with a mercaptan can be reacted with the polymer sulfonyl chloride in an appropriate basic buffer system. One end of the ligand precursor attaches to the sulfonic acid function of the polymer through a thio-sulfonyl bond. In this way, the ligand can be attached to each identifiable sulfonyl group on the MOF through a thionyl chloride intermediate chemistry in a moderate base to produce the overall compound structure of R₁—SO₂—S—R₂—SH, where R₁ is a MOF of the present invention having a pendant benzyl group to which the ligand (—SO₂—S—R₂—SH) is attached and where R₂ is an alkyl group that may be either propyl or ethyl. It is important that the basic feature of the buffer does not attack the thionyl chloride independently of the thio-mercaptan. In some embodiments, the basic solution in which the ligand precursor is attached to the sulfonic acid moiety of the MOF contains sodium hydroxide and may have a pH of approximately 10-11.

To form the chemical compound wherein the alkyl group (R₂) is ethyl (see FIG. 33), in one embodiment, the sulfonyl chloride on the MOF may be reacted with 1,2-dimercaptoethane as follows:

[MOF]—(C₆H₅—SO₂—Cl)+HS—[CH₂]₂—SH+NaOH(aq)→[MOF]—(C₆H₅—SO₂—S—[CH₂]₂—SH)+NaCl(aq)+H₂O (Eq. 3)

Specifically, a homogeneous solution of 1,2-dimercaptoethane, sodium hydroxide, and dimethoxyethane (monoglyme, an ether-like solvent) is made. The reaction pH should be approximately 10-11. The reaction must be sufficiently basic such that the 1,2-dimercaptoethane can exist as an anion to condense with the sulfonyl chloride group on the MOF. If the base is too strong, sulfonyl chloride hydrolysis may occur preventing the reaction with the 1,2-dimercaptoethane. If the base is too weak, such may also prevent the reaction with the 1,2-dimercaptoethane.

The MOF with the sulfonyl chloride, such as [MOF]—(C₆H₅—SO₂—Cl), can then be added to the above homogeneous solution. The MOF with the sulfonyl chloride can be added slowly added drop-wise into the solvated dimercaptoalkane solution while the reaction vessel containing the solution is held on ice, as the reaction is exothermic. In some embodiments, the temperature may be maintained at approximately 0-4° C. Various washings may then be used, such as washing with water, methanol, and ethyl acetate. Thereafter, the ligated MOF may be dried and is then ready for use.

To form the chemical compound wherein the alkyl group (R₂) is propyl (see FIG. 34), in one embodiment, the sulfonyl chloride on the MOF may be reacted with 1,3-dimercaptopropane as follows:

[MOF]—(C₆H₅—SO₂—Cl)+HS—[CH₂]₃—SH+NaOH(aq)→[MOF]—(C₆H₅—SO₂—S—[CH₂]₃—SH)+NaCl(aq)+H₂O (Eq. 4)

Specifically, a homogeneous solution of 1,3-dimercaptopropane, sodium hydroxide, and dimethoxyethane (monoglyme, an ether-like solvent) is made. The reaction pH should be approximately 10-11. The reaction must be sufficiently basic such that the 1,3-dimercaptopropane can exist as an anion to condense with the sulfonyl chloride group on the MOF. If the base is too strong, sulfonyl chloride hydrolysis may occur preventing the reaction with the 1,3-dimercaptopropane. If the base is too weak, such may also prevent the reaction with the 1,3-dimercaptopropane.

The MOF with the sulfonyl chloride, such as [MOF]—(C₆H₅—SO₂—Cl), is then added to the above homogeneous solution. The MOF with the sulfonyl chloride can be added slowly added drop-wise into the solvated dimercaptoalkane solution while the reaction vessel containing the solution is held on ice, as the reaction is exothermic. In some embodiments, the temperature is maintained at approximately 0-4° C. Various washings may then be used, such as washing with water, methanol, and ethyl acetate. Thereafter, the ligated MOF may be dried and is then ready for use.

In use and according to one embodiment of the present invention, the MOFs of the present invention can be used in a process to selectively remove particular species from a liquid or liquid stream. As described above, the MOFs of the present invention can be used to remove for example various anionic species, including, for example, oxy-anions, such as oxy-anions of selenium, including selenite (SeO₃²⁻) and selenate (SeO₄²⁻); oxy-anions of antimony, including oxy-anions in either the Sb[III] (antimonite) or the Sb[V] (antimonate) redox state; oxy-anions of lead, including oxy-anions in either the Pb[II] or the Pb[IV] redox state, such as Pb(OH)₆²⁻, Pb(OH)₆⁴⁻, PbO₃²⁻, and PbO₂²⁻; oxy-anion species of iodine, including radioisotopes of iodine such as ¹²⁹I and ¹³¹I, which may exist in the liquid or liquid stream as iodide, I⁻, or an oxy-anion of iodine, such as iodate, IO³⁻; and an oxy-anion of sulfur (sulfate). Further, oxy-anions of nitrogen in aqueous solution (nitrate (NO₃⁻) and nitrite (NO₂⁻)) could be removable by Zr-MOFs. Additionally, the MOFs of the present invention having an attached ligand for complexation with cationic species can be used to remove not only the various anionic species noted but also certain cationic species, such as, for example, divalent lead (Pb²⁺) or mercury (Hg²⁺), and in similar cations in nuclear power primary reactor coolant cleanup applications, cobalt (Co²⁺), which can be radioactive either as ⁵⁸Co²⁺ or more problematically as ⁶⁰Co²⁺, from a liquid stream.

It should be appreciated that the liquid or liquid stream may be any liquid or liquid stream containing anionic or cationic species that can be removed by the MOFs of the present invention. In some embodiments, the liquid stream may be an industrial process stream or wastewater stream. The liquid stream may be an industrial process stream such as a power plant coolant stream, such as nuclear power plant reactor coolant stream or clean-up stream., such as an industrial process liquid stream, including, for example, a power plant process stream or a wastewater stream. It should be appreciated that the ability of the MOFs of the present invention, such as NU-1000 or MOF 808, to reduce the concentration of the oxy-anion in water provides for a more environmentally acceptable water stream. In addition, without being limited by theory, it is believed that the complexation of the cationic species, by the ligand attached to the MOF through the mercapto-sulfur of the thio-sulfonyl moiety and the backbiting terminal mercaptan moiety or through the use of the TEPA ligand, provides the ability to remove significant amounts of the cation from a given liquid, resulting in the ability to achieve extremely low concentrations of the given cation within the liquid or liquid stream.

The particular MOF can be attached to any structure that is used to facilitate contact between the liquid stream having the particular species to be removed and the MOF. For example, the MOF can be attached to precoatable filter/demineralizers or independent packed columns, including such devices already in use at a given facility or plant (e.g., existing vessels used for ion exchange). Thereafter, the structure can be appropriately mounted to allow contact between the liquid stream and the MOF on the structure. Once in contact with the liquid stream, the particular species to be removed is adsorbed onto the MOF, thereby reducing the concentration of that species in the liquid stream.

It should also be appreciated that the MOFs of the present invention with the ligand attached for complexation of cations may be used in various environments or industries in which removal of cationic species is desirable, as the ability to reduce the concentration of large cations in a given liquid solution or stream may have several beneficial effects. For example, reducing the concentration of lead (Pb²⁺) in a given liquid stream can reduce stress corrosion cracking in certain materials in which the liquid stream comes in contact. In addition, removal of certain cation species such as cationic lead and mercury may provide health and environmental benefits. Given that drinking water limits for lead may be as low as 10 ppb, the present invention provides the ability to remove lead in a given liquid stream to such an acceptable level. Further, removal of radioactive cations like ⁵⁸Co²⁺ and ⁶⁰Co²⁺ from a nuclear reactor primary coolant could reduce personnel exposure to detrimental radioactive fields.

As noted above, it should be appreciated that in some embodiments, the liquid stream, such as the industrial process stream, such as a nuclear power plant reactor coolant stream or clean-up stream, may be at a temperature where it may be desirable to maintain the heat content of that stream or minimize the heat loss, such as reducing the amount of cooling required for removing a given species from that liquid stream. Accordingly, the present invention provides the ability to utilize the MOFs described above at higher temperatures, than typically seen for commercially available, nuclear grade, ion exchange, polymeric clean-up resins, to minimize the amount of cooling and thereby improve overall thermal efficiency of the process and nuclear reactor operation. The MOFs of the present invention provide the ability to remove the various species described above at higher than normal temperatures to provide thermal efficiency for liquid streams that would otherwise require cooling prior to treatment.

This feature makes MOFs a potentially an aqueous stream clean-up media for small modular reactors (SMRs, next-generation nuclear power reactor systems employing water-based coolants). Further, in present-day light water reactors (LWRs) for electricity generation, clean-up loops using MOFs may be considered as potential engineering modifications in existing coolant circuits where beneficial, aqueous ion clean-up had not been considered in original designs due to the elevated temperature (above the thermal stability limit of polymeric ion exchange resins) of the liquid stream that could benefit from said clean-up modification. Examples include two in boiling water reactors (BWRs, a type of LWR): a) removing nitrate and nitrite from heater drain liquid derived from turbine extraction lines, wherein the heaters raise the temperature of reactor feedwater using the heat content of the extraction liquid, and pumped forward into BWR final feedwater thereby potentially limiting the ¹⁶N concentration in the circuit and hence reducing turbine deck radiological dose to personnel; and b) removing ⁶⁰Co₂⁺ (a gamma photon emitting radioisotope of cobalt) that carries over in BWR main steam droplets to the moisture separator reheater (MSR) whose drain flow then concentrates the radio-cobalt which also can produce dose to personnel. In the latter example, the radio-cobalt content of the circuit increases as the moisture content of the main steam increases, today almost tripling in volume percentage from that expected in original BWR designs due to more aggressive nuclear core fuel designs. Finally in this example, upon removal of the high temperature, droplet-based radio-cobalt directly from two-phase, main steam using MOFs, then the dose rates from the radio-cobalt could be decreased further using a wet steam cation clean-up system since none of it would have had the opportunity yet in the steam flow to plate out on cooler, metal surfaces of piping and heat exchanger materials downstream of the reactor exit flow.

For example, the use of ion-exchange columns for cleaning nuclear power plant reactor coolant streams or clean-up streams requires that that streams be cooled to obtain the desired removal of a given species. Such results in heat loss. The MOFs of the present invention would allow the aqueous clean-up loop temperature to remain well above the roughly 45° C. thermal limit for nuclear grade ion exchange resins, such as up to approximately 200° C., for purpose of improving energy efficiency of the loop and not having to cool the kidney flow nor reheat it as much. It should be appreciated that the pressure must be maintained at least at or above the saturation pressure of water for each temperature to 200° C. For reference, the primary coolant in a typical GEN III or GEN III+ operating Pressurized Water Reactor is a liquid typically at 155 bar (2235 psig; 2250 psia), which at 290 C is about 82 bar above water saturation and at 320° C. is about 41 bar above water saturation (these temperature examples reflect a possible range of T_{cold} to Tₕₒₜ around the reactor primary, liquid-water-based coolant loop). On the other hand, Boiling Water Reactors [BWRs] operate at saturation with pressure roughly 1000 psig in steam exiting the reactor.

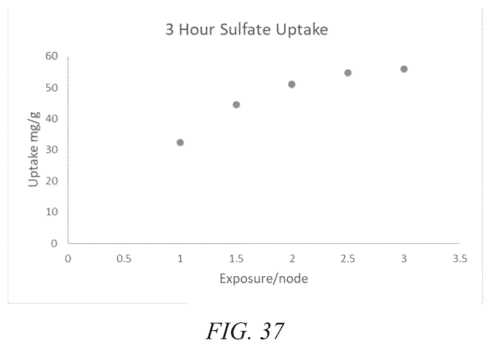

In one embodiment, MOF 808 was synthesized and activated for use in uptake experiments. 5 mg portions of MOF-808 were exposed to 10 mL of water containing 1, 1.5, 2, 2.5, and 3 node equivalents of sulfate, as solutions of 109, 163.5, 218, 272.5, and 327 ppm of Na₂SO₄ at room temperature. Adsorption of sulfate in MOF-808 was tested after 3 hours of exposure. FIG. 37 and Table 9 below illustrate the results.

TABLE 9
Sulfate Adsorption in MOF-808

| Exposure per Node | 3 h Uptake (mg/g) |
|---|---|
| 1 | 33 |
| 1.5 | 44 |
| 2 | 51 |
| 2.5 | 54 |
| 3 | 56 |

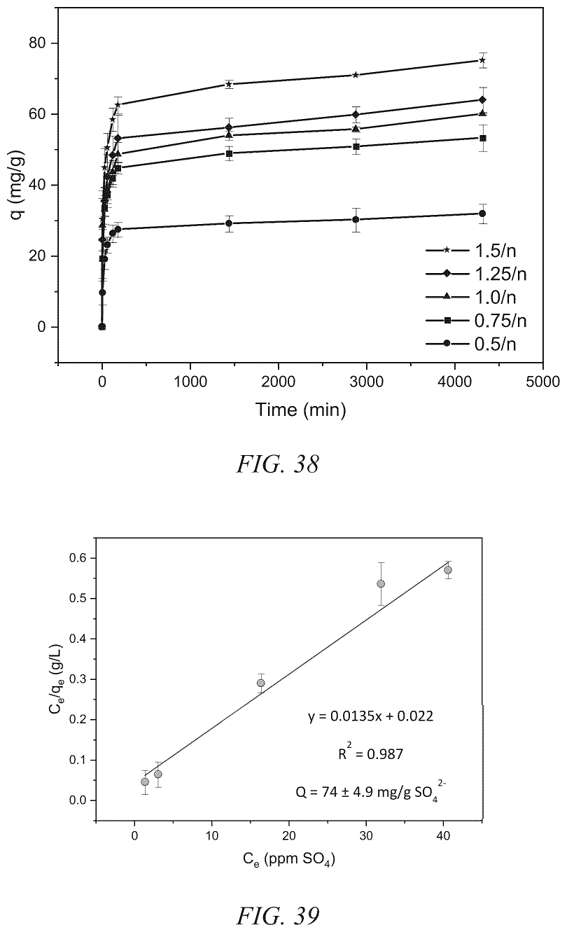

In another embodiment, MOF-808 was synthesized and activated for use in uptake experiments. 20 mg portions of MOF-808 were exposed to 20 mL of water containing 0.5, 0.75, 1.0, 1.25, and 1.5 per node equivalents of sulfate, corresponding to 54.5, 81.75, 111, 138.75, and 163.5 ppm of SO₄ at 20° C. FIG. 38 and Table 10 illustrate the results of the adsorption over time. FIG. 38 shows MOF-808 sulfate uptake after exposure to 0.5, 0.75, 1.0, 1.25, and 1.5 equivalents of sodium sulfate up to 72 h, noting that the legend corresponds to each curve from top to bottom (e.g., exposure to 1.5 equivalents of sodium sulfate is the top curve). Table 10 shows MOF-808 sulfate adsorption per node and per gram, after exposure to increasing concentrations of sodium sulfate at 20° C.

TABLE 10
Sulfate Adsorption in MOF-808

| Exposure per Node | Eq. Uptake per Node | Eq. Uptake (mg/g) |
|---|---|---|
| 0.5 | 0.43 | 31.58 |
| 0.75 | 0.72 | 53.25 |
| 1.0 | 0.81 | 60.02 |
| 1.25 | 0.87 | 63.95 |
| 1.5 | 1.02 | 75.14 |

FIG. 39 illustrates a Langmuir plot for MOF-808 sulfate adsorption at room temperature. The equilibrium adsorption capacity determined using Langmuir adsorption theory shows MOF-808 exhibiting a room temperature capacity of 70.4 mg/g.

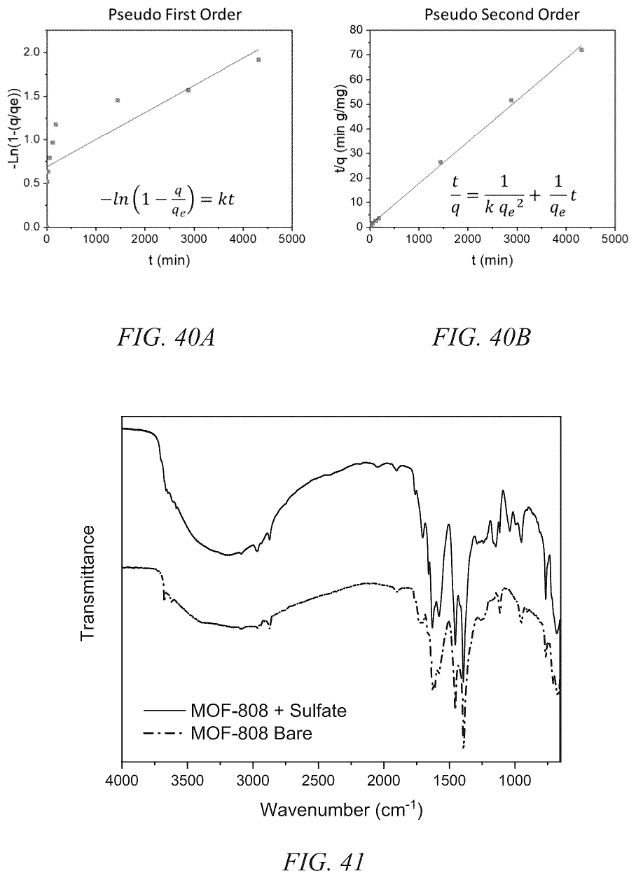

FIGS. 40A and 40B illustrate the results of kinetic studies of the adsorption of sulfate in MOF-808. FIG. 40A shows a rate order determination fitting to pseudo 1^{st} order kinetics, and FIG. 40B shows a rate order determination fitting to pseudo 2^{nd} order kinetics. Using room temperature adsorption data, kinetics studies were performed to determine the reaction rate order and reaction rate constants. Upon fitting, the sulfate adsorption onto MOF-808 was determined to be pseudo-second order, like behavior seen previously for other oxy-anions adsorbed by Zr-MOFs from water solution.

FIG. 41 illustrates diffuse reflectance infrared Fourier transform spectroscopy (DRIFTS) as performed on MOF-808 to confirm the nodal adsorption mechanism by the sulfate oxyanion. There is a reduction of the sharp terminal —OH peak at approximately 3650 cm⁻¹ after soaking in sulfate solution, as the sulfate oxyanions coordinate to the metal node in place of the terminal —OH groups. Also, an S—O stretching vibration appears around 1050 cm⁻¹ after sulfate loading.

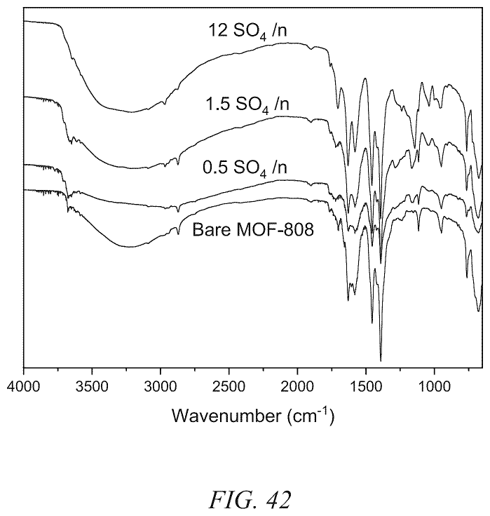

FIG. 42 DRIFTS as performed on MOF-808 to confirm the nodal adsorption mechanism by the sulfate oxyanion according to another embodiment of the invention. Diffuse reflectance infrared Fourier transform spectroscopy (DRIFTS) was performed on MOF-808 to confirm the nodal adsorption mechanism by the sulfate oxyanion, noting that the legend corresponds to each curve from top to bottom (e.g., 12 sulfate/n is the top curve). A reduction of the terminal —OH peak exists at approximately 3650 cm-1 after soaking in sulfate solution, as the sulfate oxyanions coordinate to the metal node in place of the terminal —OH groups, and the appearance of an S—O stretching vibration around 1050 cm-1 after sulfate loading, increasing in relative intensity at higher loading ratios.

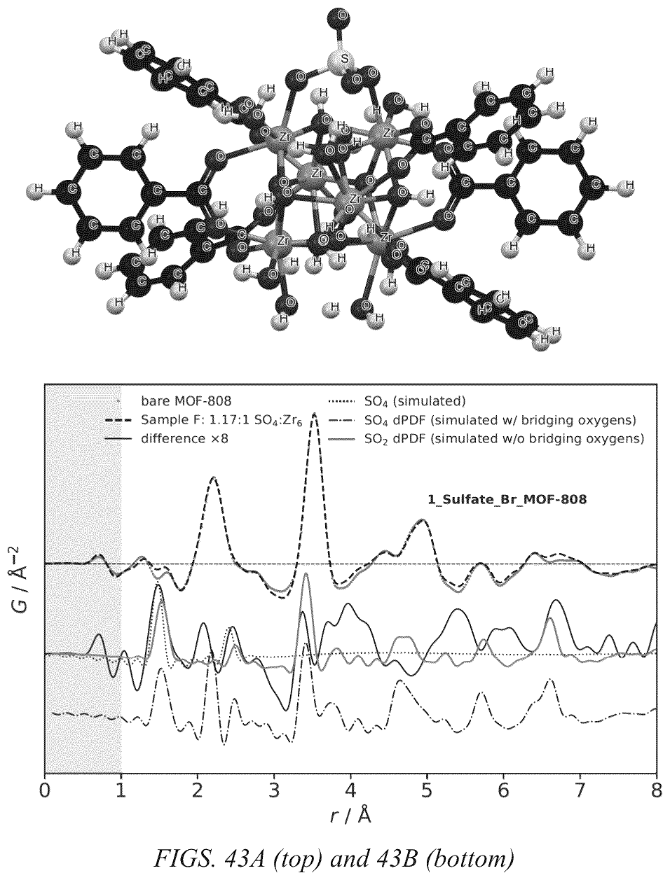

FIGS. 43A-B illustrate DFT optimized MOF-808 node with bridging sulfate comparison to experimental pair distribution function of sulfate loaded MOF-808. Differential pair distribution function analysis of X-ray scattering data was performed on bare and sulfate loaded MOF-808 in a similar fashion to iodate binding studies and compared to DFT optimized binding models. Preliminary results suggest that the sulfate binding occurs by the same bridging (μ₂η₂) mechanism found in other oxyanions.

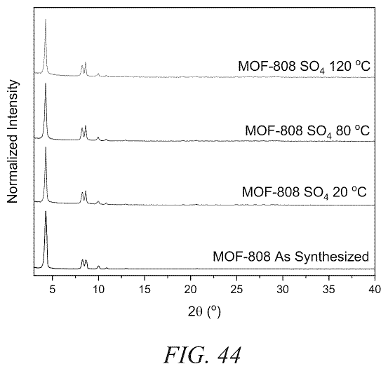

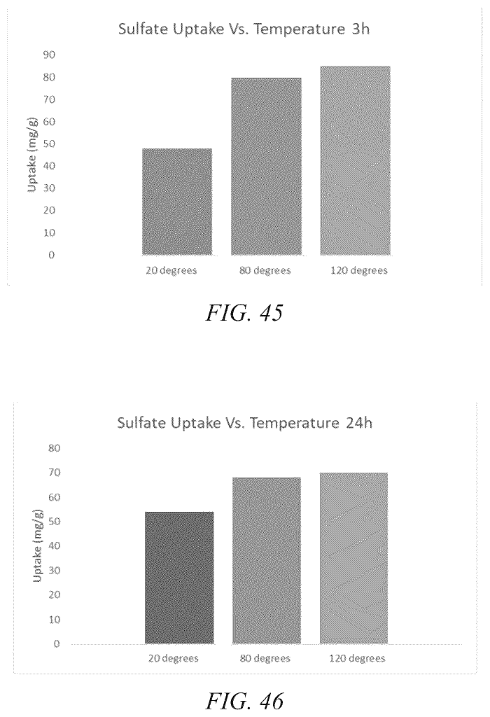

FIGS. 44 and 45 illustrate sulfate uptake by MOF 808 after 3 hours and 24 hours, respectively, at 20° C., 80° C., and 120° C. Table 11 provides the same. Sulfate adsorption from water using MOF-808 was tested at 20° C., 80° C., and 120° C. 5 mg portions of MOF-808 were exposed to 10 mL of a 1.5 sulfate per node equivalent solution of sodium sulfate. For 80° C. data collection, samples were heated in a sand bath for 2 hours and 55 minutes in a sealed centrifuge tube, cooled for 5 minutes to prevent evaporation and the aliquot taken for a 3-hour time point. For 120° C., samples were heated in a pressurized CEM Discover 2.0 solvothermal synthesis microwave for 2 hours and 45 minutes under stirring. The vial was cooled for 15 minutes to room temperature to prevent evaporation, and the aliquot taken for a 3-hour time point. For the 24 hour time point measurements, samples were heated in sealed reaction jars in an oven at either 80° C. or 120° C. for 23 hours and 45 minutes, and cooled for 15 minutes to prevent evaporation before the aliquots were taken.

TABLE 11
Sulfate uptake by MOF 808

| Temperature (° C.) | 3-Hour Uptake (mg/g) | 24-Hour Uptake (mg/g) |
|---|---|---|
| 20 | 48 | 54 |
| 80 | 80 | 68 |
| 120 | 85 | 70 |

It should be appreciated that the stirring setting and gentle boiling of the 120° C. reaction performed in the microwave may have resulted in reduced contact between the MOF and the sulfate solution, potentially decreasing the total uptake. Regardless of these effects, the sulfate uptake performance was increased relative to room temperature at both elevated temperatures. The increased temperatures may be resulting in improved kinetics due to higher rates of diffusion, allowing samples at 80° C. and 120° C. to reach equilibrium more quickly than the room temperature samples.

FIG. 46 illustrates powder X-Ray diffractograms of as-synthesized MOF-808 and MOF-808 after 3-hour sulfate adsorption experiments at 20° C., 80° C., and 120° C. Powder X-ray diffraction (PXRD) data was collected on the MOFs before and after exposure to the sulfate solutions at elevated temperatures to determine the structural stability of the materials under these conditions. PXRD studies show the conservation of the crystalline structure after exposure to higher temperatures, and for the case of the 120° C. sample, microwave irradiation, for prolonged periods of time. It is important to note for clarity that all work on liquid water systems at temperatures in excess of 100° C. was accomplished at elevated pressure, too, so as to keep the system in the liquid state as much as possible.

Mass balance confirmation experiments were performed by weighing an initial mass of MOF (10 mg) and exposing it to a sulfate solution for 3 hours at either 20° C., 80° C., or 120° C. After the 3 hours elapsed, the samples were cooled and filtered using a vacuum microfiltration apparatus, and washed 3× with 10 mL of ethanol. The samples were transferred to pre-weighed glass vials and heated at 160° C. for 12 hours to remove all traces of water, and reweighed. All samples experienced minor weight loss; however, this may be attributed to transfer losses due to the small scale of the experiment. Table 12 illustrates these results.

TABLE 12
MOF-808 mass balance after exposure to sulfate
solutions at elevated temperatures

| Temperature (° C.) | Starting Mass (mg) | Mass after 3 hours (mg) |
|---|---|---|
| 20 | 10.0 | 9.2 |
| 80 | 10.0 | 8.9 |
| 120 | 10.0 | 9.2 |

These tests illustrate the strong potential for MOF-808 to physi-sorb sulfate via nodal bridging binding without significant loss after several hours of exposure at elevated temperature, thereby indicating that the MOF itself as well as its sulfate adsorbate likely will remain chemically stable for further extended periods at such elevated temperature. If similar results bear out in the laboratory for temperature to 200° C., then the likelihood of using MOFs for primary RWCU loops in advanced reactors with significant energy efficiency savings within the primary coolant clean-up operation is reasonably high.

Initial sulfate adsorption uptake temperature effect studies were performed at 20° C., 40° C., 60° C., 80° C., 100° C., and 120° C. using 20 mg portions of MOF-808 exposed to 20 mL of a 1.5 sulfate per node equivalent solution of sodium sulfate. For kinetic studies lasting up to 3-hour below 100° C., sulfate solutions were preheated in an oven to the target temperature before the MOF powder was added. For kinetic studies lasting 3 hours at temperatures over 100° C., a pressurized microwave reactor was used, noting that the solutions were stirred. It is important to note for clarity that all work on liquid water systems at temperatures in excess of 100° C. was accomplished at elevated pressure, too, so as to keep the system in the liquid state as much as possible.

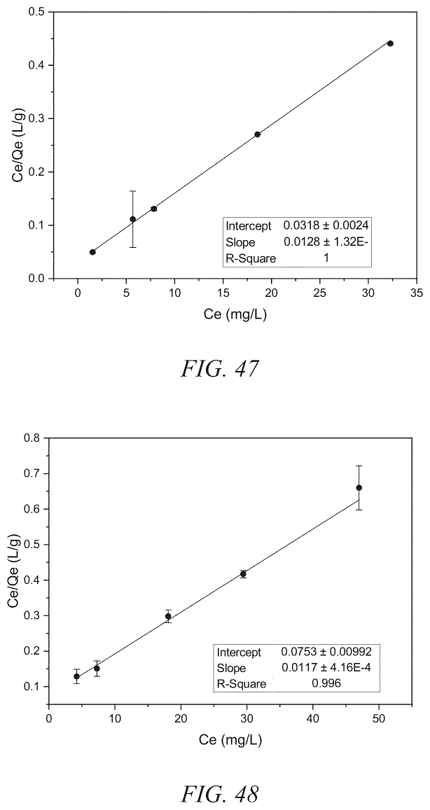

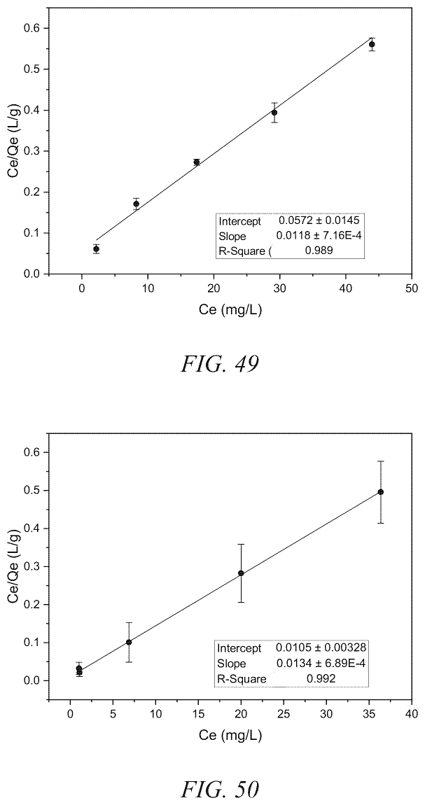

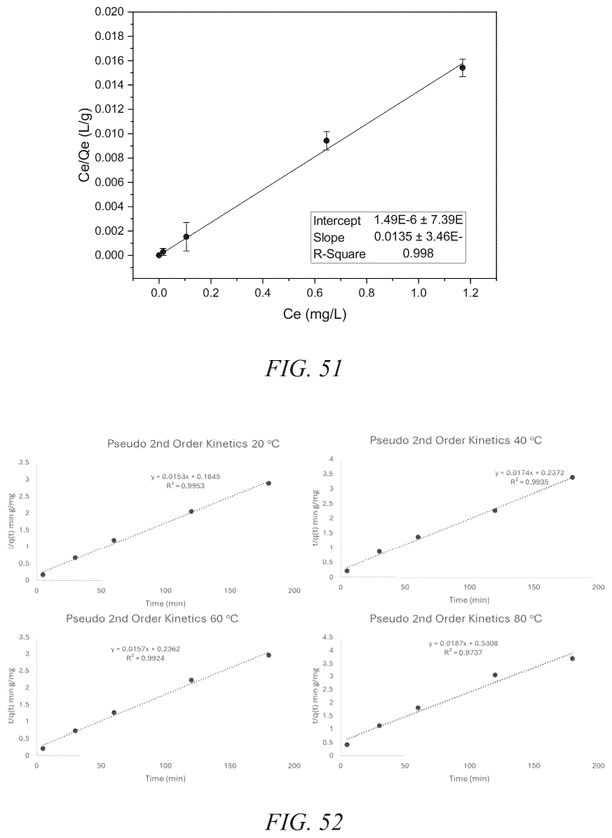

FIGS. 47-51 illustrates Langmuir plots for sulfate adsorption in MOF-808 at various temperatures. Specifically, Langmuir plots were constructed for each of the above sulfate adsorption studies. FIG. 47 illustrates a Langmuir plot for MOF-808 sulfate adsorption at between 0.5-1.5 per node exposure at 40° C. FIG. 48 illustrates a Langmuir plot for MOF-808 sulfate adsorption at between 0.5-1.5 per node exposure at 60° C. FIG. 49 illustrates a Langmuir plot for MOF-808 sulfate adsorption at between 0.5-1.5 per node exposure at 80° C. FIG. 50 illustrates a Langmuir plot for MOF-808 sulfate adsorption at between 0.5-1.5 per node exposure at 100° C. FIG. 51 illustrates a Langmuir plot for MOF-808 sulfate adsorption at between 0.5-1.5 per node exposure at 120° C. An increase in the maximum adsorption capacity relative to room temperature is observed at 40° C., 60° C., and 80° C., while exhibiting uptake at 100° C. and 120° C. that is equivalent to 20° C. Peak uptake at 60° C. of 85 mg/g shows ˜15% increase in adsorption capacity relative to the 74 mg/g at 2° C. (see Table 13 below).

TABLE 13
Temperature effect on maximum sulfate uptake capacity

| Temperature (° C.) | Uptake (mg/g) |
|---|---|
| 20 | 74 ± 4.9 |
| 40 | 79 ± 1.0 |
| 60 | 86 ± 3.0 |
| 80 | 85 ± 5.1 |
| 100 | 75 ± 3.8 |
| 120 | 74 ± 1.9 |

FIG. 52 illustrates pseudo second order kinetics fits for MOF-808 sulfate adsorption at 1.5/n exposures up to 3 hours at 20° C., 40° C., 60° C., and 80° C. Uptake kinetics experiments were performed to determine the rate constants for adsorption by fitting to a pseudo-second-order kinetics model. The rate constant for sulfate adsorption in MOF-808 increases relative to room temperature at both 40° C. and 60° C., while decreasing as the temperature is increased to 80° C., indicating that 60° C. is likely the most kinetically efficient temperature for sulfate adsorption within this temperature range (see Table 14 below).

TABLE 14
Rate constants for MOF-808 sulfate adsorption between 20-80° C.

| Temperature (° C.) | K (min⁻¹) |
|---|---|
| 20 | 0.00096 |
| 40 | 0.001909 |
| 60 | 0.001034 |
| 80 | 0.000651 |

Uptake experiments were performed at elevated temperatures of 150° C. and 200° C. to probe the high temperature performance of the MOF in a specially designed pressure reactor that eliminated the need for sealed jars when microwave heating. 3-hour sulfate uptake after exposure to 1.5/node sulfate solutions showed high uptake at 150° C. of 76.6 mg/g, compared to 62.5 mg/g at room temperature and 66.4 mg/g at 60° C., while adsorption was reduced to 23.4 mg/g at 200° C., likely due to partial structural collapse of the MOF pore network (see Table 15 below). These results suggest that sulfate uptake is most efficient at 150° C.

TABLE 15
Temperature effect on sulfate uptake after 3 hours

| Temperature (° C.) | Uptake (mg/g) |
|---|---|
| 20 | 62.5 |
| 40 | 53.3 |
| 60 | 66.4 |
| 80 | 52.2 |
| 150 | 76.6 |
| 200 | 23.4 |

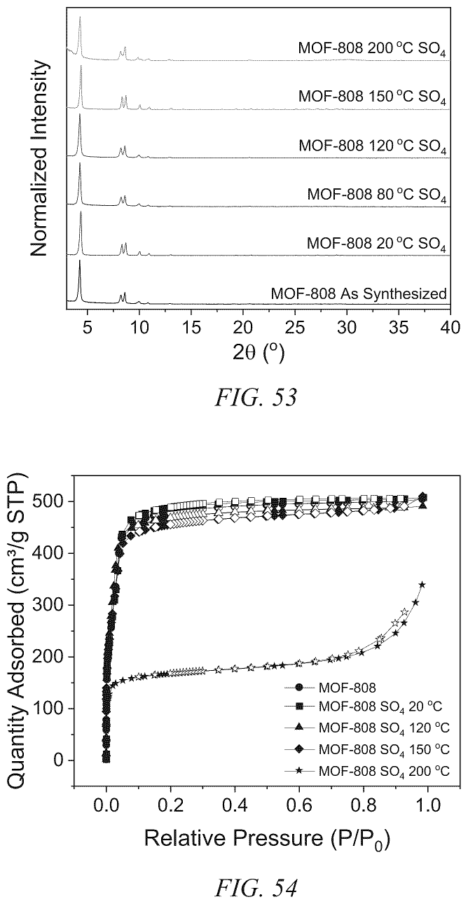

FIG. 53 illustrates powder X-ray diffractograms of as-synthesized MOF-808 and MOF-808 after 72-hour sulfate adsorption experiments at 20° C., 80° C., and 120° C. and after 3-hour adsorption experiments at 150° C. and 200° C. Powder X-ray diffraction (PXRD) experiments were performed on the MOFs before and after exposure to the sulfate solutions and elevated temperatures to determine the structural stability of the material under these conditions. PXRD studies show the conservation of the crystalline structure after exposure to higher temperatures, and for the case of some 120° C. and 150° C. samples, microwave irradiation, for prolonged periods of time. MOF-808 samples exposed to sulfate solutions at 200° C. begin to show signs of a reduction in bulk crystallinity.

FIG. 54 illustrates nitrogen adsorption-desorption isotherms for as-synthesized MOF-808 and MOF-808 after 72-hour sulfate adsorption experiments at 20° C. and 120° C. and 3-hour adsorption experiments at 150° C. and 200° C. Nitrogen adsorption-desorption isotherms were collected on MOF-808 samples used in 72-hour sulfate uptake experiments at temperatures up to 120° C. For 72 h equilibrium uptake studies at 120° C. the MOF was added to room temperature solutions and heated in a sealed glass jar. For experiments at temperatures higher than 120° C., reactions were performed in a pressurized microwave reactor with stirring. The isotherms collected show that MOF-808 retains its porosity over a broad temperature range from 20-150° C. during sulfate exposure. At elevated temperatures of 120° C. and 150° C., the BET surface areas of 1900 and 1870 m²/g respectively both show a reduction of less than 5% of the original 1950 m²/g surface area. However, after exposure to sulfate solutions at 200° C., MOF-808 shows a significant decline in surface area to 640 m²/g, indicating partial collapse of the pore structure. The partial pore collapse at this temperature does not appear to be the result of framework disintegration, where Zr leaching experiments performed on the sulfate solution post-adsorption show extremely low levels of Zr, with the highest corresponding to below 0.07% of the total Zr mass of the MOF after 200° C. exposure, with leaching levels two orders of magnitude less for the 20-150° C. temperature regime, meaning less than 0.0007% of leached Zr. Hence, likely industrial process and nuclear power applications up to 150° C. in pressurized liquid water solutions could be addressable using Zr-MOFs.

The present invention also provides methods for attaching a MOF to a substrate to form a MOF-containing product that can be used in numerous ways depending upon the specific MOF attached to the substrate. Accordingly, it should be appreciated that a particular MOF having a particular property, such as an affinity for a particular species to be removed from a given fluid, may be selected for attachment to the substrate. The substrate may be any substrate to which a given MOF may be attached, and the form and shape of the substrate may be selected based upon its ultimate use. For example, the configuration or shape of the substrate may be selected to allow use of the selected MOF in a given environment, such as a given industrial process or a given piece of equipment, and provide the proper exposure of the MOF in that environment, such as exposure of the MOF to a given fluid in a given process or piece of equipment. It should be appreciated that while reference herein is generally to MOF in the singular, such should also be interpreted as appropriate as referring to a plurality of MOF particles, as opposed to a single MOF particle or structure. For example, description regarding the mechanism for attachment of a MOF to a substrate may be interpreted as the mechanism for attachment of a single MOF particle; however, it should be understood that in attaching a MOF to a substrate that a plurality of MOF particles would obviously be attached to a given substrate.

Accordingly, the present invention provides methods for disposing a given MOF on a substrate to form a commercial product. The present invention also provides methods for utilizing that commercial product in a given process to remove certain chemical species or compounds from a fluid, such as a liquid or a liquid stream or a gas or gas stream. The following provides a description of these methods, including the MOFs and the substrates that may be used in the present invention, noting that such are exemplary and not intended to represent the only MOFs or substrates that may be used or the only manner in which the MOF-containing substrate product may be used. As noted, the MOF may be any of the MOFs described herein.

The substrate may be any substrate to which a given MOF may be attached and that is suitable for use in the environment or process in which it will be used to remove certain chemical species or compounds from a liquid or a liquid stream. In some embodiments, the substrate may be an inert substrate to avoid any chemical interaction with the liquid or liquid stream being treated. In some embodiments, the substrate has a physical shape that allows for its deployment and use in a given process or in a particular piece of processing equipment for removing certain chemical species from a given liquid stream. In some embodiments, the substrate may be a bead or plurality of beads. In some embodiments, the beads may be inert polypropylene polymer resin beads. In some embodiments, the substrate may be a macroscopic fabric, such as a mesh material or mesh filter. In some embodiments, the substrate may be a molecular fabric made from organic strands, essentially consisting of a two dimensional copolymer framework or organic woven material.

It should be understood that the following description of the methods for attaching a given MOF to a substrate, as well as the description of the methods for using the substrate with the attached MOF, refers to a MOF generically. However, it should be appreciated that in all of the embodiments described herein, the specific MOFs noted above may be used. Accordingly, it should be appreciated that while some of the above specific MOFs are capable of removing, or configured to remove, specific liquid phase cationic and anionic species, other MOFs capable of removing other liquid phase species from a liquid or liquid stream may similarly be used and attached to a given substrate. Further, while some of the above specific MOFs are capable of removing certain species from a gas or gas stream, such as water from ambient air, other MOFs capable of removing other gas phase species from a gas or gas stream may similarly be used and attached to a given substrate. (It should be appreciated that the term “gas” or “gas stream” is used generically and includes any gas or gas stream containing condensable species or entrained vapor or particles.) In addition, while the following methods are described with reference to specific substrates, it should be appreciated that other substrates, including substrates having a different chemical composition or having a different geometric shape, may be used in any combination with any suitable MOF.

In general, methods for attaching a given MOF particle to a substrate may depend upon the specific substrate used. Accordingly, the following describes methods for attaching a given MOF to a bead, including a plurality of beads, a macroscopic fabric, such as a mesh fabric, a mesh filter media or a mesh filter septa, and a molecular fabric made from organic strands, essentially consisting of a two dimensional copolymer framework or organic woven material.

In some embodiments, a given MOF may be attached to a substrate that is a bead or a plurality of beads. In some embodiments, the bead may be an inert polypropylene polymer resin bead. In general, the method for attaching the MOF is performed using a buffer modifier that adheres the MOF to the surface of the bead. In some embodiments, the buffer modifier may be a buffer modifier typically used in capillary electrophoresis such as an osmotic flow modifier, including CTAB and beta-CD. Both CTAB and beta-CD are compounds that bind well to MOF particles at room temperature and cause the MOF to be chemisorbed onto the surface of the bead.

In one embodiment, CTAB may be used to attach the MOF to the bead surface. In this case, atomic layer deposition (ALD) is used to seed the beads with metal oxides that provide surface hydroxyl groups capable of forming chemical bonds with MOF particles via the CTAB. In some embodiments, the metal oxide chemisorbs onto the bead surface in water, thereby making hydroxyl groups available for attachment to the CTAB, via, for example, the cationic head groups of the CTAB. These metal oxides include, but are not limited to, aluminum oxide, titanium oxide, zinc oxide, and combinations thereof. Once exposed to water, the deposited metal oxides will appear similar to silicon dioxide/surface hydroxide in a capillary electrophoresis osmotic flow reversal application of CTAB. Accordingly, the MOF is then attached to the CTAB through hydrogen bonding, electrostatic interactions, and van der Waals forces. Without being limited by theory, it is believed that the non-polar surfaces of the MOF, such as the organic linkers of the MOF, attach to the trimethyl “arms” of the CTAB.

In one embodiment using CTAB, the beads may first be subjected to ALD to chemisorb the metal oxide to the surface of the beads. Separately, the CTAB and MOF may be combined at room temperature to attach the MOF to the CTAB and form a solution of the CTAB with the MOF attached. The beads with the metal oxide attached may then be contacted with the solution or combined with the CTAB having the attached MOF resulting in the CTAB attaching to the bead surface via the metal oxide, again, which can be done at room temperature in a water solution and in some embodiments in a basic water solution. Alternatively, the beads after being subjected to ALD to attach the metal oxide may be mixed in a water solution containing the MOF and, in some embodiments, a basic water solution containing the MOF. Subsequently, the CTAB may be added to the solution to attach to both the MOF and the metal oxide resulting in attachment of the MOF to the bead surface. Thereafter, the beads can be washed and dried. Accordingly, at this point, a MOF-adsorbed bead, such as a plurality of MOF-adsorbed polypropylene beads, has been produced and may constitute a commercial product that can be used as further described below.

In another embodiment, beta-CD may be used to attach the MOF to the bead surface. In this case, the substrate does not need to be subjected to ALD. Rather, the non-polar region of the beta-CD will attach to a corresponding non-polar portion of the polypropylene beads via hydrogen bonding, electrostatic interactions, and van der Waals forces. The MOF can then be attached to the beta-CD via interaction between one or more polar portions on the surface of the MOF with the negative charge on the beta-CD. In some embodiments, the MOF can be attached to the beads in a water solution containing beta-CD. In some embodiments, a less polar solvent, such as an alcohol, may be used. Thereafter, the beads can be washed and dried. Accordingly, at this point, a MOF-adsorbed bead, such as a plurality of MOF-adsorbed polypropylene beads, has been produced and may constitute a commercial product that can be used as further described below.

It should be appreciated that in some embodiments both beta-CD and CTAB may be used in combination. In this case, the substrate or beads would be subjected to ALD, after which a solution containing the MOF and both CTAB and beta-CD would be added.

It should also be appreciated that in some embodiments, the surface of the beads for functionalization of the CTAB and beta-CD may be silicon dioxide. In some cases, silane hydroxide chemistry may be used to functionalize the polymer bead to accept silicon adducts followed by hydroxide to provide the necessary chemistry for the attachment of the CTAB or beta-CD.

In another embodiment, the invention comprises a method for attaching the MOF to a macroscopic fabric for subsequent use. In some embodiments, the macroscopic fabric may be any fabric, including artificial fiber-based materials, to which a given MOF may be attached. In some embodiments, the macroscopic fabric is a mesh material, a mesh filter media or a mesh filter septa, including an inert polypropylene-based mesh material or filter. Accordingly, it should be appreciated that the fabric may have any dimensions, such as any area or surface area, as desired or dictated by the ultimate use of the fabric. MOF particles may be attached to the fibers of the fabric in the same manner described above for attachment to a bead. Accordingly, it should be appreciated that buffer modifiers such as beta-CD and CTAB may be used as described above to attach the MOF to the fabric in combination with ALD treatment of the fabric. After attachment of the MOF to the macroscopic fabric, a MOF-adsorbed macroscopic fabric has been produced and may constitute a commercial product that can be used as further described below. It should be appreciated that the term “macroscopic” is being used to distinguish this fabric as being one that is visible to the naked eye or that can be physically manipulated by hand, as opposed to a molecular fabric as described below.

In another embodiment, the invention comprises a method for attaching the MOF to a molecular fabric for subsequent use. In some embodiments, the molecular fabric is made from organic strands, essentially forming a two dimensional copolymer framework or organic woven material, to which a given MOF may be attached. MOF particles may be attached to the strands of the fabric in the same manner described above for attachment to a bead. Accordingly, it should be appreciated that buffer modifiers such as beta-CD and CTAB may be used as described above to attach the MOF to the fabric in combination with ALD treatment of the fabric. After attachment of the MOF to the molecular fabric, a MOF-adsorbed molecular fabric has been produced and may constitute a commercial product that can be used as further described below. It should be appreciated that the molecular fabric is a fabric formed at the molecular level and is, therefore, much smaller in size than, for example, the macroscopic fabric described above.

Once attached, the substrate with the attached MOF can be used to remove certain chemical species from a liquid or liquid stream, such as industrial liquid streams (e.g., power plant coolant streams such as nuclear power plant streams) or waste streams. Generally, the substrate with the attached MOF would be positioned to allow contact between the liquid containing one or more liquid species to be removed from the liquid with the MOF. Upon contact, the liquid species to be removed would attach to the MOF and, therefore, be removed from the liquid. In this regard, the manner in which the substrate with the attached MOF would be used depends the particular MOF attached and the liquid phase species that it can remove and upon the physical configuration of the inert substrate used (e.g., beads or fabric).

In the case of beads, such could be used in the same manner as traditional resin beads to remove certain chemical species from a liquid, for example, by placing the beads in a resin bed in a given vessel through which the liquid being treated would pass. It should be appreciated that existing equipment designed to manage resin beads may be adapted if necessary to manage the use of beads coated with MOF particles. In one embodiment, a cylindrical vessel containing a bed of beads coated with MOF particles could be used. In this case, the bed of beads would be stationary within the vessel and a liquid stream would pass through the vessel, thereby passing through the bed of beads and providing contact between the liquid containing a liquid species to be removed and the MOF particles. Upon contact, the liquid species to be removed would attach to the MOF and, thereby, be removed from the liquid passing through the vessel.

It should be appreciated that in some embodiments in which the vessel contains resin beads that are used to remove certain liquid phase species, such resin beads can be replaced with beads coated with a given MOF according to the present invention. In one embodiment, when the resin beads are in need of replacement, such can be easily replaced with beads coated with a given MOF according to the present invention within the same equipment. Alternatively, the resin beads could be replaced with inert polypropylene beads and attachment of the selected MOF can be performed in-situ. In this case, the beads could be pre-treated with ALD to attach a given metal oxide and then disposed within the vessel or such treatment with ALD to attach a metal oxide could also be performed in-situ. In the latter case, the beads would be disposed within the vessel and then treated using ALD to attach a metal oxide. Thereafter, a solution containing CTAB and the selected MOF could be added to the vessel to attach the CTAB and the MOF to the beads, or a solution of CTAB could be added to the vessel followed by a solution of the selected MOF. The result would be the replacement of the original resin beads with beads coated with a selected MOF without having to alter or change any of the existing equipment used for the original resin beads.

Alternatively, the beads would be disposed within the vessel and thereafter, a solution containing beta-CD and the selected MOF could be added to the vessel to attach the beta-CD and the MOF to the beads, or a solution of beta-CD could be added to the vessel followed by a solution of the selected MOF. The result would be the replacement of the original resin beads with beads coated with a selected MOF without having to alter or change any of the existing equipment used for the original resin beads.

In the case of a macroscopic fabric coated with a select MOF, such fabric could be positioned or placed such that a liquid stream would pass through the fabric, thereby providing contact between the liquid containing a liquid species to be removed and the MOF particles attached to the fibers of the fabric. Upon contact, the liquid species to be removed would attach to the MOF and, thereby, be removed from the liquid passing through the fabric. It should be appreciated that the fabric may be placed within a vessel or pipe or any piece of equipment such that the liquid would pass through the fabric.

In one embodiment, a demineralizer through which a liquid stream passes may be used. In this case, the macroscopic fabric may be a mesh filter that can be wound into a spiral, thereby creating a lumen in the center. Liquid may pass into the demineralizer and around the outside of the wound mesh filter. The liquid would then pass through the wound mesh filter and into the lumen or center of the demineralizer and out through the center of the demineralizer. It should be appreciated that in some embodiments, an existing mesh filter may be coated with a select MOF. In this case, the MOF can be attached to the existing mesh filter in-situ in the same manner as described above for in-situ coating of beads in an existing vessel.

It should also be appreciated that a MOF-coated fabric may be used in many different situations. In one embodiment, the MOF-coated fabric may be used on top of a resin bed to facilitate removal of liquid phase species, either providing removal of other liquid phase species relative to those removed by the resin bed or additional removal of the same or similar species. Additionally, it should be appreciated that in the embodiment in which a bed of beads is coated with a select MOF in-situ, the use of a macroscopic fabric on top of the bed may also be coated with a select MOF in-situ and concurrently with the coating of the bed of beads. Accordingly, it should also be appreciated that the MOF used for the beads and the fabric may be the same or different, noting that if different, either the beads or the fabric may need to be coated prior to disposing both within a given vessel.

In the case of a molecular fabric coated with a select MOF, such fabric could be positioned or placed such that a liquid stream would pass through the fabric, thereby providing contact between the liquid containing a liquid species to be removed and the MOF particles attached to the fibers of the fabric. Upon contact, the liquid species to be removed would attach to the MOF and, thereby, be removed from the liquid passing through the fabric. It should be appreciated that the fabric may be placed within a vessel or pipe or any piece of equipment such that the liquid would pass through the fabric. It should also be appreciated that the molecular fabric could be generated in-situ and the select MOF particles attached thereafter. In some embodiments, the molecular fabric could be constructed such that it is located on at the outlet of a vessel, such as a vessel containing resin beads in a bed or a demineralizer.

Regardless of the substrate used, however, it should be appreciated that for a given liquid stream and concentration of various liquid phase components to be removed, the capacity of a selected MOF to remove those liquid phase components will generally be much greater, such that saturation of the MOF is not a limitation. Accordingly, rather than using, for example, a bed full of MOF particles, the use of a substrate coated with MOF particles will still provide the requisite surface area required to obtain the desired removal of a given liquid phase species.

The present invention is also directed to methods for regenerating the adsorbent, such as the MOF, including a zirconium-based MOF such as MOF-808. In some embodiments, the regeneration of the MOF includes using an acid wash to remove the adsorbed species. In some embodiments, the acid wash may be an aqueous solution of hydrochloric acid, including solutions having up to approximately 10% hydrochloric acid (HCl). In some embodiments, up to three washes may be used, resulting in a regenerated MOF having little to no effect on subsequent adsorption performance as measured against performance of as-synthesized, virgin MOF.

Once removal of the desired species from the given liquid or liquid stream is performed, regeneration of the MOF may be optionally performed. Generally, regeneration of a given MOF can be performed to remove the adsorbed species from the MOF to thereby allow the MOF to be re-used. One of skill in the art will appreciate that the MOF may be in need of regeneration or spent depending upon the performance of the MOF over time or a change in the removal of the adsorbed species from the liquid. Testing to determine a chance in the removal rate or testing of a sample of the MOF to determine the saturation level of the adsorbed species on the MOF can be done to determine whether regeneration is appropriate.

Regeneration of the MOF can be done using a chemical wash or rinse. For example, for removal of adsorbed anion, such may be done via acid treatment, such as, but not limited to, hydrochloric, sulfuric or nitric acid washes. Subjecting the MOF to such treatment results in the adsorbed species being collected in the solution used to regenerate the MOF, which can be further processed as necessary. The MOF at this point would be ready for re-use.

Depending upon the structure to which the MOF is attached or the media to which it is attached, the equipment used for regeneration may vary. Industrial uses, including nuclear power plant reactor coolant kidney clean-up loops, may employ regeneration procedures on attached MOF, meaning to include the substrate to which it is ported in the process equipment. Detached MOF crystallites may be regenerated themselves according to the procedure described above for acid regeneration and remaining adsorption capacity and porosity following regeneration with various concentrations of aqueous HCl, which may be as high as approximately 10%. Once regenerated, the MOF can then be re-deployed for use. Accordingly, it should be appreciated that depending upon the substrate used to support the MOF, the MOF may be regenerated in-situ or removed from a given process, regenerated, and return to use in the process.

As described above, in one embodiment, MOF-808 can be regenerated using hydrochloric acid wash. With reference to FIGS. 31A-D, varying concentrations of HCl provide for varying amounts of removal to the adsorbed species, in this case, iodate. One of skill in the art can determine the concentration of any acid wash so as to provide the desired removal of the adsorbed species from the MOF.

In the specific application of nuclear power reactor coolant clean-up media, MOFs for iodate removal may in fact afford continued, safe operation of a nuclear power plant for which a fuel cladding leak has been detected during normal power operation. Typical polymer resin-based anion exchange resins are not capable of removing radioactive iodates from water at low enough concentrations so as to keep radio-iodine localized on the clean-up media; in particular, they slough iodate back into the effluent of the clean-up loop from the resin media due to equilibrium constraints on concentration at the filtration effluent. MOFs, like MOF-808, on the other hand, hold iodate more strongly such that effluent concentration below roughly 10 ppb may be possible. Further, MOFs are physically stable so that once loaded with radioactive species they may be contained and handled appropriately for disposal at licensed, low and intermediate level (LILW) radioactive waste disposal sites.

In the case of boiling water reactors (BWRs), fuel cladding defects can afford release of iodine gas from within the fuel rod. This radio-iodine is produced within the nuclear fuel during operation, by nuclear transmutation of xenon within the normally pressurized fuel rod. Once released into the coolant water, under radiolytically produced oxidative conditions, this iodine is oxidized to iodate and must be removed from the reactor coolant water in order to continue operation. Hence, using the MOF to take up these low concentrations of radio-iodate may afford continued safe operation of a BWR nuclear core because in BWRs it is possible to use control blade maneuvers together with off-gas gamma scanning to isolate the assembly region from which the fuel cladding leak is occurring. While the ultimate cause of the cladding defect can be varied (like debris impact, hydrogen embrittlement and crack initiation within the cladding alloy, thermal transients, or other reasons such as grid-to-rod fretting within the fuel assembly during coolant flow through the core, or possibly pellet-to-cladding interaction (PCI)), the solution to afford continued operation in the instance of a suitable small defect is to first be able to isolate and suppress the fission reaction in the leaking assemblies (using independent control blade positioning in BWR cores) and second to be able to continuously clean-up the radio-iodate being added to the coolant by the leaking rods. If these two conditions are met (the latter with MOF use according to the present invention) then the plant could continue operation until the planned end of the power cycle when the core is going to be rebuilt with subsets of assemblies replaced by new fuel anyway. In that instance, the leaking assemblies would be removed as well during the refueling outage, before the BWR was allowed to re-start. This is much more economical than being forced to shut the reactor down prior to a planned refueling outage in order to find and remove the slightly leaking assemblies, causing a mid-cycle re-build of the core before the plant would be allowed to re-start. Hence, MOF use in clean-up according to the present invention would be essential for affording this type of continued full cycle operation in BWRs. Further, BWR RWCU systems employ filter demineralizers to which the MOF crystallites might be deployed directly, without need for an extra substrate on which to port them. In a similar situation as for iodate, MOFs are expected to be able to remove pertechnetate since they are known to remove chemically analogous perrhenate. Pertechnetate is radioactive and is produced when irradiated nuclear fission fuel is exposed to liquid water.

In pressurized water reactors (PWRs), similar fuel leakers can occur, though PWRs have less capability to find and isolate them neutronicly given that their control rod designs do not afford partial, independent insertion like BWR designs do. Hence, once a leak is detected, the PWR typically must undertake a mid-cycle outage to find the offending fuel assemblies (by sipping them in the spent fuel pool) and remove them. As with BWRs, the degree to which radio-iodates might be controlled in the PWR reactor coolant, kidney clean-up loop will be beneficial to personnel dose once the refueling actions are underway during the mid-cycle outage. Nevertheless, the degree as well to which the released iodine gas is oxidized to iodate can vary with the shutdown operations of the PWR reactor coolant. It may end up mostly as off-gas or it may end up as aqueous iodate to which a bead-supported MOF according to the present invention could apply for clean-up purposes. The determining factors include the method and rate at which hydrogen is removed during shut down transients when the plant is going into the mid-cycle outage, as well as the degree of peroxidation of the coolant during those transients for the PWR mid-cycle planned at each PWR. Generally, individual plants are constrained by their technical specifications as to the freedom they might have in a PWR to re-start with elevated concentrations of radio-iodate or fuel leakers within their primary reactor coolant circuit.

For any nuclear reactor plant, LILW aqueous waste must be characterized as to its radioactive content before it is allowed to be shipped offsite for discharge. In normally operating nuclear power plants, hard-to-detect radionuclides include those containing long-lived radio-iodine and technetium. Typically, their oxy-anions exist at such low concentrations that usual plant laboratory instrumentation cannot measure them directly, resulting in application of a regulatorily approved scaling procedure which assume a much higher concentration than likely exists for characterization purposes, and which then results in higher costs to the shipper and at the ultimate, licensed, discharge facility. MOFs could conceivably be used to concentrate these hard-to-detect oxy-anions in radiological wastewater, thereby increasing the likelihood that the plant chemistry laboratory might be able to definitively determine the amount of these oxy-anions on the MOF. If so, then the actual concentration in the influent water passing through the MOF concentration cartridge might more accurately be determine given known flow rates and times through that cartridge, hopefully then lowering ultimate shipping and discharge costs to the nuclear power plant.

### Experimental Methods Regarding Iodine

Maximum Iodate Uptake per Node. 2.5 mg of activated MOF-808 was placed in a 15 mL centrifuge tube with 10 mL of either 41, 82, 123, 164, 205, 246, or 287 ppm solution of potassium iodate, corresponding to an exposure of 2, 3, 4, 5, 6, and 7 iodate anions per metal node of MOF. After 72 hours, the solutions were centrifuged to settle the MOF. 50 μL aliquots were taken and diluted to 5 mL with 0.5% ammonium hydroxide. The iodine concentration in each sample was determined by ICP-MS and compared to that of the corresponding stock solution to determine the iodate uptake by the MOF. A basic matrix for iodate samples is required to prevent the formation of volatile 12, which can permeate polypropylene, causing memory effects and incorrect concentration measurements.

Iodate Uptake Kinetics. 2.5 mg of activated MOF-808 was placed in a 15 mL centrifuge tube with 10 mL of either 41, 61.5, 82, 102.5, or 123 ppm solution of potassium iodate, corresponding to exposure of 1, 1.5, 2, 2.5, and 3 iodate molecules per node of MOF. The solution was centrifuged for 3 minutes for the MOF to settle, before aliquots of the supernatant were taken at 4, 6, 8, 10, 20, 40, 60, 120, and 180 minutes, as well as 24, 48, and 72 hours after initial exposure. The concentration of iodine was measured by ICP-MS, where the samples were diluted 100-fold with a 0.5% ammonium hydroxide solution by adding 50 μL aliquots to 5 mL.

The adsorption (q) in mg/g was determined for each exposure concentration performed using Equation 1. The maximum equilibrium adsorption capacity (Q) was determined by fitting the data to the Langmuir adsorption model. The Langmuir equation (Equation 2) was used to determine the Q for iodate uptake in MOF-808, where Ce is the equilibrium adsorption concentration (ppm) taken as the average of the concentrations at 48, 72 and 96 hours, and qₑ is the equilibrium uptake (mg/g), taken as the average of the calculated q values at 48, 72, and 96 hours.

Powder X-ray Diffraction (PXRD). Powder X-ray diffraction (PXRD) patterns were collected on a Bruker D8 Advance diffractometer (measurement made over a range of 3°<20<40° in 0.020 step with a 0.200 s scanning speed) equipped with a LYNXEYE linear position sensitive detector (Bruker AXS, Madison, WI). Neat samples were smeared directly onto the silicon wafer of a proprietary low-background sample holder. Data was collected using a continuous coupled θ/2θ scan with Ni-filtered CuKα (λ=1.54178 Å radiation operating at 40 kV and 40 mA).

¹H-NMR Spectra. ¹H-NMR spectra were collected with a 300 MHz Bruker spectrometer. Chemical shifts were referenced to the residual solvent peaks. Approximately 2 mg of MOF-808 was digested in 8 drops of D₂SO₄ before dilution in 0.6 mL DMSO-d₆.

Diffuse Reflectance Infrared Spectra. Diffuse reflectance infrared spectra were collected using a Thermo Scientific Nicolet 6700 FT-IR equipped with a liquid nitrogen cooled MCT detector with a resolution of 1 cm⁻¹.

SEM and X-ray Spectroscopy. Scanning electron microscopy (SEM) images and energy dispersive X-ray spectroscopy data were collected on a Phenom ProX desktop SEM.

MOF Activation. MOF samples were activated using a Micromeritics SmartVacPrep instrument equipped with a hybrid turbo vacuum pump.

BET Surface Area. BET surface areas are calculated using isotherm points between 0.0005 and 0.1 P/P₀ that satisfy all BET criteria.

Nitrogen Adsorption-Desorption Isotherms. Nitrogen adsorption-desorption isotherms were measured at 77 K on a Micromeritics TriStar II Plus instrument.

ICP-MS. Inductively coupled plasma-mass spectrometry (ICP-MS) data was measured on an Agilent 7500 Series. Standards were prepared at concentrations of 0.05, 0.1, 0.2, 0.5, and 1 ppm I⁻ by serial dilution in a 0.5% (v/v) solution of ammonium hydroxide.

X-ray Total Scattering. X-ray total scattering measurements for MOF-808 were conducted using beamline P02.1 of Petra III at the Deutsches Elektronen-Synchrotron (DESY), in Hamburg, Germany. Data were collected in a rapid acquisition mode using a 2D VAREX XRD4343CT detector (2880×2880 pixels, 150×150 μm² each) mounted orthogonal to the beam path. The samples were packed in 1 mm diameter glass capillaries and measured with a sample-to-detector distance of 499.0 mm. The incident energy of the X-ray beam was 59.58 keV (λ=0.20729 Å). LaB₆ was used to calibrate the detector position. The damping of data in real space due to the instrumental resolution in reciprocal space was characterized by fitting the structure of the calibration standard in the program PDFgui:¹⁴ Q_{damp}=0.0170 Å⁻¹.

Data Reduction. Calibration of the detector geometry and image integration were performed using the azimuthal integration software pyFAI. The raw data images were summed and corrected for polarization effects, then masked and azimuthally integrated to produce 1D powder diffraction patterns. Further normalization and transformation to the real space PDF was performed using PDFgetX3 within xPDFsuite. The total scattering structure function S(Q) is obtained from the coherent scattering intensities I_{c}(Q), after removal of the self-scattering by,

$$S ( Q ) = \frac{{I}_{c} ( Q ) / N - 〈 {f ( Q )}^{2} 〉 + {〈 f ( Q ) 〉}^{2}}{{〈 f ( Q ) 〉}^{2}}$$

Q is the magnitude of the scattering momentum transfer (Q=4π sin(θ)/λ for elastic scattering, where is the wavelength, and 2θ is the scattering angle). fᵢ(Q) is the atomic form factor for atom i, and averaging denoted by <⋅> is performed stoichiometrically over all atoms (N) in the sample. The reduced total structure function is defined as

$$F ( Q ) = Q [ S ( Q ) - 1 ]$$

and the experimental PDF, G(r), is obtained via truncated Fourier transformation,

$$G ( r ) = \frac{2}{π} {\int }_{{Q}_{min}}^{{Q}_{max}} F ( Q ) sin ( Qr ) dQ$$

which corresponds to the real space density distribution by

$$G ( r ) = 4 π r [ ρ ( r ) - {ρ}_{0} {γ}_{0} ]$$

where ρ₀ is the average atomic number density and ρ(r) is the local atomic pair density, which is the average density of neighboring atoms at a distance r from an atom at the origin. γ₀ is the characteristic function of the diffracting domains which equals 1 for bulk crystals but has an r-dependence for nanosized domains. The PDFs were determined with values of Qₘₐₓ=20.7 Å⁻¹. Simulated PDFs were determined from cluster models using the Debye function calculator in the Diffpy-CMI software,¹⁶ using a Q_{range}=0.5-20.0 Å⁻¹ and Bᵢₛₒ=0.5 Å².

For the difference PDF analysis, a modification function M(Q) was multiplied by F(Q) prior to the Fourier transformation (Qₘₐₓ=20.7 Å⁻¹) to minimize the presence of termination effects in the real-space signal. In order to assess the systematic errors introduced by the difference PDF (dPDF) extraction method used, the dPDF was extracted using four different subtraction methods:
1. Direct subtraction of empty MOF from loaded MOF intensities in reciprocal space;
2. Subtraction in real space by optimizing the scale of empty and loaded MOF PDFs over a range of 1.5-6 Å;
3. Subtraction in real space by fitting the empty to loaded MOF PDF: empty MOF PDF was modified by a spherical domain damping function, and a damped sine wave was added and refined to adjust for atomic density differences; and
4. Same as above: the empty MOF PDF was additionally modified by an expansion coefficient to allow the signal to expand/contract to best fit the loaded MOF PDF signal.

Systematic uncertainties in the experimental dPDFs were then estimated as the standard deviations between the four different extraction methods. The model dPDFs were simulated from the clusters considering atom-pairs between I atoms and O atoms of the IO₃ motif (not bound to the cluster) with each other and with the rest of the atoms. The Debye function calculator in Diffpy-CMI software, was used with a Q_{range}=1.0-20.0 Å⁻¹ and Bᵢₛₒ=1.0 Å².

Additional Diffraction Measurements. For verification of the sample structures, additional measurements were performed on the samples using a STOE Stadi-P diffractometer with CuKα radiation (λ=1.540596 Å, a Ge(111) Johann monochromator, and a single Mythen detector scanned over a range of 0.0-115.0° 2θ over a timespan of approximately 3.7 hours. The samples were loaded into 0.7 mm diameter borosilicate capillaries, and the samples were spun during the measurement for optimal orientational sampling of the powdered crystallites.

Pawley and Rietveld Refinements. Pawley and Rietveld refinements were performed using TOPAS v5/v6. In either case, refinements were performed considering the cubic Fd-3m symmetry along with Gaussian and Lorentzian contributions to the peak profile broadening, and the Stephens model for strain (3 parameters). Further corrections included a zero-offset correction, sample length parameter in the full axial model for peak asymmetry, and the Lorentz-Polarisation factor for the given radiation and monochromator. The complicated backgrounds were described using combinations of Chebychev polynomials and broad Gaussian peaks or using a second hkl phase with a fixed peak broadening set to 1 nm. Additional pseudoatoms with atomic displacement parameters fixed to a larger value were included to account for pore water content and bound water or IO₃⁻.

Regeneration. To test the reusability of MOF-808 in multiple adsorption cycles, 10 mg of MOF-808 was exposed to 10 mL of a 1148 ppm solution (7 iodate anions/node) of potassium iodate overnight. The MOF powder and iodate solution was then placed on a membrane filter in a glass microfiltration apparatus attached to a vacuum pump. The iodate solution was drawn through the membrane, the filtrate collected, and the MOF on the membrane was washed with 3×10 mL of water. 10 mL of 1%, 3%, 5%, or 10% HCl was then drawn through the MOF sample over the course of 5 minutes by vacuum control. Aliquots (100 μL) of the acid filtrate were taken immediately after filtration and diluted 2000× by serial dilution with 0.5% ammonium hydroxide. The iodine concentration was measured via ICP-MS to determine the amount of iodate removed from the MOF by the acid wash. After washing with acid, the MOF on the membrane was again washed with 3×10 mL of water. The powder was then placed in a fresh solution of 1148 ppm potassium iodate to soak overnight and begin the next adsorption cycle. Three adsorption-desorption cycles were performed.

To assess the porosity after recycling, 5 batches of 10 mg MOF-808 were loaded with iodate and regenerated with 10% HCl as described above. After the 3^{rd} cycle, the MOF samples were combined and washed 3× with 20 mL of water, and 3× with 20 mL of acetone and left to soak in acetone overnight before activation and BET measurement.

To assess the porosity of MOF-808 after adsorption, 50 mg of MOF-808 was exposed to 50 mL of a 1148 ppm (7 iodate anions/node) solution of potassium iodate overnight. Iodate loaded samples were then washed 3× with 20 mL of water, and 3× with 20 mL of acetone and left to soak in acetone overnight before activation and BET measurement.

For the nitrogen adsorption-desorption isotherms appearing in FIG. 22C, 234.0 mg, 20.1 mg, and 33.2 mg of MOF was used for analysis of MOF-808, MOF-808+ iodate, and HCl regenerated MOF-808, respectively.

Various embodiments of the invention have been described above. However, it should be appreciated that alternative embodiments are possible and that the invention is not limited to the specific embodiments described above. For example, it should be appreciated, however, that other MOFs may be used and attached to a given substrate. For example, the MOF may be a Zr-based MOF used to remove certain chemical species, such as water, from a gas stream or air, including ambient air. Such MOFs may include MOF-801, 801-P, 802, 805, 806, 812, and 841. In some embodiments, such MOFs once attached to a given substrate may be used to remove water from ambient air at night and use solar energy during the day to effectively produce liquid water without electrical power consumption. These MOFs are described in Hiroyasu Furukawa, Felipe Gandara, Yue-Biao Zhang, Juncong Jiang, Wendy L. Queen, Matthew R. Hudson, and Omar M. Yaghi, “Water Adsorption in Porous Metal-Organic Frameworks and Related Materials,” J. Am. Chem. Soc. 136, 4369-4381 (2014), the entirety of which is incorporated by reference herein.

Further, because there exists in the literature established chemistries for altering the metal components of a MOF, one of sufficient expertise in the art ought to be able to produce MOFs related to NU-1000 that contain less expensive metal constituents, like using zirconium metal precursors which are only 90% pure and contain hafnium. In fact, in the present invention, one embodiment was tested in which an NU-1000 MOF analogue containing Zr:Hf within the nodal components at a ratio of 9:1. It was found in similar experiments as those prescribed above for NU-1000 itself, that the 90% Zr/10% Hf MOF indeed exhibited similar excellent nodal uptake of selenium derived oxy-anions (i.e., 90% to as high as 95% of the uptake seen with the pure Zr NU-1000 MOF), implying that commercial cost reduction should be possible through the use of less pure zirconium starting materials to make NU-1000.

What is claimed is:

1. A method for removing a pre-determined species from a liquid, comprising:
contacting a zirconium-based MOF with a liquid comprising a pre-determined species to be removed and having a temperature that is greater than approximately 45° C.;
adsorbing the species onto the MOF.

2. The method of claim 1, wherein the pre-determined species comprises an oxy-anion.

3. The method of claim 1, wherein the pre-determined species comprises sulfate anion.

4. The method of claim 1, wherein the liquid comprises a liquid stream used in a nuclear reactor system.

5. The method of claim 4, wherein the liquid stream comprises a primary nuclear reactor coolant stream.

6. The method of claim 1, wherein the temperature is approximately 150° C.

7. A method for removing an oxy-anion from a liquid process stream used in a nuclear reactor system, comprising:
contacting a zirconium-based MOF with a liquid process stream used in a nuclear reactor system comprising an oxy-anion to be removed and having a temperature that is greater than approximately 45° C.;
adsorbing the species onto the MOF.

8. The method of claim 7, wherein the pre-determined species comprises sulfate anion.

9. The method of claim 7, wherein the liquid stream comprises a primary nuclear reactor coolant stream.
